(19) United States
(12) Patent Application Publication
(10) Pub. No.: US 2024/0188564 A1
(43) Pub. Date: Jun. 13, 2024

(54) ANTIBIOFILM FORMULATIONS AND METHODS

(71) Applicant: Suncor Energy Inc., Calgary (CA)

(72) Inventors: Michael Fefer, Mississauga (CA); Jun Liu, Mississauga (CA); Kenneth Ng, Mississauga (CA); Yuichi Terazono, Mississauga (CA); Wenzi Ckurshumova, Mississauga (CA)

(21) Appl. No.: 18/284,164

(22) PCT Filed: Mar. 25, 2022
(86) PCT No.: PCT/CA2022/050446

§ 371 Date: Sep. 26, 2023

Related U.S. Application Data
(60) Provisional application No. 63/166,627, filed on Mar. 26, 2021.

(51) Int. Cl. A01N 37/44; A01N 25/30; A01N 31/02; A01N 31/08; A01N 31/14; A01N 35/02; A01N 37/36; A01N 45/00; A01N 65/44; A01P 1/00

(52) U.S. Cl. CPC A01N 37/44; A01N 25/30; A01N 31/02; A01N 31/08; A01N 31/14; A01N 35/02; A01N 37/36; A01N 45/00; A01N 65/44; A01P 1/00

(57) ABSTRACT

An antibiofilm composition is provided. The antibiofilm composition includes a polycarboxylic acid derivative or a salt thereof, onto which a hydrophobic group, a poly(ethylene oxide) group and/or a poly(propylene oxide) group is covalently bound, an essential oil, and a biosurfactant.

### FIELD

The technical field generally relates to antibiofilm formulations, and more particularly to antibiofilm combinations and compositions comprising a polycarboxylic acid derivative including a hydrophobic moiety, a biosurfactant and an essential oil for the treatment of surfaces.

### BACKGROUND

Biofilms are microbial communities that adhere to biological or abiotic substrates and produce an extracellular matrix that typically includes polysaccharides and proteins. Microbes in biofilms are resistant to antibiotics and host immune responses and can be difficult to eradicate. Many challenges still exist in the field of antibiofilm compositions.

### SUMMARY

In one aspect, an antibiofilm combination is provided. The antibiofilm combination comprises:

a compound of Formula (I):

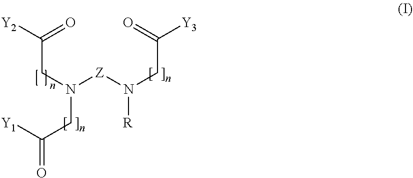

or a salt thereof, wherein:
R is selected from the group consisting of

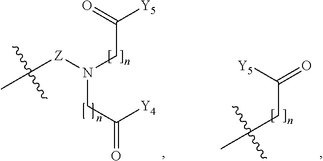

(C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl,
-(PO)_{w1}-(EO)ₜ-(C₂-C₂₄)alkenyl, -(PO)_{w1}-(EO)ₜ-(C₂-C₂₄)alkynyl, —(CH₂)ₚ—OR₁, —(CH₂)ₚ—NR₁R₂, —(CH₂)ₚ—OC(═O)R₁, —(CH₂)ₚ—NR₂C(═O)R₁, (C₁-C₂₄)acyl, aryl and a steroidyl group;
each Y₁, Y₂, Y₃ and Y 4 is independently selected from the group consisting of —OR₃ and —NR₃R₄;
Y₅ is selected from the group consisting of —OR₁ and —NR₁R₂;
each R₁ is independently selected from the group consisting of (C₁-C₂₄)alkyl, -(EO)ₜ—(C₁-C₂₄)alkyl, (C₂-C₂₄)alkenyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl,
-(PO)_{w1}-(EO)ₜ-(C₂-C₂₄)alkenyl, -(PO)_{w1}-(EO)ₜ-(C₂-C₂₄)alkynyl, aryl and a steroidyl group;
each R₂, R₃ and R₄ is independently selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}(C₂-C₂₄)alkenyl, -(EO)ₜ-(PO)_{w1}-(C₂-C₂₄)alkynyl, -(PO)_{w1}-(EO)ₜ-(C₁-C₂₄)alkyl,
-(PO)_{w1}(EO)ₜ-(C₂-C₂₄)alkenyl, -(PO)_{w1}(EO)ₜ-(C₂-C₂₄)alkynyl, aryl and a steroidyl group;
each Z is independently selected from the group consisting of (C₂-C₆)alkylene, (C₃-C₆)cycloalkylene and —(CH₂)₂—O—(CH₂)₂—O—(CH₂)₂—;
wherein each (C₂-C₆)alkylene and (C₃-C₆)cycloalkylene is independently unsubstituted or substituted by one or more identical or different substituents R₅;
wherein each aryl, (C₁-C₂₄)alkyl, (C₂-C₂₄)alkenyl and (C₂-C₂₄)alkynyl is independently unsubstituted or substituted by one or more identical or different substituents R₆;
wherein each R₅ and each R₆ is independently selected from the group consisting of halogen, —OH, —O—(C₁-C₄)alkyl, CF₃, and —CN;
each n is independently 1, 2, 3 or 4;
each p is independently 2, 3 or 4;
each t is independently a number between 1 and 50; and
each w1 is independently a number between 0 and 10.
   an essential oil; and
   a biosurfactant selected from the group consisting of an alkyl polyglycoside, a rhamnolipid, a sophorolipid and a combination thereof.

In some implementations, the compound of Formula (I) is:

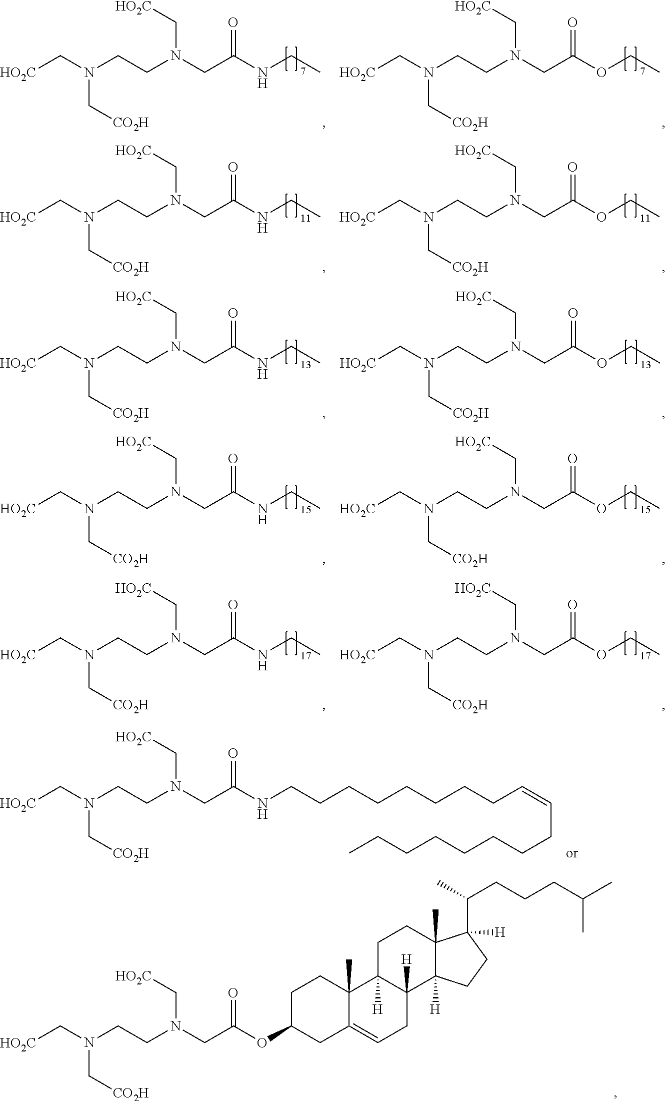

or a salt thereof.

In some implementations, the compound of Formula (I) is:

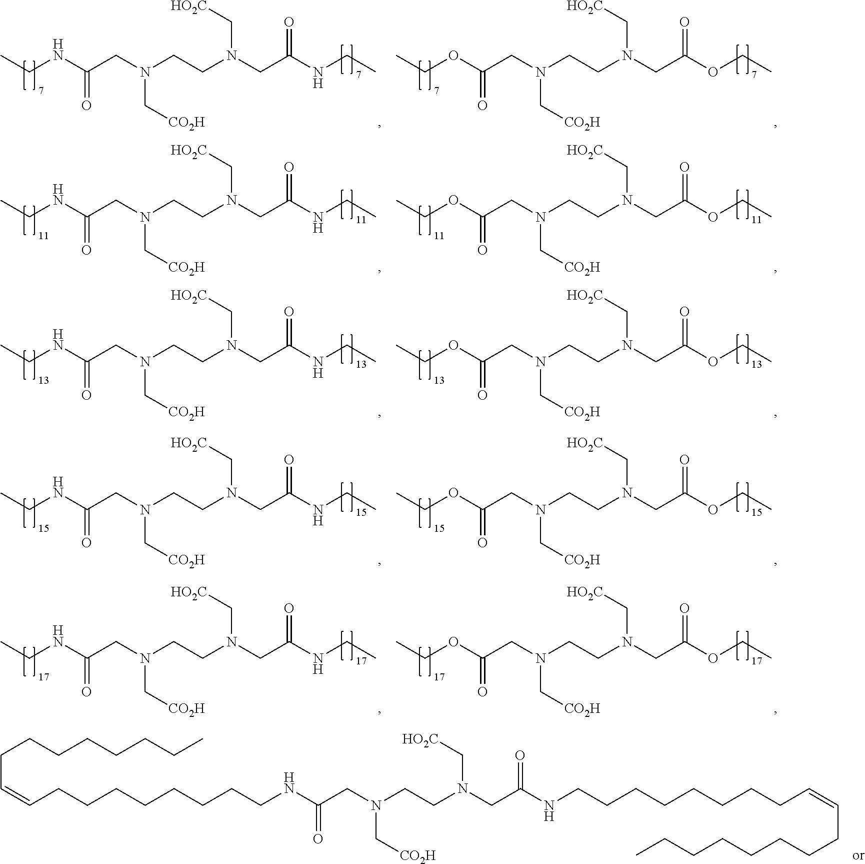

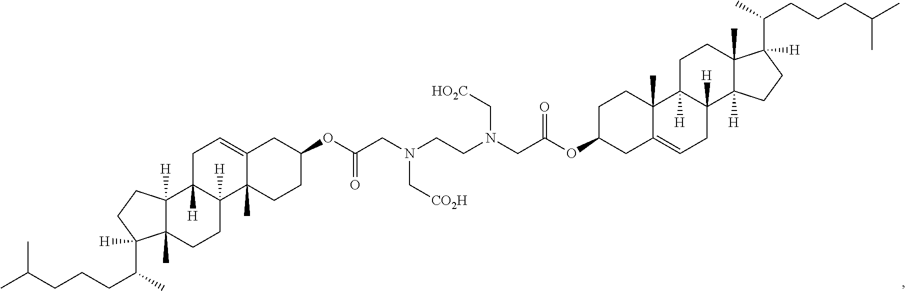

or a salt thereof.

In some implementations, the compound of Formula (I) is:

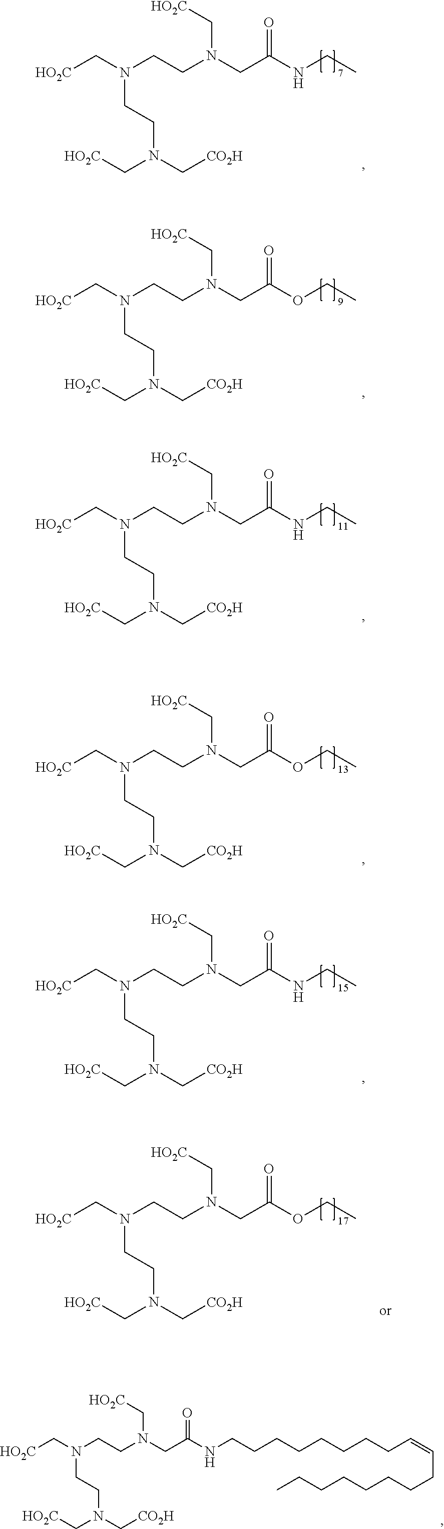

or a salt thereof.

In some implementations, the compound of Formula (I) is:

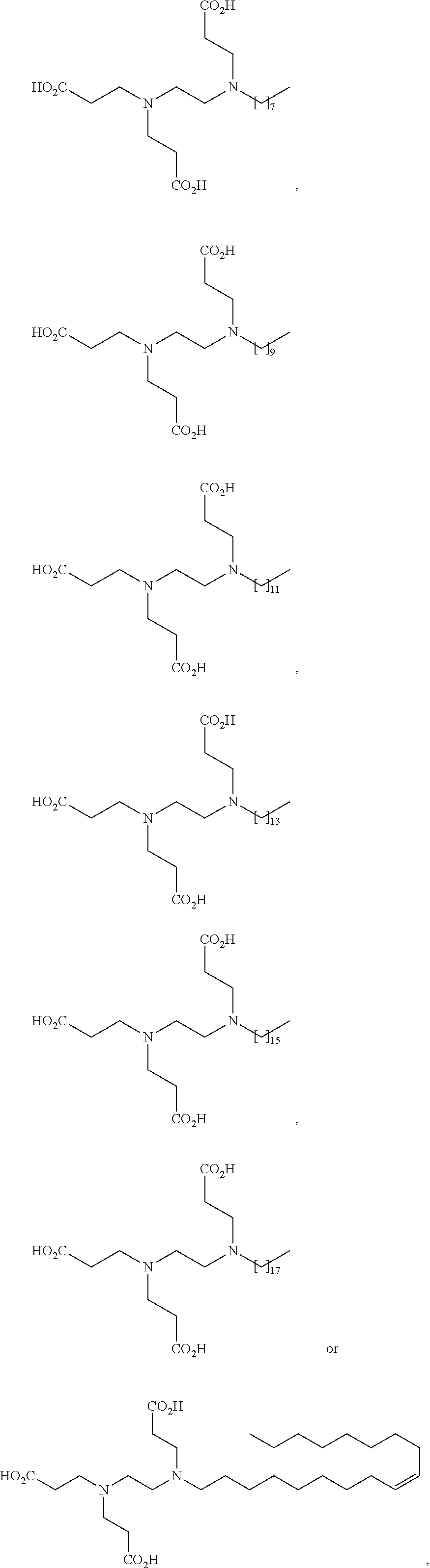

or a salt thereof.

In some implementations, the compound of Formula (I) is:

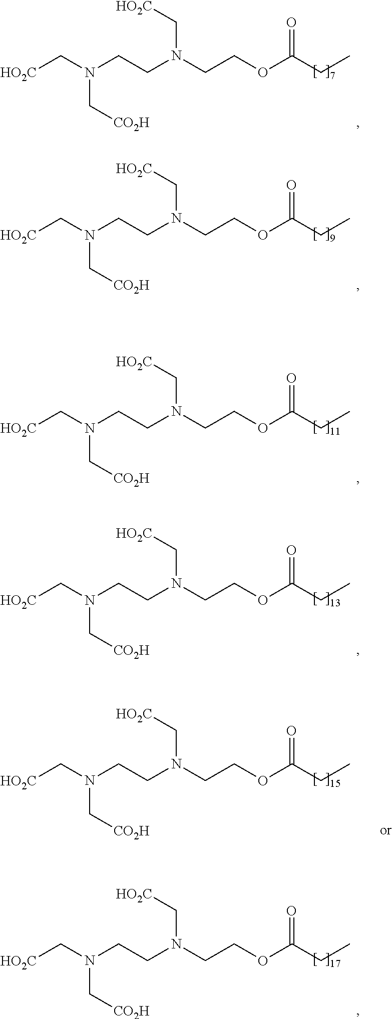

or a salt thereof.

In some implementations, the compound of Formula (I) is:

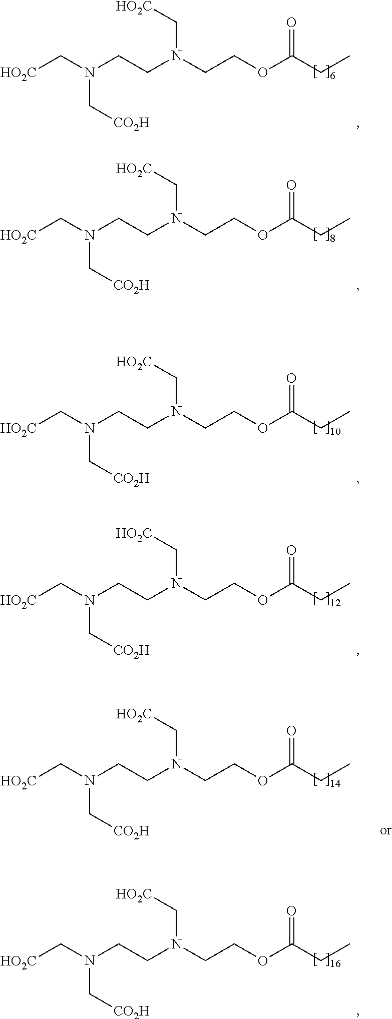

or a salt thereof.

In some implementations, the compound of Formula (I) is:

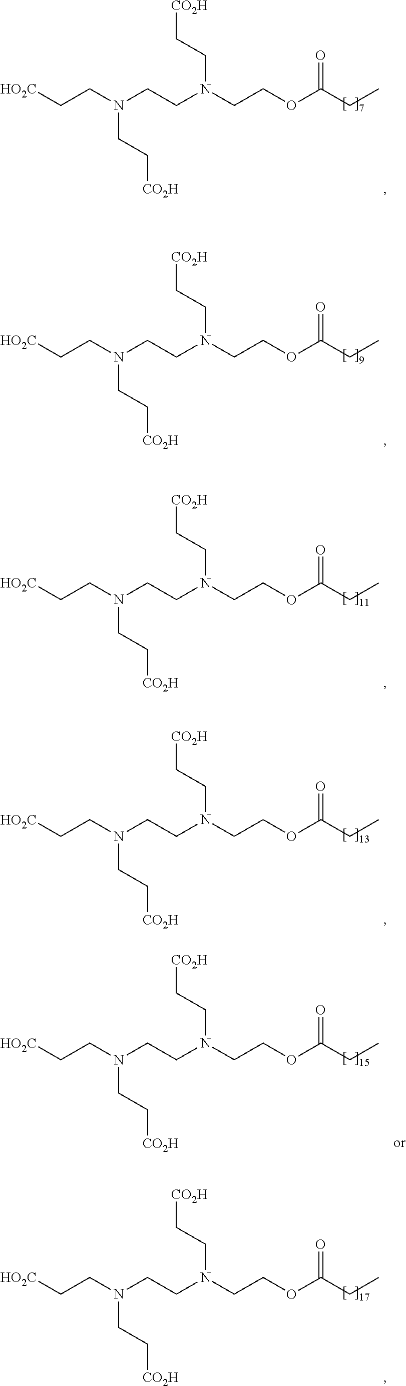

or a salt thereof.

In some implementations, the compound of Formula (I) is:

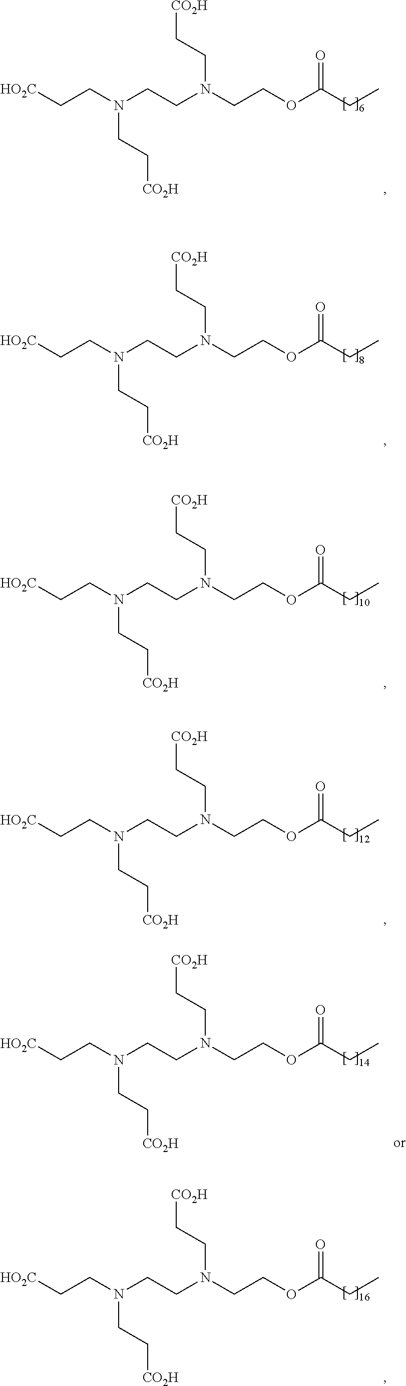

or a salt thereof.

In another aspect, an antibiofilm combination is provided. The antibiofilm combination comprises:

a compound of Formula (IIIA):

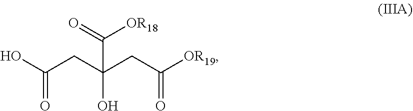

or a salt thereof, wherein:
R₁₉ is selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -EOₜ-(PO)_{w1}(C₂-C₂₄)alkenyl,
-(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl and -(PO)_{w1}-(EO)ₜ-(C₂-C₂₄)alkynyl,
R₁₈ is selected from the group consisting of H, (C₁-C₂₄)alkyl, (C₂-C₂₄)alkenyl,
(C₂-C₂₄)alkynyl; -(EO)ₜ-(PO)_{w1}-(C₁-C₂₄)alkyl, -(EO)ₜ-(PO)_{w1}-(C₂-C₂₄)alkenyl,
-(EO)ₜ-(PO)_{w1}-(C₂-C₂₄)alkynyl, -(PO)_{w1}-(EO)ₜ-(C₁-C₂₄)alkyl,
-(PO)_{w1}-(EO)ₜ-(C₂-C₂₄)alkenyl and -(PO)_{w1}-(EO)ₜ-(C₂-C₂₄)alkynyl,
wherein at least one of R₁₈ and R₁₉ is not H;
each (C₁-C₂₄)alkyl, (C₂-C₂₄)alkenyl and (C₂-C₂₄)alkynyl is independently unsubstituted or substituted by one or more identical or different substituents R₆;
wherein each R₆ is independently selected from the group consisting of halogen, —OH, —O—(C₁-C₄)alkyl, CF₃, and —CN;
each t is independently a number between 1 and 50; and
each w1 is independently a number between 1 and 10;
   an essential oil; and
   a biosurfactant selected from the group consisting of an alkyl polyglycoside, a rhamnolipid,
   a sophorolipid and a combination thereof.

In some implementations, the compound of Formula (IIIA) is:

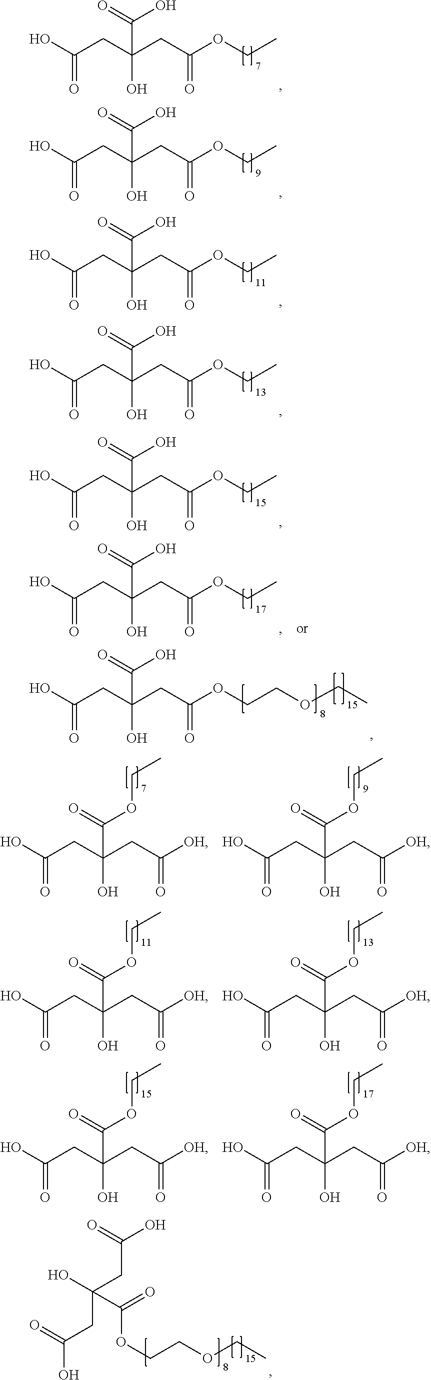

a salt thereof, or a mixture thereof.

In another aspect, an antibiofilm combination is provided. The antibiofilm combination comprises:

a compound of Formula (VII):

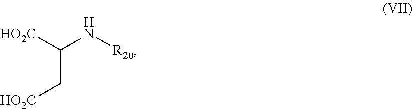

or a salt thereof, wherein:
R₂₀ is selected from the group consisting of: (C₁-C₂₄)alkyl, (C₂-C₂₄)alkenyl,
(C₂-C₂₄)alkynyl, -(EO)ₜ-(PO)_{w1}-(C₁-C₂₄)alkyl, -(EO)ₜ-(PO)_{w1}-(C₂-C₂₄)alkenyl,
-(EO)ₜ-(PO)_{w1}-(C₂-C₂₄)alkynyl, -(PO)_{w1}-(EO)ₜ-(C₁-C₂₄)alkyl,
-(PO)_{w1}-(EO)ₜ-(C₂-C₂₄)alkenyl, -(PO)_{w1}-(EO)ₜ-(C₂-C₂₄)alkynyl,

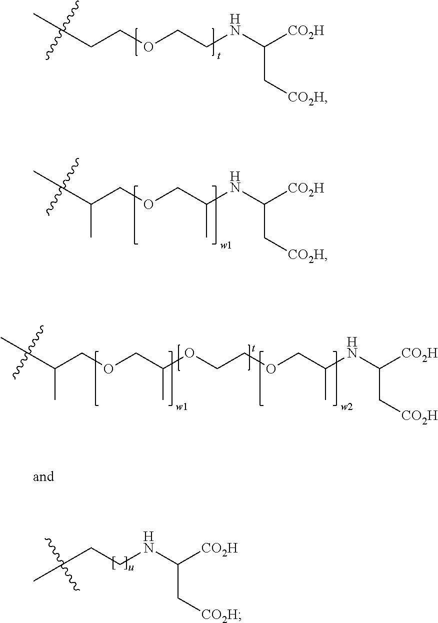

t is a number between 1 and 50;
u is a number between 1 and 23;
w1 is a number between 0 and 10; and
w2 is a number between 0 and 10;
each (C₁-C₂₄)alkyl, (C₂-C₂₄)alkenyl and (C₂-C₂₄)alkynyl is independently unsubstituted or substituted by one or more identical or different substituents R₆;
wherein each R₆ is independently selected from the group consisting of halogen, —OH, —O—(C₁-C₄)alkyl, CF₃, and —CN;
   an essential oil; and
   a biosurfactant selected from the group consisting of an alkyl polyglycoside, a rhamnolipid,
   a sophorolipid and a combination thereof.

In yet another aspect, an antibiofilm combination is provided. The antibiofilm combination comprises:

a polycarboxylic acid compound of Formula (10) or Formula (IB),

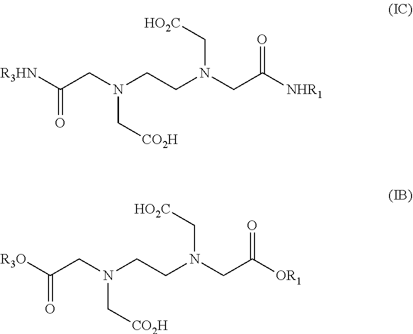

or a salt thereof, wherein:
each R₁ is independently selected from the group consisting of (C₈-C₂₄)alkyl,
-(EO)ₜ-(C₈-C₂₄)alkyl, (C₈-C₂₄)alkenyl, -(EO)ₜ-(C₈-C₂₄)alkenyl, (08-C₂₄)alkynyl and
-(EO)ₜ-(C₈-C₂₄)alkynyl;
each R₃ is independently selected from the group consisting of H, (C₈-C₂₄)alkyl,
-(EO)ₜ-(C₈-C₂₄)alkyl, (C₈-C₂₄)alkenyl, -(EO)ₜ-(C₈-C₂₄)alkenyl (08-C₂₄)alkynyl and
-(EO)ₜ-(C₈-C₂₄)alkynyl,
wherein each t is independently a number between 1 and 30,
   an essential oil; and
   a biosurfactant selected from the group consisting of an alkyl polyglycoside, a rhamnolipid,
   a sophorolipid and a combination thereof.

In some implementations, the antibiofilm combination is provided as a multiple-pack system comprising at least two packs, each one of the two packs comprising at least one separate component of the combination.

In some implementations, the antibiofilm combination is an antibiofilm composition. In other words, in some implementations, all the components of the antibiofilm combination are provided in a single formulation.

In one aspect, a method for disrupting preformed biofilms on a surface is provided. The method includes applying the antibiofilm combination or composition as described herein, to the surface.

In one aspect, a method for inhibiting biofilm formation on a surface is provided. The method includes applying the antibiofilm combination or combination as described herein to the surface.

In some implementations, the method further includes removing and/or cleaning the biofilm from the surface.

### DETAILED DESCRIPTION

The present description provides antibiofilm combinations and compositions, as well as methods of applying such antibiofilm combinations and compositions to surfaces. The antibiofilm combinations and compositions include a polycarboxylic acid derivative that includes at least one hydrophobic moiety that is covalently bound to the polycarboxylic acid derivative, an essential oil, a biosurfactant, and water. Each of the components of the antibiofilm composition is described herein.

### Definitions

Unless stated otherwise, the following terms and phrases as used herein are intended to have the following meanings.

When trade names are used herein, it is intended to independently include the tradename product and the active ingredient(s) of the tradename product.

The term “antimicrobial”, as used herein, refers to a compound or a composition that kills, inhibits and/or stops the growth of microorganisms, including, but not limited to bacteria and fungi.

The term “biofilm”, as used herein, refers to a community of microorganism that is matrix-enclosed in a self-produced extracellular polymeric matrix, and attached to a biological or non-biological surface. Bacteria in a biofilm can be up to 1000 times more resistant to antibiotics/antimicrobials compared to their planktonic (free living) counterparts.

The term “Biofilm formation”, as used herein, refers to the attachment of microorganisms to surfaces and the subsequent development of multiple layers of cells. The term “biofilm formation” is intended to include the formation, growth and modification of the microbial colonies contained within the biofilm, as well as the synthesis and maintenance of the extracellular polymeric matrix of the biofilm.

The term “surface” or “surfaces”, as used herein, refers to biological or non-biological surfaces. Non-limiting examples of biological surfaces include wounds (including chronic and acute wounds), skin lesions, skin, mucous membranes, mucous membrane lesions, internal organs, body cavity, oral cavity, bone tissue, muscle tissue, nerve tissue, ocular tissue, urinary tract tissue, lung and trachea tissue, sinus tissue, ear tissue, dental tissue, gum tissue, nasal tissue, vascular tissue, cardiac tissue, epithelium, and epithelial lesions, and peritoneal tissue. Non-limiting examples of non-biological surfaces include the surface of an article of manufacture such as a medical device, pipes, filters, walls, floors, table-tops or toilets. The surfaces can be porous, soft, hard, semi-soft, semi-hard, regenerating, or non-regenerating. These surfaces include, but are not limited to, polyurethane, metal, alloy, or polymeric surfaces in medical devices, enamel of teeth, and cellular membranes in animals such as mammals (e.g., humans).

The term “antibiofilm”, as used herein, refers to inhibition of biofilm formation and/or to disruption or dispersal of preformed biofilms. The antibiofilm combinations of the present description can be applied to biological and/or non-biological surfaces, to prevent microorganisms from adhering to the surfaces, or to remove the microorganisms that have adhered to the surfaces. In other words, the surfaces can be coated or impregnated with the antibiofilm combination prior to use. Alternatively, the surfaces can be treated with the antibiofilm combination to control, reduce, or eradicate the microorganisms adhering to the surfaces. The term “microorganisms”, as used herein, refers to bacteria, archaea, fungi (yeasts and molds), algae, protozoa and viruses.

As used herein, the phrase “a compound of Formula I” means a compound of Formula I or a salt thereof. With respect to isolatable intermediates, the phrase “a compound of Formula (number)” means a compound of that formula and salts thereof.

The term “Alkyl”, as used herein, means a hydrocarbon containing primary, secondary, tertiary or cyclic carbon atoms. For example, and without being limiting, an alkyl group can have 1 to 24 carbon atoms (i.e, C₁-C₂₄ alkyl), 4 to 18 carbon atoms (i.e., C₄-C₁₈ alkyl), 8 to 18 carbon atoms (i.e., C₈-C₁₈ alkyl), 8 to 16 carbon atoms (i.e., C₈-C₁₆ alkyl) or 12 to 16 carbon atoms (i.e., C₁₂-C₁₆ alkyl). Examples of suitable alkyl groups include, but are not limited to, methyl (Me, —CH₃), ethyl (Et, —CH₂ CH₃), 1-propyl (n-Pr, n-propyl, —CH₂CH₂CH₃), 2-propyl (i-Pr, i-propyl, —CH(CH₃)₂), 1-butyl (n-Bu, n-butyl, —CH₂CH₂CH₂CH₃), 2-methyl-1-propyl (i-Bu, i-butyl, —CH₂CH(CH₃)₂), 2-butyl (s-Bu, s-butyl, —CH(CH₃)CH₂CH₃), 2-methyl-2-propyl (t-Bu, t-butyl, —C(CH₃)3), 1-pentyl (n-pentyl, —CH₂CH₂CH₂CH₂CH₃), 2-pentyl (—CH(CH₃)CH₂CH₂CH₃), 3-pentyl (—CH(CH₂CH₃)₂), 2-methyl-2-butyl (—C(CH₃)2CH₂CH₃), 3-methyl-2-butyl (—CH(CH₃)CH(CH₃)₂), 3-methyl-1-butyl (—CH₂CH₂CH(CH₃)₂), 2-methyl-1-butyl (—CH₂CH(CH₃)CH₂CH₃), 1-hexyl (—CH₂CH₂CH₂CH₂CH₂CH₃), 2-hexyl (—CH(CH₃)CH₂CH₂CH₂CH₃), 3-hexyl (—CH(CH₂CH₃)(CH₂CH₂CH₃)), 2-methyl-2-pentyl (—C(CH₃)2CH₂CH₂CH₃), 3-methyl-2-pentyl (—CH(CH₃)CH(CH₃)CH₂CH₃), 4-methyl-2-pentyl (—CH(CH₃)CH₂CH(CH₃)₂), 3-methyl-3-pentyl (—C(CH₃)(CH₂CH₃)₂), 2-methyl-3-pentyl (—CH(CH₂CH₃)CH(CH₃)₂), 2,3-dimethyl-2-butyl (—C(CH₃)2CH(CH₃)₂), 3,3-dimethyl-2-butyl (—CH(CH₃)C(CH₃)₃, octyl (—(CH₂)₇CH₃), n-hexadecyl (—(CH₂)₁₅CH₃), n-tetradecyl (—(CH₂)₁₃CH₃), n-dodecyl (—(CH₂)₁₁CH₃).

The term “Alkenyl”, as used herein, means a hydrocarbon containing primary, secondary, tertiary or cyclic carbon atoms with at least one site of unsaturation, i.e. a carbon-carbon sp² double bond. For example, and without being limiting, an alkenyl group can have 2 to 24 carbon atoms (i.e., C₂-C₂₄ alkenyl), 2 to 18 carbon atoms (i.e., C₂-C₁₈ alkenyl), 8 to 18 carbon atoms (i.e., C₈-C₁₈ alkenyl) or 12 to 16 carbon atoms (i.e., C₁₂-C₁₆ alkenyl). Examples of suitable alkenyl groups include, but are not limited to, ethylene or vinyl (—CH═CH₂), allyl (—CH₂CH═CH₂), cyclopentenyl (—C₅H₇), 5-hexenyl (—CH₂CH₂CH₂CH₂CH═CH₂) and 9-octadecenyl (—CH₂—(CH₂)₇—CH═CH—(CH₂)₇—CH₃). It is understood that the term “alkenyl” also includes terpenyl radicals. Terpenyl radicals are derived from terpenes which are of general formula (C₅H₈) n where n is 2, 3, 4 or more. As used herein, the terms “terpene” and “terpenyl” extend to compounds which are known as “terpenoids”, involving the loss or shift of a fragment, generally a methyl group. As a non-limiting example, sesquiterpenes (where n is 3) may contain 14 rather than 15 carbon atoms—and are then considered to be terpenoids (or more specifically sesquiterpenoids). Terpene or terpenyl radicals can be cyclic or acyclic. A non-limiting example of a sub-class of terpenes are carotenes or carotenoids, also referred to as tetraterpenes or tetraterpenoids.

The term “Alkynyl”, as used herein, means a hydrocarbon containing primary, secondary, tertiary or cyclic carbon atoms with at least one site of unsaturation, i.e. a carbon-carbon, sp triple bond. For example, and without being limiting, an alkynyl group can have 2 to 24 carbon atoms (i.e., C₂-C₂₄ alkynyl), 2 to 18 carbon atoms (i.e., C₂-C₁₈ alkynyl), 8 to 18 carbon atoms (i.e., C₈-C₁₈ alkynyl) or 12 to 16 carbon atoms (i.e., C₁₂-C₁₆ alkynyl). Examples of suitable alkynyl groups include, but are not limited to, acetylenic (—≡CH), propargyl (—CH₂C≡CH) and hexadecynyl (—(CH₂)₁₄—C≡CH).

The term “Alkoxy”, as used herein, is interchangeable with the term “O(Alkyl)”, in which an “Alkyl” group as defined above is attached to the parent molecule via an oxygen atom. For example, and without being limiting, the alkyl portion of an O(Alkyl) group can have 1 to 24 carbon atoms (i.e, C₁-C₂₄ alkyl), 4 to 18 carbon atoms (i.e., C₄-C₁₈ alkyl), 8 to 16 carbon atoms (i.e., C₈-C₁₆ alkyl) or 12 to 16 carbon atoms (i.e., C₁₂-C₁₆ alkyl). Examples of suitable Alkoxy or O(Alkyl) groups include, but are not limited to, methoxy (—OCH₃ or -OMe), ethoxy (—OCH₂CH₃ or -OEt) and t-butoxy (—O—C(CH₃)₃ or -OtBu). Similarly, “O(alkenyl)”, “O(alkynyl)” and the corresponding substituted groups will be understood by a person skilled in the art.

The term “Acyl”, as used herein, is meant to encompass several functional moieties such as “C═O(Alkyl)”, “C═O(Alkenyl)”, “C═O(Alkynyl)” and their corresponding substituted groups, in which an “Alkyl”, “Alkenyl” and “Alkynyl” groups are as defined above and attached to an O, N, S of a parent molecule via a C═O group. For example, and without being limiting, the alkyl portion of a C═O(Alkyl) group can have 1 to 24 carbon atoms (i.e, C₁-C₂₄ alkyl), 1 to 8 carbon atoms (i.e., C₁-C₈ alkyl), 1 to 6 carbon atoms (i.e., C₁-C₆ alkyl) or 1 to 4 carbon atoms (i.e., C₁-C₄ alkyl). Examples of suitable Acyl groups include, but are not limited to, formyl (i.e., a carboxyaldehyde group), acetyl, trifluoroacetyl, propionyl, and butanoyl. A person skilled in the art will understand that a corresponding definition applies for “C═O(Alkenyl)” and “C═O(Alkynyl)” moieties. In the present description, “C═O(Alkyl)”, “C═O(Alkenyl)”, “C═O(Alkynyl)” can also be written as “CO(Alkyl)”, “CO(Alkenyl) and “CO(Alkynyl)”, respectively. It is understood that the term “(C₁-C₂₄)acyl, as used herein, refers to “C═O((C₁-C₂₄)Alkyl), C═O(((C₁-C₂₄)Alkenyl) or C═O(((C₁-C₂₄)Alkynyl)”.

The term “Alkylene”, as used herein, means a saturated, branched or straight chain or cyclic hydrocarbon radical having two monovalent radical centers derived by the removal of two hydrogen atoms from the same or two different carbon atoms of a parent alkane. For example, and without being limiting, an alkylene group can have 1 to 24 carbon atoms, 1 to 18 carbon atoms, 1 to 10 carbon atoms, 1 to 6 carbon atoms, 1 to 4 carbon atoms, 8 to 24 carbon atoms or 8 to 18 carbon atoms. Typical alkylene radicals include, but are not limited to, methylene (—CH₂—), 1,1-ethyl (—CH(CH₃)—), 1,2-ethyl (—CH₂CH₂—), 1,1-propyl (—CH(CH₂CH₃)—), 1,2-propyl (—CH₂CH(CH₃)—), 1,3-propyl (—CH₂CH₂CH₂—) and 1,4-butyl (—CH₂CH₂CH₂CF₁₂—).

The term “Alkenylene”, as used herein, means an unsaturated, branched or straight chain or cyclic hydrocarbon radical having two monovalent radical centers derived by the removal of two hydrogen atoms from the same or two different carbon atoms of a parent alkene. For example, and without being limiting, and alkenylene group can have 2 to 24 carbon atoms, 2 to 18 carbon atoms, 2 to 10 carbon atoms, 2 to 6 carbon atoms, 2 to 4 carbon atoms, 8 to 24 carbon atoms or 8 to 18 carbon atoms. Typical alkenylene radicals include, but are not limited to, 1,2-ethylene (—CH═CH—).

The term “Alkynylene”, as used herein, means an unsaturated, branched or straight chain or cyclic hydrocarbon radical having two monovalent radical centers derived by the removal of two hydrogen atoms from the same or two different carbon atoms of a parent alkyne. For example, and without being limiting, an alkynylene group can have 2 to 24 carbon atoms, 2 to 18 carbon atoms, 2 to 10 carbon atoms, 2 to 6 carbon atoms or 2 to 4 carbon atoms, 8 to 24 carbon atoms or 8 to 18 carbon atoms. Typical alkynylene radicals include, but are not limited to, acetylene (—C≡C—), propargyl (—CH₂ C≡C—), and 4-pentynyl (—CH₂CH₂CH₂C≡C—).

The term “Aryl”, as used herein, means an aromatic hydrocarbon radical derived by the removal of one hydrogen atom from a single carbon atom of a parent aromatic ring system. For example, and without being limiting, an aryl group can have 6 to 20 carbon atoms, 6 to 14 carbon atoms, or 6 to 10 carbon atoms. Typical aryl groups include, but are not limited to, radicals derived from benzene (e.g., phenyl), substituted benzene, naphthalene, anthracene and biphenyl. It is understood that the term “aryl” encompasses polyaromatic radicals, such as naphtalenyl. Biphenyl, fluorenyl, anthracenyl, phenanthrenyl, phenalenyl. The polyaromatic radicals can be substituted or unsubstituted.

The term “Arylalkyl”, as used herein, means an acyclic alkyl radical in which one of the hydrogen atoms bonded to a carbon atom, typically a terminal or sp³ carbon atom, is replaced with an aryl radical. Typical arylalkyl groups include, but are not limited to, benzyl, 2-phenylethan-1-yl, naphthylmethyl, 2-naphthylethan-1-yl, naphthobenzyl, 2-naphthophenylethan-1-yl and the like. For example, and without being limiting, the arylalkyl group can include 7 to 20 carbon atoms, e.g., the alkyl moiety is 1 to 6 carbon atoms and the aryl moiety is 6 to 14 carbon atoms.

The term “Arylalkenyl”, as used herein, means an acyclic alkenyl radical in which one of the hydrogen atoms bonded to a carbon atom, typically a terminal or sp³ carbon atom, but also an sp² carbon atom, is replaced with an aryl radical. The aryl portion of the arylalkenyl can include, for example, any of the aryl groups described herein, and the alkenyl portion of the arylalkenyl can include, for example, any of the alkenyl groups described herein. The arylalkenyl group can include 8 to 20 carbon atoms, e.g., the alkenyl moiety is 2 to 6 carbon atoms and the aryl moiety is 6 to 14 carbon atoms.

The term “Arylalkynyl”, as used herein, means an acyclic alkynyl radical in which one of the hydrogen atoms bonded to a carbon atom, typically a terminal or sp³ carbon atom, but also an sp carbon atom, is replaced with an aryl radical. The aryl portion of the arylalkynyl can include, for example, any of the aryl groups disclosed herein, and the alkynyl portion of the arylalkynyl can include, for example, any of the alkynyl groups disclosed herein. For example, and without being limiting, the arylalkynyl group can include 8 to 20 carbon atoms, e.g., the alkynyl moiety is 2 to 6 carbon atoms and the aryl moiety is 6 to 14 carbon atoms.

The term “steroidyl group”, as used herein, refers to a steroid fused ring system which can be covalently bound to the polycarboxylic acid derivative. Non-limiting examples of steroids include cholesterol, cholic acid, lanosterol and chenodeoxycholic acid. Is should be understood that the steroidyl group can be attached to the polycarboxylic acid derivative in various ways and via an oxygen, nitrogen, sulfur or carbon atom of the streroidyl group.

The term “protecting group”, as used herein, means a moiety of a compound that masks or alters the properties of a functional group or the properties of the compound as a whole. The chemical substructure of a protecting group can greatly vary. One function of a protecting group is to serve as an intermediate in the synthesis of the parental active substance. Chemical protecting groups and strategies for protection/deprotection are well known in the art. See: “Protective Groups in Organic Chemistry”, Theodora W. Greene (John Wiley & Sons, Inc., New York, 1991).

The term “substituted”, as used herein in reference to alkyl, alkylene, alkoxy, alkenyl, alkynyl, alkenylene, aryl, alkynylene, etc., for example “substituted alkyl”, “substituted alkylene”, “substituted alkoxy”-“or substituted O(Alkyl)”, “substituted alkenyl”, “substituted alkynyl”, “substituted alkenylene”, “substituted aryl” and “substituted alkynylene”, unless otherwise indicated, means alkyl, alkylene, alkoxy, alkenyl, alkynyl, alkenylene, aryl and alkynylene, respectively, in which one or more hydrogen atoms are each independently replaced with a non-hydrogen substituent.

Typical non-hydrogen substituents include, but are not limited to, -X, -R^{B}, —O⁻, ═O, —OR^{B}, —SR^{B}, —S⁻, —NR^{B}₂, Si(R^{C})₃, —N⁺R^{B}₃, —NR^{b}-(Alk)-NR^{B}₂, —NR^{B}-(Alk)-N⁺R^{B}₃, —NR^{B}-(Alk)-OR^{B}, —NR^{B}-(Alk)-OP(═O)(OR^{B})(O⁻), —NR^{B}-(Alk)-OP(═O)(OR^{B})₂, —NR^{B}-(Alk)-Si(R^{C})₃, —NR^{B}-(Alk)-SR^{B}, —O-(Alk)-NR^{B}₂, —O-(Alk)-N⁺R^{B}₃, —O-(Alk)-OR^{B}, —O-(Alk)-OP(═O)(OR^{B})(O⁻), —O-(Alk)-OP(═O)(OR^{B})₂, —O-(Alk)-Si(R^{C})₃, —O-(Alk)-SR^{B}, ═NR^{B}, —CX₃, —CN, —OCN, —SCN, —N═N═O, —NCS, —NO, —NO₂, ═N₂, —N₃, —NHC(═O)R^{B}, —OC(═O)R^{B}, —NHC(═O)NR^{B}₂, —S(═O)₂—, —S(═O)₂OH, —S(═O)₂R⁸, —OS(═O)₂OR^{B}, —S(═O)₂NR^{B}₂, —S(═O)R^{B}, —OP(═O)(OR^{B})(O⁻), —OP(═O)(OR^{B})₂, —P(═O)(OR^{B})₂, —P(═O)(O⁻)₂, —P(═O)(OH)₂, —P(O)(OR^{B})(O⁻), —C(═O)R^{B}, —C(═O)X, —C(S)R^{B}, —C(O)OR^{B}, —C(O)O⁻, —C(S)OR^{B}, —C(O)SR^{B}, —C(S)SR^{B}, —C(O)NR^{B}₂, —C(S)NR^{B}₂ or —C(═NR^{B})NR^{B}₂ where X is independently a halogen; F, Cl, Br, or I; each R^{B} is independently H, alkyl, aryl, arylalkyl, a heterocycle, an alkyloxy group such as poly(ethyleneoxy), PEG or poly(methyleneoxy), or a protecting group; each R^{C} is independently alkyl, O(alkyl) or O(tri-substituted silyl); and each Alk is independently alkylene, substituted alkylene, alkenylene, substituted alkenylene, alkynylene or substituted alkynylene. Unless otherwise indicated, when the term “substituted” is used in conjunction with groups such as arylalkyl, which have two or more moieties capable of substitution, the substituents can be attached to the aryl moiety, the alkyl moiety, or both.

The term “PEG” or “poly(ethylene glycol)”, as used herein, is meant to encompass any water-soluble poly(ethylene oxide). Typically, substantially all, or all monomeric subunits are ethylene oxide subunits, though the PEG can contain distinct end capping moieties or functional groups. PEG chains of the present description can include one of the following structures: —(CH₂CH₂₀)ₘ— or —(CH₂CH₂₀)ₘ₋₁CH₂CH₂—, depending on if the terminal oxygen has been displaced, where m is a number, optionally selected from 1 to 100, 1 to 50, 1 to 30, 5 to 30, 5 to 20 or 5 to 15. The PEG can be capped with an “end capping group” that is generally a non-reactive carbon-containing group attached to a terminal oxygen or other terminal atom of the PEG. Non-limiting examples of end capping groups can include alkyl, substituted alkyl, aryl, substituted aryl, alkenyl, substituted alkenyl, alkynyl, substituted alkynyl, CO(alkyl), CO(substituted alkyl), CO(alkenyl), CO(substituted alkenyl), CO(alkynyl) or CO(substituted alkynyl). In the present description, it is understood that “(EO)t” means “—(CH₂CH₂₀)ₜ—”. Similarly, the term “(PO)_{w1}” means “—(CH(CH₃)CH₂₀)_{w1}—”. It is also understood that the numbers t and w1 can be integers or non-integers. It is understood that when t and/or w1 are non-integers, several compounds are present in a mixture, and the value of t and w1 represents a mean value.

A person skilled in the art will recognize that substituents and other moieties of the compounds of the present description should be selected in order to provide a useful compound which can be formulated into an acceptably stable antimicrobial composition, preferably an antibiofilm composition, that can be applied to surfaces. The definitions and substituents for various genus and subgenus of the compounds of the present description are described and illustrated herein. It should be understood by a person skilled in the art that any combination of the definitions and substituents described herein should not result in an inoperable species or compound. It should also be understood that the phrase “inoperable species or compound” means compound structures that violate relevant scientific principles (such as, for example, a carbon atom connecting to more than four covalent bonds) or compounds too unstable to permit isolation and formulation into acceptable antimicrobial or antibiofilm compositions.

Selected substituents of the compounds of the present description can be present to a recursive degree. In this context, “recursive substituent” means that a substituent may recite another instance of itself. Because of the recursive nature of such substituents, theoretically, a large number of compounds can be present in any given implementation. For example, RX includes a R^{y} substituent. R^{y} can be R. R can be W³. W³ can be W⁴ and W⁴ can be R or include substituents including R. A person skilled in the art of organic chemistry understands that the total number of such substituents is to be reasonably limited by the desired properties of the compound intended. Such properties include, by way of example and not limitation, physical properties such as molecular weight, solubility or log P, application properties such as activity against the intended target, possibility of application in antimicrobial compositions or antibiofilm compositions, surface tension, foamability, and practical properties such as ease of synthesis. Typically, each recursive substituent can independently occur 20, 19, 18, 17, 16, 15, 14, 13, 12, 11, 10, 9, 8, 7, 6, 5, 4, 3, 2, 1, or 0, times in a given implementation. For example, each recursive substituent can independently occur 3 or fewer times in a given implementation. Recursive substituents are an intended aspect of the compounds of the present description. A person skilled in the art of organic chemistry understands the versatility of such substituents.

The term “optionally substituted”, as used herein in reference to a particular moiety of the compounds of the present description, means a moiety wherein all substituents are hydrogen or wherein one or more of the hydrogens of the moiety can be replaced by substituents such as those listed under the definition of the term “substituted” or as otherwise indicated.

It will be understood that all enantiomers, diastereomers, and racemic mixtures, tautomers, polymorphs, and pseudopolymorphs of compounds within the scope of the formulae and compositions described herein and their salts, are embraced by the present description. All mixtures of such enantiomers and diastereomers are also within the scope of the present description.

The modifier “about” used in connection with a quantity is inclusive of the stated value and has the meaning dictated by the context. For example, the modifier “about” can include the degree of error associated with the measurement of the quantity.

It will be understood that the compounds described herein can be in their un-ionized, ionized, as well as zwitterionic form, and in combinations with various amounts of water (e.g., stoichiometric amounts of water) such as in hydrates.

Whenever a compound described herein is substituted with more than one of the same designated group, e.g., “R₁” or “R₂”, then it will be understood that the groups may be the same or different, i.e., each group is independently selected. For example, in the formula “CH(R^{x})₃” with each R^{x} being independently alkyl or aryl”, it is understood that each R^{x} can independently be selected from alkyl groups and aryl groups. CH(R^{x})₃ therefore includes both symmetrical groups where all three R^{x} are the same and asymmetrical groups where at least one R^{x} group is different from the other two R^{x} groups, or where each R^{x} group is different. It is also understood that this applies to all R_{q}, Z or Y_{q} groups defined herein (e.g., q being selected from 1 to 7). Any given group “R₁” will be understood to be necessarily the same as another group “R₂ ” only when it is explicitly stated that “R₁=R₂”.

The compounds described herein can also exist as tautomeric forms in certain cases. Although only one delocalized resonance structure will typically be depicted, all such forms are contemplated within the scope of the present description.

### Polycarboxylic Acid Derivatives

The combinations and compositions of the present description include a polycarboxylic acid derivative onto which a hydrophobic moiety and/or poly(ethylene oxide) moiety and/or (poly)propylene oxide moiety is covalently bound. In some scenarios, the polycarboxylic acid derivative can act as a chelating agent and as a surfactant. It is understood that the term “polycarboxylic acid derivative”, as used in the present description, refers to a polycarboxylic acid onto which a hydrophobic moiety is covalently bound, and/or onto which a poly(ethylene oxide) and/or (poly)propylene oxide moiety is covalently bound. In some implementations, the polycarboxylic acid derivative is an aminopolycarboxylic acid. In some implementations, the polycarboxylic acid derivative is a hydroxy polycarboxylic acid, such as a a-hydroxy polycarboxylic acid.

It should be understood that the polycarboxylic acid derivative can be present as a salt or as a free acid. The polycarboxylic acid derivative can, in some scenarios, be complexed to a metal. In other scenarios, the polycarboxylic acid derivative can be metal-free.

The polycarboxylic acid derivative can be obtained by covalently binding a hydrophobic moiety onto a polycarboxylic acid, or by synthesizing the polycarboxylic acid derivative in another manner. Non-limiting examples of polycarboxylic acids include dicarboxylic acids, tricarboxylic acids, tetracarboxylic acids and pentacarboxylic acids.

Non-limiting examples of dicarboxylic acids include malic acid, fumaric acid, oxalic acid, malonic acid, succinic acid, glutaric acid, adipic acid, pimelic acid, suberic acid, azelaic acid, sebacic acid, undecanedioic acid, dodecanedioic acid, tartaric acid, alanine diacetic acid (ADA), ethanolamine diacetic acid, ethylenediaminediglutaric acid, aspartic acid (L-aspartic acid, D-aspartic acid or DL-aspartic acid), glutamic acid (L-glutamic acid, D-glutamic acid or DL-glutamic acid), ethylenediaminedipropionic acid (EDDP) and ethylenediaminedi(hydroxyphenylacetic acid (EDDHA).

Non-limiting examples of tricarboxylic acids include citric acid, isocitric acid, aconitic acid, propane-1,2,3-tricarboxylic acid, agaric acid, trimesic acid, hydroethylenediaminetriacetic acid (HEDTA).

Non-limiting examples of tetracarboxylic acids include 1,2,3,4-butanetetracarboxylic acid, ethylenediaminetetraacetic acid (EDTA), ethylenediaminedisuccinate (EDDS), cyclohexanediaminetetraacetic acid (CDTA), glycol ether diaminetetraacetic acid (GEDTA), 1,2-doaminopropanetetraacetic acid (DPTA-OH), 1,3-diamino-2-propanoltetraacetic acid (DPTA), ethylenediaminetetrapropionic acid (EDTP).

A non-limiting example of a pentacarboxylic acid is diethylenetriaminepentaacetic acid (DTPA).

It should be understood that the hydrophobic moiety can be covalently bound to the polycarboxylic acid moiety directly via one of the carboxylic acid groups, via another functional group present in the polycarboxylic acid, or via any carbon or heteroatom (oxygen, nitrogen, etc.) of the polycarboxylic acid. For example, the hydrophobic moiety can be covalently bound to a hydroxy functional group present on the polycarboxylic acid, to a carbon atom on the polycarboxylic acid, or to an amino group present on the polycarboxylic acid.

In some implementations, the polycarboxylic acid derivative is an aminopolycarboxylic acid derivative can be obtained by covalently binding a hydrophobic moiety, a poly(ethyleneoxide) moiety and/or a poly(propyleneoxide) moiety onto an aminopolycarboxylic acid, or by synthetizing the aminopolycarboxylic acid derivative in another manner (e.g., via a Michael addition). Non-limiting examples of aminopolycarboxylic acids include ethylenediaminetetraacetic acid (EDTA), diethylenetriaminepentaacetic acid (DTPA), hydroethylenediaminetriacetic acid (HEDTA), ethylenediaminedisuccinate (EDDS), cyclohexanediaminetetraacetic acid (CDTA), glycol ether diaminetetraacetic acid (GEDTA), alanine diacetic acid (ADA), 1,2-doaminopropanetetraacetic acid (DPTA-OH), 1,3-diamino-2-propanoltetraacetic acid (DPTA), ethanolamine diacetic acid, ethylenediaminediglutaric acid (EDDG), ethylenediaminedipropionic acid (EDDP), ethylenediaminedi(hydroxyphenylacetic acid (EDDHA) and ethylenediaminetetrapropionic acid (EDTP).

Preferably, the aminopolycarboxylic acid derivative is based on one of the following aminopolycarboxylic acid scaffolds: ethylenediaminetetraacetic acid (EDTA), diethylenetriaminepentaacetic acid (DTPA), hydroethylenediaminetriacetic acid (HEDTA), cyclohexanediaminetetraacetic acid (CDTA), glycol ether diaminetetraacetic acid (GEDTA), 1,2-doaminopropanetetraacetic acid (DPTA-OH), 1,3-diamino-2-propanoltetraacetic acid (DPTA), ethylenediaminedipropionic acid (EDDP) and ethylenediaminetetrapropionic acid (EDTP).

In some implementations, the aminopolycarboxylic acid derivative is a compound of general Formula (I) represented below, or a salt thereof.

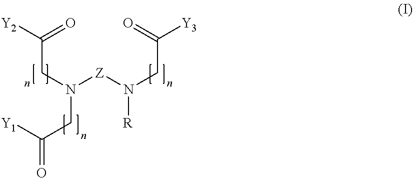

In one aspect, the compound of Formula (I), or salt thereof, is selected such that:
R is selected from the group consisting of

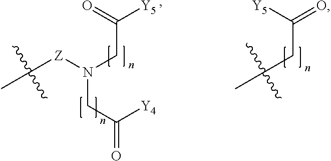

(C₁-C₂₄)alkyl,
(C₂-C₂₄)alkenyl, (C₂-C₂₄)alkynyl, -(EO)ₜ-(PO)_{w1}-(C₁-C₂₄)alkyl, -(EO)ₜ-(PO)_{w1}(C₂-C₂₄)alkenyl,
-(EO)ₜ-(PO)_{w1}-(C₂-C₂₄)alkynyl, -(PO)_{w1}-(EO)ₜ-(C₁-C₂₄)alkyl,
-(PO)_{w1}-(EO)ₜ-(C₂-C₂₄)alkenyl, -(PO)_{w1}-(EO)ₜ-(C₂-C₂₄)alkynyl, —(CH₂)ₚ—OR₁, —(CH₂)ₚ—NR₁R₂, —(CH₂)ₚ—OC(═O)R₁, —(CH₂)ₚ—NR₂C(═O)R₁, (C₁-C₂₄)acyl, aryl and a steroidyl group;
each Y₁, Y₂, Y₃ and Y₄ is independently selected from the group consisting of —OR₃ and —NR₃R₄;
Y₅ is selected from the group consisting of —OR₁ and —NR₁R₂;
each R₁ is independently selected from the group consisting of (C₁-C₂₄)alkyl,
-(EO)ₜ-(C₁-C₂₄)alkyl, (C₂-C₂₄)alkenyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl,
-(PO)_{w1}-(EO)ₜ-(C₂-C₂₄)alkenyl, -(PO)_{w1}-(EO)ₜ-(C₂-C₂₄)alkynyl, aryl and a steroidyl group;
each R₂, R₃ and R₄ is independently selected from the group consisting of H, (C₁-C₂₄)alkyl, (C₂-C₂₄)alkenyl, (C₂-C₂₄)alkynyl, -(EO)ₜ-(PO)_{w1}(C₁-C₂₄)alkyl, -(EO)ₜ-(PO)_{w1}(C₂-C₂₄)alkenyl, -(EO)ₜ-(PO)_{w1}(C₂-C₂₄)alkynyl, -(PO)_{w1}(EO)ₜ-(C₁-C₂₄)alkyl, -(PO)_{w1}(EO)ₜ-(C₂-C₂₄)alkenyl, -(PO)_{w1}(EO)ₜ-(C₂-C₂₄)alkynyl, aryl and a steroidyl group;
each Z is independently selected from the group consisting of (C₂-C₆)alkylene, (C₃-C₆)cycloalkylene and —(CH₂)2—O—(CH₂)2—O—(CH₂)2-;
wherein each (C₂-C₆)alkylene and (C₃-C₆)cycloalkylene is independently unsubstituted or substituted by one or more identical or different substituents R₅;
wherein each aryl, (C₁-C₂₄)alkyl, (C₂-C₂₄)alkenyl and (C₂-C₂₄)alkynyl is independently unsubstituted or substituted by one or more identical or different substituents R₆;
wherein each R₅ and each R₆ is independently selected from the group consisting of halogen, —OH, —O—(C₁-C₄)alkyl, CF₃, and —CN;
each n is independently 1, 2, 3 or 4;
each p is independently 2, 3 or 4;
each t is independently a number between 1 and 50; and
each w1 is independently a number between 0 and 10.

In some implementations, at least one of Y₁, Y₂, Y₃ and Y₄ is —OH. In some implementations, at least two of Y₁, Y₂, Y₃ and Y₄ are—OH.

In some implementations, R₁ is independently selected from the group consisting of (C₈-C₁₈)alkyl, (C₈-C₁₈)alkenyl, (C₈-C₁₈)alkynyl and a steroidyl group. In some implementations, each R₃ is independently selected from the group consisting of H, (C₈-C₁₈)alkyl, (C₈-C₁₈)alkenyl, (C₈-C₁₈)alkynyl and a steroidyl group.

In some implementations, each R₁ is independently selected from the group consisting of (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl, -(EO)ₜ-(C₈-C₁₈)alkynyl and a steroidyl group, wherein each t is independently a number between 1 and 30. In some implementations, each R₁ is independently selected from the group consisting of (C₈-C₁₈)alkyl and -(EO)ₜ-(C₈-C₁₈)alkyl, wherein each t is independently a number between 1 and 30. In some implementations, each R₃ is independently selected from the group consisting of H, (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl, -(EO)ₜ-(C₈-C₁₈)alkynyl and a steroidyl group, wherein each t is independently a number between 1 and 30. In some implementations, each R₃ is independently selected from the group consisting of H, (C₈-C₁₈)alkyl and (EO)ₜ-(C₈-C₁₈)alkyl, wherein each t is independently a number between 1 and 30. In the present description, it is understood that when any -(EO)ₜ-(PO)_{w1}-(C₁-C₂₄)alkyl/alkenyl/alkynyl or -(PO)_{w1}-(EO)ₜ-(C₁-C₂₄)alkyl/alkenyl/alkynyl group is written as -(EO)ₜ-(C₁-C₂₄)alkyl/alkenyl/alkynyl, w1 is equal to 0.

In some implementations, R₂ and R₄ are each H.

In some implementations, the steroidyl group is:

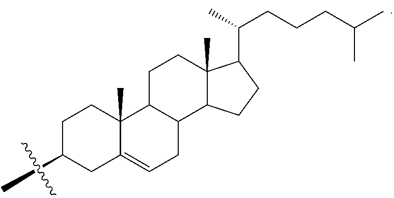

In some implementations, Z is selected from the group consisting of —CH₂—CH₂—,

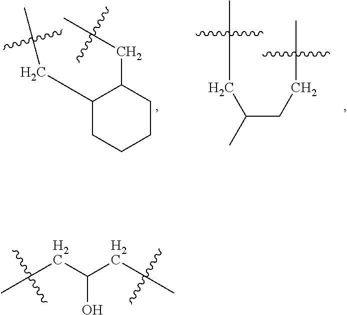

and —(CH₂)₂—O—(CH₂)₂—O—(CH₂)₂—. In some implementations, Z is —CH₂—CH₂—.

In some implementations, n is preferably 1 or 2 and p is preferably 2. In some implementations, n is 1 and p is 2.

In some implementations, R is

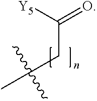

In some implementations, Y₂=OH and Y₃=OH. In some implementations, Y₁=OH. In other implementations, Y₁=Y₅.

In some implementations, the compound of Formula (I), or salt thereof, is a compound of Formula (IA) or Formula (IB), or a salt thereof, where R₁, R₂, R₃ and R₄ are as defined hereinabove:

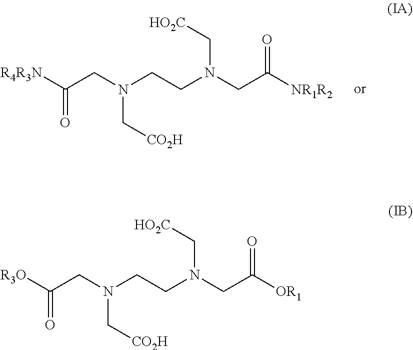

In some implementations, the compounds of Formula (IA) or (IB) include a single hydrophobic chain at R₁, and all the other substituents R₂, R₃ and R₄ are H. In other implementations, the compounds of Formula (IA) or (IB) include two hydrophobic chains at R₁ and R₃, and the other substituents R₂ and R₄ are H. In such case, R₁ and R₃ can be the same or different.

In some implementations, the compound of Formula (I), or salt thereof, is a compound of Formula (IC) or Formula (IB),

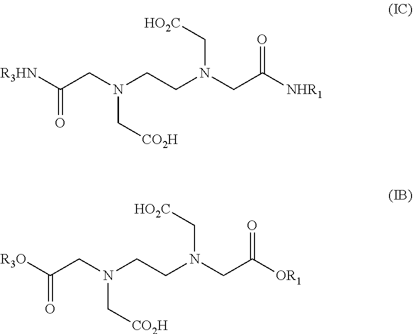

or a salt thereof, wherein:
each R₁ is independently selected from the group consisting of (C₈-C₂₄)alkyl,
-(EO)ₜ-(C₈-C₂₄)alkyl, (C₈-C₂₄)alkenyl, -(EO)ₜ-(C₈-C₂₄)alkenyl, (C₈-C₂₄)alkynyl and
-(EO)ₜ-(C₈-C₂₄)alkynyl;
each R₃ is independently selected from the group consisting of H, (C₈-C₂₄)alkyl,
-(EO)ₜ-(C₈-C₂₄)alkyl, (C₈-C₂₄)alkenyl, -(EO)ₜ-(C₈-C₂₄)alkenyl (C₈-C₂₄)alkynyl and
-(EO)ₜ-(C₈-C₂₄)alkynyl,
wherein each t is independently a number between 1 and 50.

In some implementations, each R₁ is independently selected from the group consisting of (C₈-C₁₈)alkyl, -(EO)ₜ-(C₈-C₁₈)alkyl, (C₈-C₁₈)alkenyl, -(EO)ₜ-(C₈-C₁₈)alkenyl, (C₈-C₁₈)alkynyl and -(EO)ₜ-(C₈-C₁₈)alkynyl;
each R₃ is independently selected from the group consisting of H, (C₈-C₁₈)alkyl, -(EO)ₜ-(C₈-C₁₈)alkyl, (C₈-C₁₈)alkenyl, -(EO)ₜ-(C₈-C₁₈)alkenyl (C₈-C₁₈)alkynyl and -(EO)ₜ-(C₈-C₁₈)alkynyl,
wherein each t is independently a number between 1 and 50.

In some implementations, each R₁ is independently selected from the group consisting of (C₈-C₁₈)alkyl and -(EO)ₜ-(C₈-C₁₈)alkyl;
each R₃ is independently selected from the group consisting of H, (C₈-C₁₈)alkyl, and -(EO)ₜ-(C₈-C₁₈)alkyl,
wherein each t is independently a number between 1 and 50.

In some implementations, each R₁ is independently selected from the group consisting of (C₈-C₁₈)alkyl and -(EO)ₜ-(C₈-C₁₈)alkyl;
each R₃ is independently selected from the group consisting of H, (C₈-C₁₈)alkyl, and -(EO)ₜ-(C₈-C₁₈)alkyl,
wherein each t is independently a number between 1 and 30.

In some implementations, R₁ is a (C₈-C₁₈)alkyl; and R₃ is H or (C₈-C₁₈)alkyl.

In some implementations, the polycarboxylic acid compound is a compound of Formula (IB), or a salt thereof. In other implementations, the polycarboxylic acid compound is a compound of Formula (IC), or a salt thereof.

Non-limiting examples of compounds of Formula (I) include:

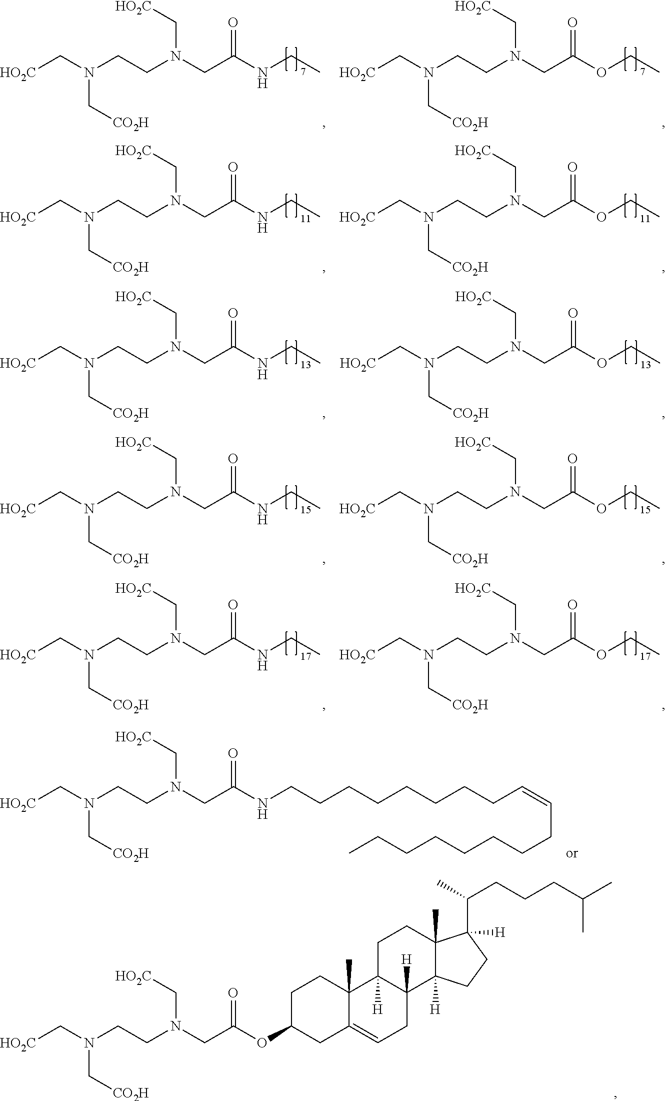

or a salt thereof.

Other non-limiting examples of compounds of Formula (I) include:

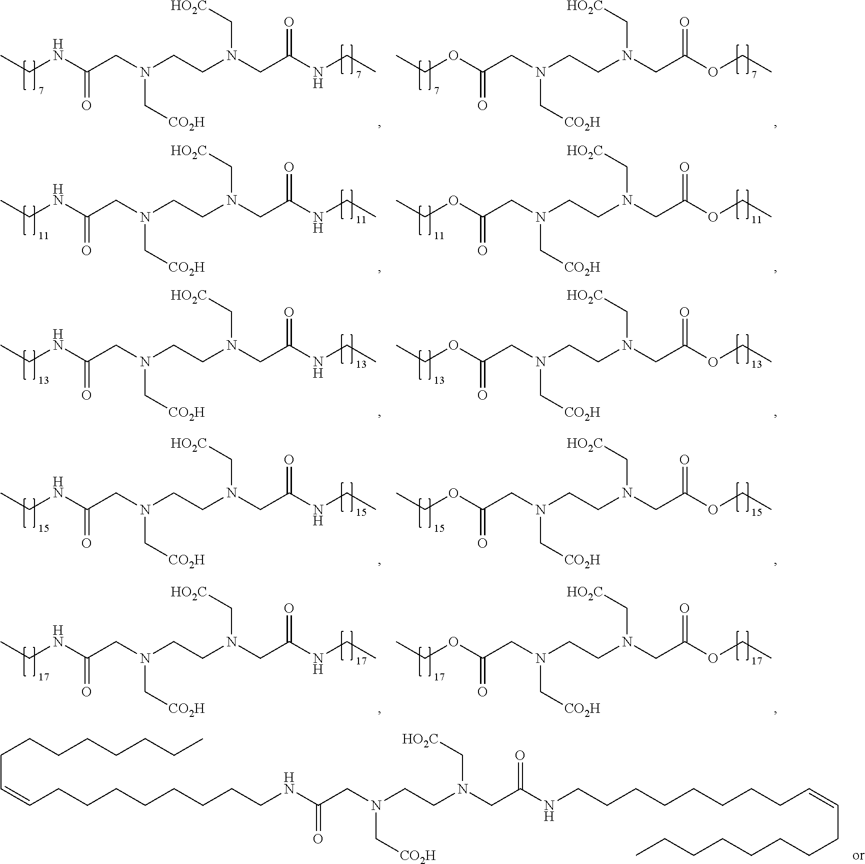

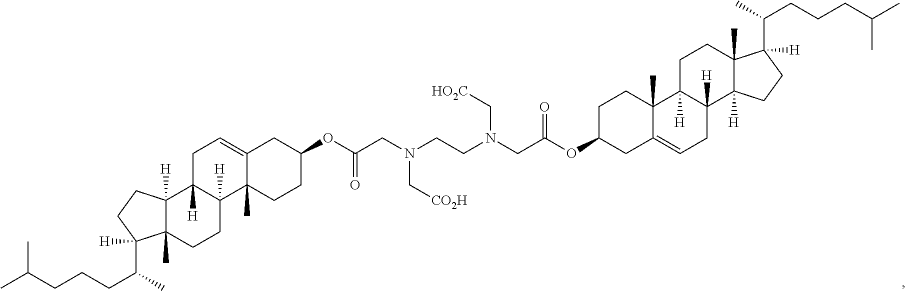

or a salt thereof.

Other non-limiting examples of compounds of Formula (I) include:

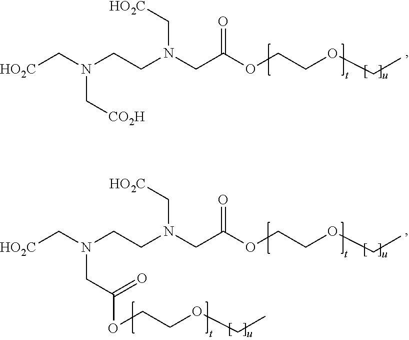

mixtures thereof, or a salt thereof, wherein t is a number between 1 and 50 and u is a number between 7 and 17.

In some implementations, the compound of Formula (I) is selected from the group consisting of:

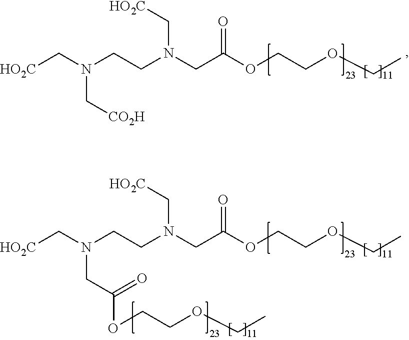

and mixtures thereof, or a salt thereof.

In some implementations, R is

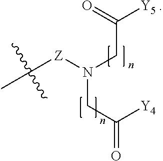

In some implementations, Y₂=OH, Y₃=OH and Y₄=OH. In some implementations, Y₁=OH. In other implementations, Y₁=Y₅.

Other non-limiting examples of compounds of Formula (I) include:

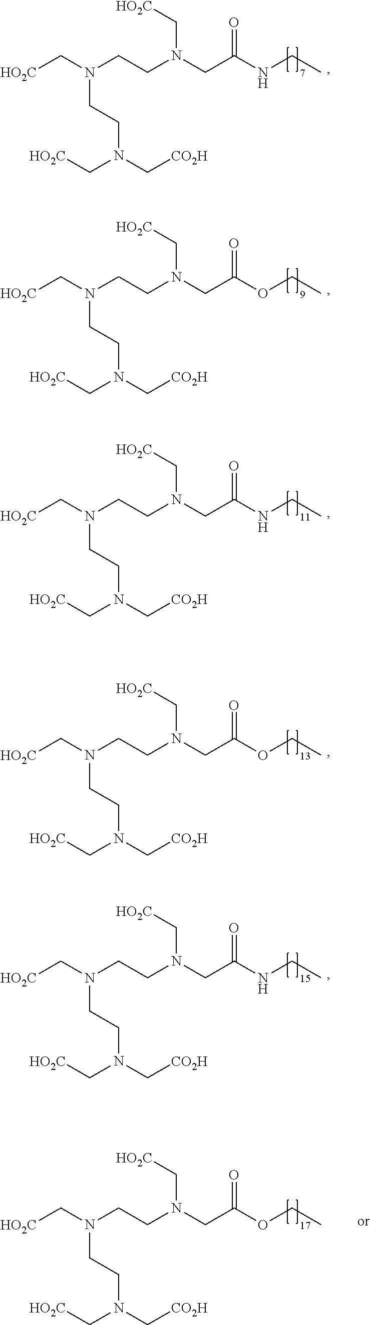

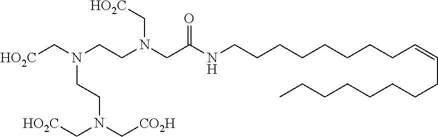 [SMILES: CCCCCCCC/C=C\CCCCCCCCNC(=O)CN(CCN(CCN(CC(=O)O)CC(=O)O)CC(=O)O)CC(=O)O]

or a salt thereof.

In some implementations, R is (C₈-C₁₈)alkyl, (C₈-C₁₈)alkenyl or (C₈-C₁₈)alkynyl. In some implementations, n=2. In some implementations, Y₁=OH, Y₂=OH and Y₃=OH.

Other non-limiting examples of compounds of Formula (I) include:

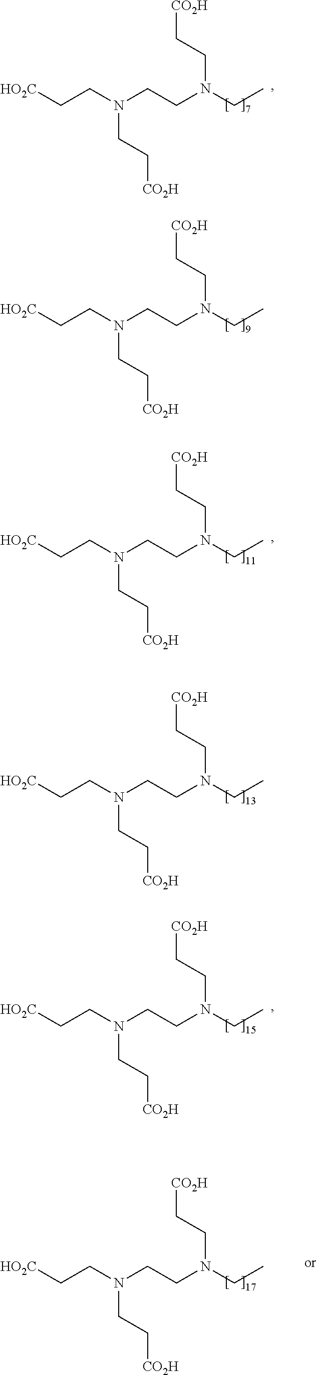

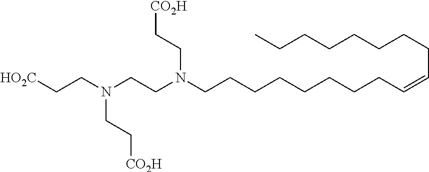 [SMILES: CCCCCCCC/C=C\CCCCCCCCN(CCC(=O)O)CCN(CCC(=O)O)CCC(=O)O]

or a salt thereof.

In some implementations, R is —(CH₂)ₚ—OC(═O)R₁. In some implementations, p=2. In some implementations, n is 1 or 2. In some implementations, Y₁=OH, Y₂=OH and Y₃=OH.

Other non-limiting examples of compounds of Formula (I) include:

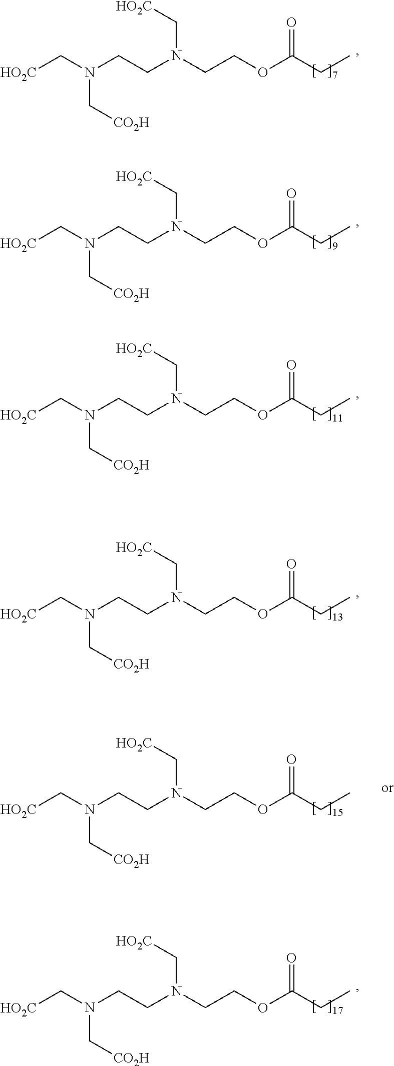

or a salt thereof.

Other non-limiting examples of compounds of Formula (I) include:

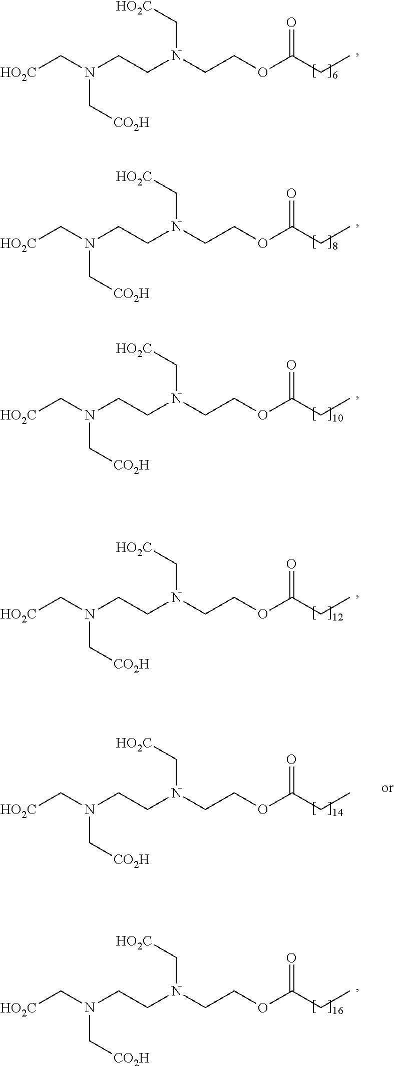

or a salt thereof.

Other non-limiting examples of compounds of Formula (I) include:

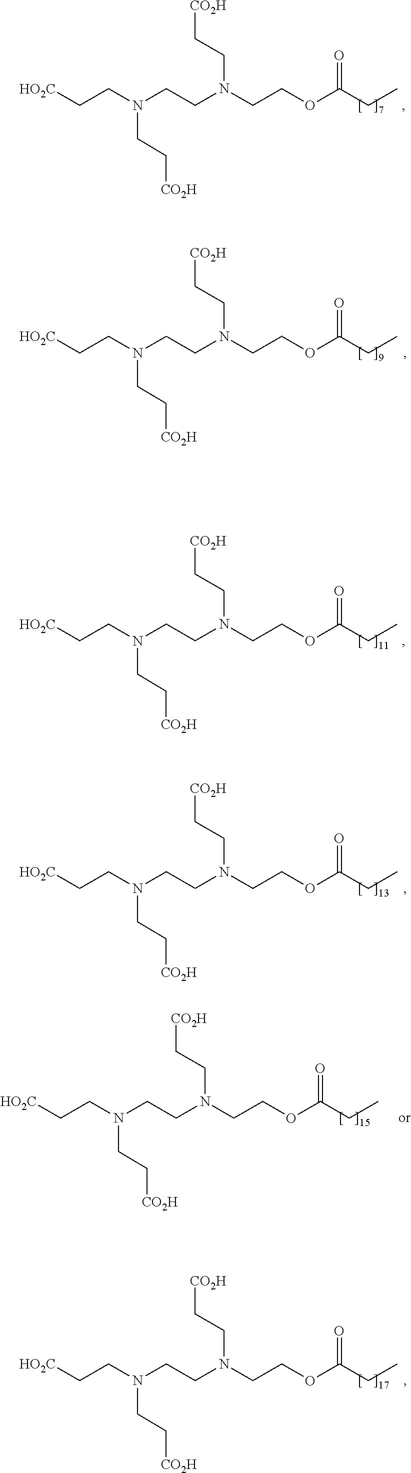

or a salt thereof.

Other non-limiting examples of compounds of Formula (I) include:

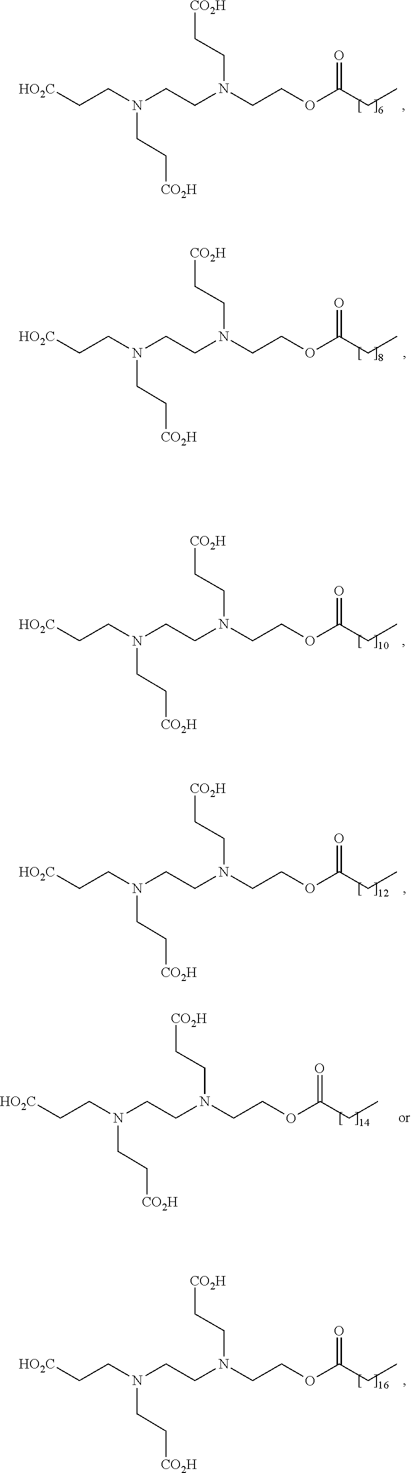

or a salt thereof.

In some implementations, the polycarboxylic acid derivative is a compound of general formula (II) represented below, or a salt thereof.

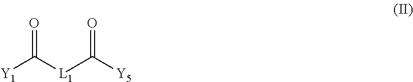

In one aspect, the compound of Formula (II), or salt thereof, is selected such that:
Y₁ is selected from the group consisting of —OR₃ and —NR₃R₄;
Y₅ is selected from the group consisting of —OR₁ and —NR₁R₂; each R₁ is independently selected from the group consisting of (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl, -(PO)_{w1}-(EO)ₜ-(C₂-C₂₄)alkynyl, aryl and a steroidyl group;
each R₂, R₃ and R₄ is independently selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl, -(PO)_{w1}-(EO)ₜ-(C₂-C₂₄)alkynyl, aryl and a steroidyl group;
each L₁ is independently selected from the group consisting of a bond, (C₁-C₁₂)alkylene, (C₂-C₁₂)alkenylene, (C₂-C₁₂)alkynylene, (C₃-C₆)cycloalkylene, —CH₂—N(CH₂CH₂OH)—CH₂—, —CH₂CH₂NHCH₂CH₂NHCH₂CH₂—, —CHR₇NHCH₂CH₂NHCHR₇—, and —(CH₂)₂—O—(CH₂)₂—O—(CH₂)₂—;
wherein each (C₁-C₁₂)alkylene, (C₂-C₁₂)alkenylene, (C₂-C₁₂)alkynylene, and (C₃-C₆)cycloalkylene is independently unsubstituted or substituted by one or more identical or different substituents R₁₁;
wherein each aryl, (C₁-C₂₄)alkyl, (C₂-C₂₄)alkenyl and (C₂-C₂₄)alkynyl is independently unsubstituted or substituted by one or more identical or different substituents R₆;
wherein each R₆ and R₇ is independently selected from the group consisting of halogen, substituted or unsubstituted phenyl, —OH, —O—(C₁-C₄)alkyl, CF₃, and —CN;
wherein each R₁₁ is independently selected from the group consisting of halogen, substituted or unsubstituted phenyl, (C₁-C₁₆)alkyl, (C₁-C₁₆)alkenyl, (C₁-C₁₆)alkynyl, —OH, —O—(C₁-C₄)alkyl, CF₃, —CN, —COOH, —(C═O)Y₅,
wherein each t is independently a number between 1 and 50; and
wherein each w1 is a number between 1 and 10.

In some implementations, Y₁=OH.

In some implementations, the polycarboxylic acid derivative is an a-hydroxy polycarboxylic acid of general Formula (III) represented below, or a salt thereof.

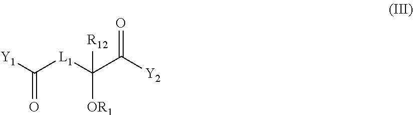

In one aspect, the compound of Formula (III), or salt thereof, is selected such that:
R₁₂ is H or -L-(C═O)Y₃;
Y₁, Y₂ and Y 3 are each independently selected from the group consisting of —OR₃ and —NR₃R₄;
R₁ is selected from the group consisting of (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl, -(PO)_{w1}-(EO)ₜ-(C₂-C₂₄)alkynyl, aryl and a steroidyl group;
each R₃ and R₄ is independently selected from the group consisting of H, (C₁-C₂₄)alkyl, (C₂-C₂₄)alkenyl, (C₂-C₂₄)alkynyl, -(EO)ₜ-(PO)_{w1}(C₁-C₂₄)alkyl, -(EO)ₜ-(PO)_{w1}(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl, -(PO)_{w1}-(EO)ₜ-(C₂-C₂₄)alkynyl, aryl and a steroidyl group;
each L₁ is independently selected from the group consisting of a bond, (C₁-C₁₂)alkylene, (C₂-C₁₂)alkenylene, (C₂-C₁₂)alkynylene, (C₃-C₆)cycloalkylene, —CH₂—N(CH₂CH₂OH)—CH₂—, —CH₂CH₂NHCH₂CH₂NHCH₂CH₂—, —CHR₇NHCH₂CH₂NHCHR₇—, and —(CH₂)₂—O—(CH₂)₂—O—(CH₂)₂—;
wherein each (C₁-C₁₂)alkylene, (C₂-C₁₂)alkenylene, (C₂-C₁₂)alkynylene, and (C₃-C₆)cycloalkylene is independently unsubstituted or substituted by one or more identical or different substituents R₁₁;
wherein each aryl, (C₁-C₂₄)alkyl, (C₂-C₂₄)alkenyl and (C₂-C₂₄)alkynyl is independently unsubstituted or substituted by one or more identical or different substituents R₆;
wherein each R₆ and R₇ is independently selected from the group consisting of halogen, substituted or unsubstituted phenyl, —OH, —O—(C₁-C₄)alkyl, CF₃, and—CN;
wherein each R₁₁ is independently selected from the group consisting of halogen, substituted or unsubstituted phenyl, (C₁-C₁₆)alkyl, (C₁-C₁₆)alkenyl, (C₁-C₁₆)alkynyl, —OH, —O—(C₁-C₄)alkyl, CF₃, —CN, —COOH, —(C═O)Y₅,
wherein each t is independently a number between 1 and 50; and
wherein each w1 is independently a number between 1 and 10.

In some implementations, R₁₂ is -L-(C═O)Y₃. In some implementations, Y₁, Y₂ and Y₃ are each —OH.

In some implementations, the compound of Formula (III) is a compound of Formula (IIIA).

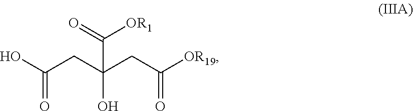

or a salt thereof, wherein:
R₁₉ is selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl and -(PO)_{w1}-(EO)ₜ-(C₂-C₂₄)alkynyl;
R₁₈ is selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl and -(PO)_{w1}-(EO)ₜ-(C₂-C₂₄)alkynyl;
wherein at least one of R₁₈ and R₁₉ is not H;
each (C₁-C₂₄)alkyl, (C₂-C₂₄)alkenyl and (C₂-C₂₄)alkynyl is independently unsubstituted or substituted by one or more identical or different substituents R₆;
wherein each R₆ is independently selected from the group consisting of halogen, —OH, —O—(C₁-C₄)alkyl, CF₃, and—CN;
each t is independently a number between 1 and 50; and
each w1 is independently a number between 1 and 10.

In some implementations, R₁₈ is selected from the group consisting of H, (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl and -(EO) t -(C₈-C₁₈)alkynyl, wherein each t is independently a number between 1 and 30. In some implementations, R₁₉ is selected from the group consisting of H, (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl and -(EO)ₜ-(C₈-C₁₈)alkynyl, wherein each t is independently a number between 1 and 30.

In some implementations, R₁₈ is H and R₁₉ is selected from the group consisting of (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl and -(EO)ₜ-(C₈-C₁₈)alkynyl, wherein each t is independently a number between 1 and 30. In other implementations, R₁₉ is H and R₁₈ is selected from the group consisting of (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl and -(EO)ₜ-(C₈-C₁₈)alkynyl, wherein each t is independently a number between 1 and 30.

In some implementations, each (C₁-C₂₄)alkyl, (C₂-C₂₄)alkenyl and (C₂-C₂₄)alkynyl is unsubstituted.
the compound of Formula (IIIA) is:

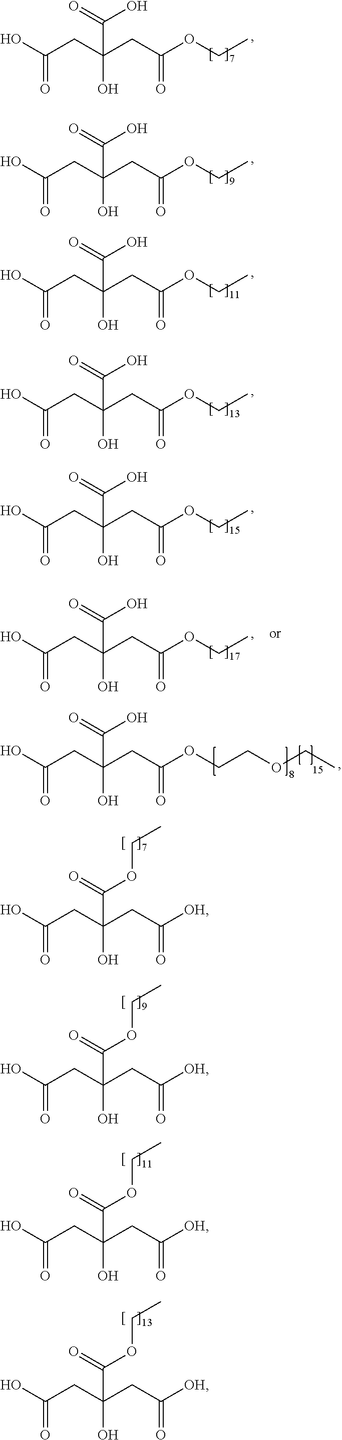

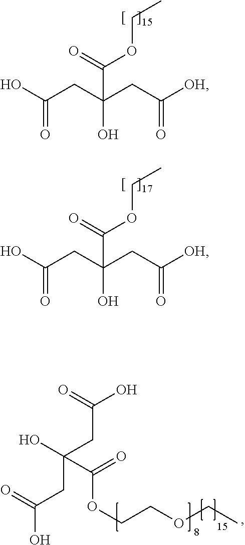

a salt thereof, or a mixture thereof.

In some implementations, the compound of Formula (IIIA) is selected from the group consisting of a compound of Formula (IIIA1), a compound of Formula (IIIA2), or a salt thereof, or a mixture thereof:

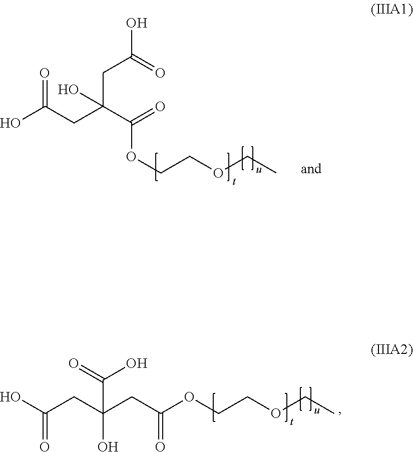

wherein t is a number between 0 and 50 and u is a number between 0 and 23. In some implementations, t=0 and u is between 7 and 17. In some implementations, t is between 5 and 15 and u is between 11 and 17. In some implementations, t is 8 and u is 15. In some implementations, the compound is a mixture of the compounds of Formulae (IIIA1) and (IIIA2), or salts thereof.

In some implementations, the polycarboxylic acid derivative is a derivative of aspartic acid (D-aspartic acid, L-aspartic acid or DL-aspartic acid). In some implementations, the polycarboxylic acid derivative is a compound of Formula (VII):

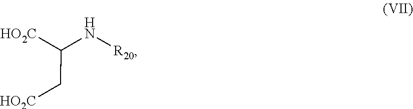

or a salt thereof, wherein:
R₂₀ is selected from the group consisting of: (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl, -(PO)_{w1}-(EO)ₜ-(C₁-C₂₄)alkyl, -(PO)_{w1}-(EO)ₜ-(C₂-C₂₄)alkenyl, -(PO)_{w1}-(EO)ₜ-(C₂-C₂₄)alkynyl,

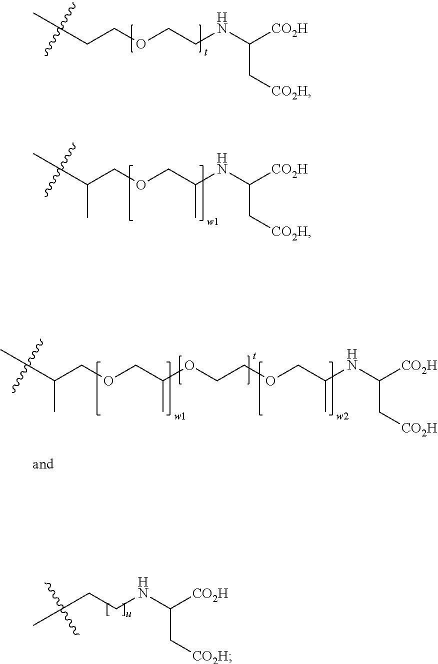

t is a number between 1 and 50;
u is a number between 1 and 23;
w1 is a number between 0 and 10; and
w2 is a number between 0 and 10;
each (C₁-C₂₄)alkyl, (C₂-C₂₄)alkenyl and (C₂-C₂₄)alkynyl is independently unsubstituted or substituted by one or more identical or different substituents R₆;
wherein each R₆ is independently selected from the group consisting of halogen, —OH, —O—(C₁-C₄)alkyl, CF₃, and —CN.

In some implementations, R₂₀ is selected from the group consisting of (C₈-C₁₈)alkyl, (C₈-C₁₈)alkenyl, (C₈-C₁₈)alkynyl, -(EO)ₜ-(C₈-C₁₈)alkyl, -(EO)ₜ-(C₈-C₁₈)alkenyl and -(EO) t -(C₈-C₁₈)alkynyl, wherein t is a number between 1 and 30. In some implementations, R₂₀ is unsubstituted (C₈-C₁₈)alkyl.

In some implementations, the compound of Formula (VII) is

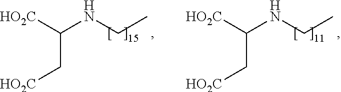

or a salt thereof.

In some implementations, R₂₀ is:

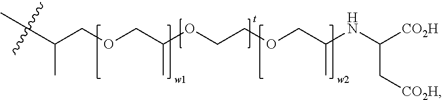

wherein: t is a number from 5 to 40; and the sum of w1+w2 is a number from 3 to 8.

In some implementations, the polycarboxylic acid derivative can be combined with a base, such as a weak base, for improved aqueous solubility. Non-limiting examples of bases that can be used include triethanolamine, TRIS-buffer (2-Amino-2-(hydroxymethyl)propane-1,3-diol, sodium bicarbonate, potassium bicarbonate, sodium carbonate or potassium carbonate.

### Essential Oil

The combinations and compositions of the present description can include an essential oil. The term “essential oil”, as used herein, refers to volatile liquids that can be extracted from plant material. Essential oils are often concentrated hydrophobic liquids containing volatile aroma compounds. Essential oil chemical constituents can fall within several classes of chemical compounds, such as terpenes (e.g., p-cymene, limonene, sabinene, α-pinene, γ-terpinene, β-caryophyllene), terpenoids (e.g., cinnamaldehyde, eugenol, vanillin, safrole), Essential oils can be natural (i.e., derived from plants), or synthetic. Non-limiting examples of essential oils can include one or more of the following oils: African basil, bishop's weed, cinnamon, clove, coriander, cumin, garlic, kaffir lime, lime, lemongrass, mustard oil, menthol, oregano, rosemary, savory, Spanish oregano, thyme, anise, ginger, bay leaf, sage, bergamot, eucalyptus, melaleuca, peppermint, spearmint, wintergreen, cannibus, marjoram, orange, rose, and combinations thereof.

In some implementations, the essential oil includes at least one of thymol, eugenol, geranial, nerol, citral, carvacrol, cinnamaldehyde, terpinol, α-terpinene, citronella, citronellal, citronellol, geraniol, geranyl acetate, limonene, lavender oil, orange oil, methyl isoeugenol and mixtures thereof.

### Biosurfactants

The combinations and compositions of the present description can include a biosurfactant selected from the group consisting of an alkyl polyglycoside, a rhamnolipid, a sophorolipid and a combination thereof. It is understood that the biosurfactant can be natural or synthetic.

The biosurfactant can include an alkyl polyglycoside. The term “alkyl polyglycoside”, as used herein, refers to a nonionic surfactant, which may be alkoxylated with one or more alkylene oxide groups (e.g., C₂-C₄ alkylene oxide groups). In some implementations, the biosurfactant is an alkyl polyglycoside.

In some implementations, the alkyl polyglycoside may be represented by Formula (IV):

R₇O—(R₈O)ₓ(G)_{DP} (IV)
wherein:
R₇ is a (C₆-C₂₄)alkyl, (C₆-C₂₄)alkenyl or (C₆-C₂₄)alkynyl, which is substituted or unsubstituted, or an alkylaryl group including a linear or branched (C₆-C₂₄)alkyl group; R₈ is an alkylene group comprising from 2 to 4 carbon atoms;
G is a saccharide unit comprising from 5 to 6 carbon atoms;
x is a value between 0 and 10, or between 0 and 4; and
DP is a value ranging from 1 to 15.

In some implementations, R₇ is a (C₈-C₁₈)alkyl, (C₈-C₁₈)alkenyl or (C₈-C₁₈)alkynyl, which is substituted or unsubstituted. Preferably, R₇ is a (C₈-C₁₈)alkyl. Non-limiting examples of substituents for R₇ include halogen, —OH, —O—(C₁-C₄)alkyl, CF₃, and —CN.

In some implementations, G is glucose, fructose or galactose. Preferably, G is glucose.

In some implementations, x is between 0 and 3. In some implementations, x=0.

The degree of polymerization of the alkyl polkyglycoside is represented by DP in formula (IV) and ranges on average from 1 to 15, or from 1 to 4. Preferably, DP ranges from 1 to 2, or from about 1.1 to about 1.5.

The glycoside bonds between the saccharide units can be of 1-6 or 1-4 type.

Non-limiting examples of alkyl polyglycosides include the Plantacare™, Glucopon™, NaturalAPG™ and Atlox™ products.

In some implementations, the alkylpolyglycoside is a C8-C10 alkylpolyglycoside, or a C9-C11 alkyl polyglycoside, or a C8-C16 alkylpolyglycoside, or a C12-C16 alkylpolyglycoside, or a C12-C14 alkylpolyglycoside. In some implementations, the alkyl polyglycoside can be added in combination with additives such as sodium sulfate, sodium silicate, sodium coco sulfate, alcohol ethoxylate and mixtures thereof.

In some implementations, the biosurfactant can include a rhamnolipid. The term “rhamnolipid”, as used herein, implies indistinctively crude or highly purified rhamnolipids. Rhamnolipids are a class of glycolipid produced by microorganisms such as Pseudomonas aeruginosa. Rhamnolipids have a glycosyl head group, such as a rhamnose moiety, and a 3-(hydroxyalkanoyloxy)alkanoic acid (HAA) fatty acid tail, such as 3-hydroxydecanoic acid. Rhamnolipids include mono-rhamnolipids and di-rhamnolipids, which include of one or two rhamnose groups respectively. Rhamnolipids are also typically heterogeneous in the length and degree of branching of the HAA moiety, which varies with the growth media used and the environmental conditions.

In some implementations, the rhamnolipid is a compound represented by the following general Formula (V):

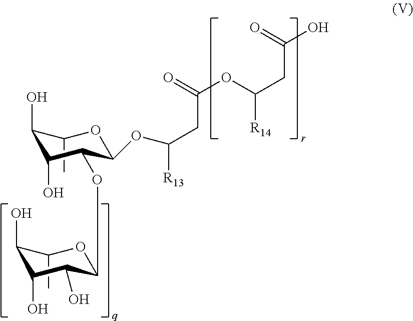

In some implementations, the compound of Formula (V) is selected such that:
r=0, 1 or 2;
q=0 or 1;
R₁₃ and R₁₄ are each independently a (C₁-C₂₄)alkyl, (C₂-C₂₄)alkenyl or a (C₂-C₂₄)alkynyl, preferably a (C₈-C₁₈)alkyl, (C₈-C₁₈)alkenyl or a (C₈-C₁₈)alkynyl, wherein R₁₃ and R₁₄ are each independently optionally branched, optionally substituted with at least one of halogen, —OH, —O—(C₁-C₄)alkyl, CF₃, and —CN, and preferably substituted with at least one—OH.

In some implementations, the biosurfactant can include a sophorolipid. The term “sophorolipid”, as used herein, refers to a surface-active glycolipid compound that can be synthesized by a number of yeast species. The term “sophorolipid” refers to a compound comprising a residue of sophorose (i.e., the disaccharide consisting of two glucose residues linked by a β-1,2′ bond, and a fatty acid as an aglycone. The sophorolipid can be acetylated on the 6 and/or 6′-positions of the sophorose residue. One terminal or subterminal hydroxylated fatty acid is β-glycosidically linked to the sophorose moiety. The hydroxy fatty acid residue can have one or more unsaturated bonds. The carboxlic group of the fatty acid is either free (acidic or open form) or internally esterified (lactonic form). It is understood that sophorolipids can exist in the form of lactones, either or both in monomeric or in dimeric forms.

In some implementations, the sophorolipid is a compound represented by the following general Formula (VI):

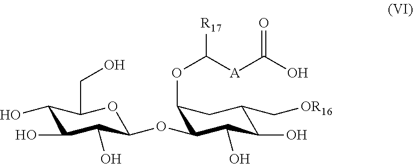

In some implementations, the compound of Formula (VI) is selected such that:
R₁₅ and R₁₆ are each independently selected from H or Ac;
R₁₇ is H or methyl;
A is a (C₈-C₂₄)alkylene, (C₈-C₂₄)alkenylene or a (C₈-C₂₄)alkynylene which is optionally branched, optionally substituted with at least one of halogen, —OH, —O—(C₁-C₄)alkyl, CF₃, and —CN.

### Additives and Adjuvants

In some implementations, the combinations and compositions of the present description can include one or more additives or adjuvants.

In some implementations, a second oil can be added to the combination or composition. The second oil can be selected from the group consisting of a mineral oil (e.g., paraffinic oil) or a vegetable oil and a mixture thereof.

Non-limiting examples of vegetable oils include oils that contain medium chain triglycerides (MCT), or oil extracted from nuts. Other non-limiting examples of vegetable oils include coconut oil, canola oil, soybean oil, rapeseed oil, sunflower oil, safflower oil, peanut oil, cottonseed oil, palm oil, rice bran oil or mixtures thereof. Non-limiting examples of mineral oils include paraffinic oils, branched paraffinic oils, naphthenic oils, aromatic oils or mixtures thereof.

Non-limiting examples of paraffinic oils include various grades of poly-alpha-olefin (PAO). For example, the paraffinic oil can include HT60™, HT100™, High Flash Jet, LSRD™, and N65DW™. The paraffinic oil can include a paraffin having a number of carbon atoms ranging from about 12 to about 50, or from about 16 to 35. In some scenarios, the paraffin can have an average number of carbon atoms of 23. In some implementations, the oil can have a paraffin content of at least 80 wt %, or at least 90 wt %, or at least 99 wt %.

In some implementations, the only oil in the combination or composition is the essential oil (i.e., the combination or composition is free of paraffinic oil or vegetable oil).

In some implementations, an additional surfactant can be added to the combination or composition. The additional surfactant can be a nonionic surfactant, a cationic surfactant, an anionic surfactant, a zwitterionic surfactant or a combination thereof.

Non-limiting examples of non-ionic surfactants include ethoxylated alcohol, a polymeric surfactant, a fatty acid ester, a poly(ethylene glycol), an ethoxylated alkyl alcohol, a monoglyceride, an alkyl monoglyceride, a polysorbate, and a mixture thereof. For example, the fatty acid ester can be a sorbitan fatty acid ester. The additional surfactant can include a plant derived glycoside such as a saponin. The additional surfactant can be a polysorbate type surfactant (e.g., Tween 80) or another suitable nonionic surfactant.

In some implementations, the poly(ethylene glycol) can include a poly(ethylene glycol) of Formula R⁹—O—(EO)_{f}-R¹⁰, wherein: each R⁹ and R¹⁰ is each, independently, H, alkyl, substituted alkyl, aryl, substituted aryl, CO(alkyl) or CO(substituted alkyl); and f is an integer selected from 1 to 100; wherein the substituted alkyl groups are, independently, substituted with one or more F, Cl, Br, I, hydroxy, alkenyl, CN and N₃.

Non-limiting examples of anionic surfactants include sulfate, sulfonate, phosphate and carboxylates anionic surfactants. Non-limiting examples of anionic surfactants include ammonium lauryl sulfate, sodium lauryl sulfate, sodium dodecyl sulfate (SDS), sodium dodecylbenzene sulfonate, sodium lauryl ether sulfate, dioctyl sodium sulfosuccinate, perfluorooctane sulfonate, alkyl-aryl ether phosphates, alkyl ether phosphates and sodium stearate. In some implementations, a sodium or potassium alkyl sulfate surfactant or alkylaryl sulfate surfactant (e.g., an alkylbenzene sulfate surfactant) is included in the antibiofilm composition.

Non-limiting examples of cationic surfactants include primary, secondary or tertiary amines that become positively charged at pH lower than about 10, such as octenidine dihydrochloride. Another non-limiting example of a cationic surfactant includes permanently charged quaternary ammonium salts such as cetrimonium bromide (CTAB), cetylpyridinium chloride (CPC), benzalkonium chloride (BAC), benzethonium chloride (BZT), dimethyldioctadecylammonium chloride and dioctadecyldimethylammonium bromide (DODAB).

Non-limiting examples of zwitterionic surfactants include sultaines such as 3-[(3-cholamidopropyl)dimethylammonio]-1-propanesulfonate or betaines such as cocamidopropyl betaine.

In other implementations, the combination or composition is free of an additional surfactant (i.e., the only surfactants in the combination or composition is the biosurfactant and the polycarboxylic acid derivative—in cases where the polycarboxylic acid derivative possesses surfactant properties).

In some implementations, the combination further includes water. In some implementations, the combination or composition further includes a non-aqueous solvent. In some implementations, the combination further includes water and a non-aqueous solvent. In some implementations, the non-aqueous solvent is at least partially soluble in water. Non-limiting examples of non-aqueous solvents include ethanol, acetone, isopropanol, ethylene glycol, pyrrolidone, propylene glycol and mixtures thereof. The combination or composition can include between about 0.1 wt % and about 50 wt %, or between about 0.1 wt % and about 20 wt %, or between about 0.1 wt % and about 15 wt %, or between about 0.1 wt % and about 10 wt %, or between about 0.1 wt % and about 5 wt % non-aqueous solvent, based on a total weight of the combination or composition. In other implementations, the combination or composition is free of non-aqueous solvent.

In some implementations, a fragrance can be added to the antibiofilm combinations of the present description. The fragrance can, for example, be used to mask the odor of the essential oil and/or to provide a specific odor to the antibiofilm composition.

### Antibiofilm Compositions

It should be understood that the polycarboxylic acid derivatives described herein, the biosurfactants described herein and the essential oils described herein are provided together as part of an antibiofilm combination and/or an antibiofilm composition. In some implementations, the components of the antibiofilm combination can be packaged in a concentrated form, without water or with little water, and water can be added to form the composition directly by the operator that can then apply the composition to surfaces. In some implementations, the combination is provided as a 1-pack composition or as a multiple-pack system (e.g., a 2-pack system). For example, the polycarbocylic acid derivative can be provided as in a first pack and the other components can be provided in a second pack. A user can combine each pack of the multiple-pack system with water (or an appropriate solvent) prior to use.

In some implementations the antibiofilm composition includes a polycarboxylic acid derivative onto which a hydrophobic group is covalently bound, an essential oil and a biosurfactant. The composition can further include one or more adjuvants or additives. For example, the composition can further include at least one of an additional oil and an additional surfactant. The composition can further include one or more non-aqueous solvents.

When the components are provided as part of a single composition, the ready-to-use composition can be provided to have certain concentrations and relative proportions of components. The ready-to-use composition can include between about 0.1 wt % and about 10 wt %, or between about 0.25 wt % and about 5 wt %, or between about 0.5 wt % and about 5 wt %, or between about 0.5 wt % and about 3 wt %, or between about 1 wt % and about 3 wt % of polycarboxylic acid derivative, based on a total weight of the composition.

The ready-to-use composition can include between about 0.1 wt % and about 25 wt %, between about 0.1 wt % and about 10 wt %, or between about 0.25 wt % and about 5 wt %, or between about 0.5 wt % and about 5 wt %, or between about 0.5 wt % and about 3 wt %, or between about 1 wt % and about 3 wt % of biosurfactant, based on a total weight of the composition.

The ready-to-use composition can include between about 0.1 wt % and about 25 wt %, between about 0.1 wt % and about 10 wt %, or between about 0.25 wt % and about 5 wt %, or between about 0.5 wt % and about 5 wt %, or between about 0.5 wt % and about 4 wt %, or between about 1 wt % and about 3 wt % of essential oil, based on a total weight of the composition.

The ready-to-use composition can include between about 0.1 wt % and about 25 wt %, between about 0.1 wt % and about 15 wt %, between about 0.1 wt % and about 12.5 wt %, between about 0.1 wt % and about 10 wt %, or between about 0.25 wt % and about 5 wt %, or between about 0.5 wt % and about 5 wt %, or between about 0.5 wt % and about 3 wt %, or between about 1 wt % and about 3 wt % of weak base, such as sodium or potassium bicarbonate, based on a total weight of the composition. In some implementations, the same amount of polycarboxylic acid derivative and weak base are added (either by wt % or molar per non-alkylated free carboxylic acid group).

For example, and without being limiting, the relative proportion, by weight, of the polycarboxylic acid derivative and the essential oil in the composition can be between about 100:1 and about 1:100, between about 20:1 and about 1:20, between about 10:1 and about 1:10, or between about 1:5 and about 5:1.

For example, and without being limiting, the relative proportion, by weight, of the polycarboxylic acid derivative and the biosurfactant in the composition can be between about 100:1 and about 1:100, between about 20:1 and about 1:20, between about 10:1 and about 1:10, or between about 1:5 and about 5:1.

For example, and without being limiting, the relative proportion, by weight, of the essential oil and the biosurfactant in the composition can be between about 100:1 and about 1:100, between about 20:1 and about 1:20, between about 10:1 and about 1:10, or between about 1:5 and about 5:1.

In some embodiments, the antibiofilm composition includes:
between about 0.1 wt % and about 25 wt % biosurfactant;
between about 0.1 wt % and about 25 wt % essential oil;
between about 0.1 wt % and about 25 wt % polycarboxylic acid derivative; and water.

In some embodiments, the antibiofilm composition includes:
between about 0.1 wt % and about 25 wt % biosurfactant;
between about 0.1 wt % and about 25 wt % essential oil;
between about 0.1 wt % and about 15 wt % polycarboxylic acid derivative; and water.

In some embodiments, the antibiofilm composition includes:
between about 0.1 wt % and about 5 wt % biosurfactant;
between about 0.1 wt % and about 5 wt % essential oil;
between about 0.1 wt % and about 5 wt % polycarboxylic acid derivative; and water.

In some embodiments, the antibiofilm composition includes:
between about 1 wt % and about 5 wt % biosurfactant;
between about 0.25 wt % and about 5 wt % essential oil;
between about 0.25 wt % and about 5 wt % polycarboxylic acid derivative; and water.

In some embodiments, the antibiofilm composition includes:
between about 1 wt % and about 5 wt % biosurfactant;
between about 0.25 wt % and about 5 wt % essential oil;
between about 0.25 wt % and about 3 wt % polycarboxylic acid derivative; and water.

The antibiofilm compositions described herein can further include an additional surfactant or be free of any additional surfactant. The additional surfactant can be present in an of up to about 25 wt %, up to about 20 wt %, up to about 15 wt %, up to about 10 wt %, up to about 5 wt %, up to about 4 wt %, up to about 3 wt %, up to about 2 wt %, up to about 1 wt % or up to about 0.5 wt %. The additional surfactant can be as described hereinabove.

In some scenarios, the antibiofilm combinations of the present description can have antibacterial, anti-fungi and/or anti-viral properties. In some scenarios, the antibiofilm combinations of the present description are effective against biofilms comprising at least one of gram-negative bacteria and gram-positive bacteria. In some scenarios, the antibiofilm combinations of the present description are effective against biofilms comprising gram-negative bacteria and gram-positive bacteria.

In some implementations, the antibiofilm compositions are non-foaming. In other words, the antibiofilm compositions can, upon being thoroughly mixed, maintain or go back to its original height within 30 seconds to a minute after being mixed.

### Synergistic Effect of the Combinations

In some scenarios, the components of the combinations or compositions of the present description can exhibit a synergistic response for inhibiting the formation of biofilms and/or for disrupting preformed biofilms. It should be understood that the terms “synergy” or “synergistic”, as used herein, refer to the interaction of two or more components of a combination (or composition) so that their combined effect is greater than the sum of their individual effects. This may include, in the context of the present description, the action of two or more of the polycarboxylic acid derivative, essential oil and biosurfactant. In some scenarios, the polycarboxylic acid derivative and the essential oil can be present in synergistically effective amounts. In some scenarios, the polycarboxylic acid derivative and the biosurfactant can be present in synergistically effective amounts. In some scenarios, the essential oil and the biosurfactant can be present in synergistically effective amounts. In some scenarios, the polycarboxylic acid derivative, the essential oil and the biosurfactant can be present in synergistically effective amounts.

In some scenarios, the approach as set out in S. R. Colby, “Calculating synergistic and antagonistic responses of herbicide combinations”, Weeds 15, 20-22 (1967), can be used to evaluate synergy. Expected efficacy, E, may be expressed as: E=X+Y(100−X)/100, where X is the efficacy, expressed in % of the untreated control, of a first component of a combination, and Y is the efficacy, expressed in % of the untreated control, of a second component of the combination. The two components are said to be present in synergistically effective amounts when the observed efficacy is higher than the expected efficacy.

### EXAMPLES

### Synthesis

### Materials

Acetic acid, acetic anhydride 2-(2-aminoethylamino)ethanol, Brij™ 10, Brij™ -L23, tert-butyl acrylate, tert-butyl chloroacetate, 1,1′-carbonyldiimidazole, citric acid, dimethylaminopyridine (DMAP), ethylenediamine tetraacetic acid, disodium salt (EDTA), EDTA-dianhydride, 1-hexadecanol (95%), hexadecylamine, Jeffamine™ ED-600, 1-octanol, octylamine, maleic acid, maleic anhydride, N-methylmorpholine N,N′-dimethylethylenediamine, palmitoyl chloride, pig liver esterase (PLE) triethylamine, trifluoroacetic acid (TFA), p-toluenesulfonic acid (p-TsOH), dimethylsulfoxide (DMSO, anhydrous) and pyridine were purchased from Sigma-Aldrich™ and used as received. Inorganic salts NaHCO₃, Na₂SO₄, Na₂HPO₄, KH₂PO₄, LiCl and Celite were also purchased from Sigma-Aldrich. Solvents chloroform, dimethylformamide (DMF), isopropanol (IPA), and diethyl ether (anhydrous) were obtained from Caledon™ and used as received. Dichloromethane (DCM), ethyl acetate (EtOAc), toluene, hexane were also obtained from Caledon and dehydrated using an activated alumina column prior to use. Ethanol was purchased from Commercial Alcohols™.

### Characterization

¹H and ¹³C NMR spectra were recorded on a Bruker™ AV-600 spectrometer at room temperature using CDCl₃ as solvent and analyzed using Bruker Topspin™. Infrared spectroscopy was done using a Thermo Scientific™ Nicolet™ 6700 FT-IR spectrometer using a Smart iTX™ attenuated total reflectance (ATR) attachment. Electrospray ionization mass spectrometry (ESI-MS) was performed using an Agilent™ 6340 Ion Trap mass spectrometer. Sample concentrations were ˜50-100 μM.

EDTA-mono-C₁₆ ester

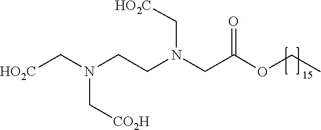

EDTA-mono-C16 ester was obtained by esterification of EDTA with 1-hexadecanol.

¹H NMR (8, 600.13 MHz, DMSO-d6): 0.79; (t, 3H, J=7.0 Hz), 1.17-1.20; (m, 26H), 1.46-1.50; (m, 2H), 2.68-2.69; (m, 2H), 3.37; (s, 2H), 3.39; (s, 4H), 3.47-3.48; (m, 2H), 3.95; (t, J=6.6 Hz) ppm. ¹³C NMR (8, 150.9 MHz, DMSO-d6): 14.4, 22.6, 25.8, 28.6, 29.1, 29.2, 29.38, 29.42, 29.47, 29.49, 51.7, 52.0, 54.9, 55.0, 55.1, 64.3, 171.4, 172.8 ppm. MS-ESI (HRMS) m/z calculated for C₂₆H₄₇N₂O₈ (M−H)⁻: 515.3338. Found: 515.3354.

EDTA-di-C₁₆ ester

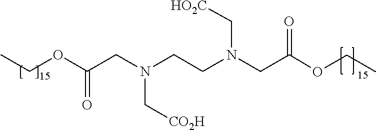

A mixture of EDTA dianhydride (2.002 g, 7.81 mmol) and 1-hexadecanol (3.984 g, 15.61mmol) in pyridine (7.5 mL, 93.67 mol) was stirred overnight at 80° C. The reaction mixture was cooled to room temperature, H₂O (10 mL) was added, and the pH was adjusted to about 4, with acetic acid (glacial). The precipitate was collected after centrifugation and washed with H₂O (3×20 mL) and extracted with chloroform (3×20 mL). The chloroform phase was concentrated and precipitated from diethyl ether, the precipitate was collected by filtration, and dried to give EDTA-di-C16 ester as pale-yellow solid (4.990 g, 83% yield).

¹H NMR (8, 600.13 MHz, CDCl₃): 0.90; (t, 6H, J=7.1 Hz), 1.28-1.33; (m, 52H), 1.63-1.68; (m, 4H), 3.10; (s, 4H), 3.68; (s, 4H), 3.78; (s, 4H), 4.14-4.16; (m, 4H) ppm. ¹³C NMR (8, 150.9 MHz, CDCl₃): 14.1, 22.7, 25.9, 28.5, 29.2, 29.3, 29.5, 29.6, 29.7 (br, multiple peaks overlapped), 31.9, 51.9, 55.2, 56.4, 65.6, 170.1, 172.2 ppm. MS-ESI (HRMS) m/z calculated for C₄₂H₇₉N₂O₈ (M−H)⁻: 739.5842. Found: 739.5856.

EDTA-di-C₈ ester

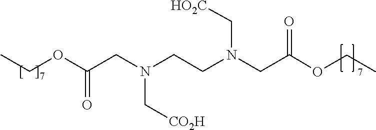

A mixture of EDTA dianhydride (3.000 g, 11.71 mmol) and 1-octanol (3.210 g, 23.42 mmol) in pyridine (11.3 mL, 140.51 mol) was stirred overnight at 80° C. The reaction mixture was cooled to room temperature, H₂O (10 mL) was added, and the pH was adjusted to about 4, with acetic acid (glacial). The precipitate was collected after centrifugation and washed with H₂O (3×20 mL), extracted with chloroform (3×20 mL), chloroform phase was concentrated and precipitated from diethyl ether, the precipitate was collected by filtration, dried to give EDTA-di-C₈ ester as pale-yellow solid (3.708g, 60% yield).

¹H NMR (8, 600.13 MHz, DMSO-d6): 0.85; (t, 6H, J=7.1 Hz), 1.26-1.35; (m, 20H), 1.54-1.58; (m, 4H), 2.74; (s, 4H), 3.44; (s, 4H), 3.54; (4H), 4.00-4.03; (m, 4H), 12.19; (br, 2H) ppm. ¹³C NMR (8, 150.9 MHz, DMSO-d6): 14.4, 22.5, 25.9, 28.6, 29.06-29.07 (multiple peaks), 31.7, 51.8, 54.9, 55.0, 64.2, 171.4, 172.8 ppm. MS-ESI (HRMS) m/z calculated for C₂₆H₄₇N₂O₈ (M−H)⁻: 515.3378. Found: 515.3354.

EDTA-mix-E023-C₁₂ ester

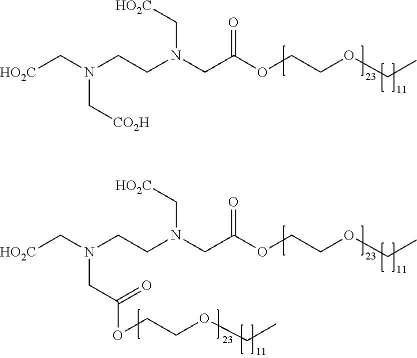

A mixture of EDTA dianhydride (0.500 g, 1.952 mmol), Brij-L23 (2.338 g, 1.952 mmol) and pyridine (1.852 g, 23.418 mmol) was stirred at 80° C. for 24 h. Toluene (20 mL) was added and was stirred for additional 10 mins, filtered and the filtrate was added hexane (20 mL), the mixture was stored at −4° C. overnight, filtered, washed with hexane (2x10 mL) and dried giving EDTA-mix-E023-012 ester as white solid (2.046 g, 72% yield based on mass balance). The product contained a minor amount of the di-adduct.

¹H NMR (8, 600.13 MHz, D₂O): 0.826; (t, J=6.9 Hz, 3H, 1.22; (br, 18H), 1.50; (br. 2H), 3.19; (s, br., 0.5H), 3.27; (s, 1.5H), 3.37-3.39; (m, 2H), 3.51; (s, br, 2H), 3.57-3.66; (m, 82H), 3.73-3.74; (m, 3H), 3.77; (s, 2H), 3.90; (s, br. 1H), 3.99; (s, 1.4H), 4.27-4.28; (m, 0.5H), 4.30-4.32; (m, 1.5H) ppm. ¹³C NMR (8, 150.9 MHz, D₂O):13.9, 22.6, 26.1, 29.5, 29.6, 29.8-29.9 (m), 48.5, 49.2, 51.1, 52.4, 54.5, 54.6, 55.1, 55.9, 56.2, 64.3, 64.8, 68.3, 69.6-70.0 (m), 71.0, 169.8, 170.3, 172.2 ppm.

Maleic-polyether-diamine

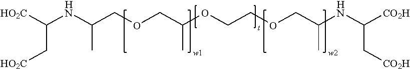

To maleic acid (1.210 g, 10.416 mmol) in isopropanol (20 mL) was added triethylamine (4.216 g, 41.67 mmol) and the mixture was stirred at room temperature for 30 min before the addition of Jeffamine™ ED-600 (2.500 g, 4.167 mmol, t=9, w1+w2=3.6) and LiCl (0.071 g, 1.667 mmol); the reaction was stirred at 80° C. for 48 h. The crude mixture was concentrated under reduced pressure, chloroform (30 mL) was added and the mixture was stirred for an additional 10 min, filtered through Celite and concentrated to ca. 5 mL under reduced pressure, then precipitated from diethyl ether (×10 mL) and dried in vacuo to give Maleic-polyether-diamine as a white solid (1.624 g, 47% yield).

¹H NMR (8, 600.13 MHz, D₂O): 1.08-1.11; (m, 6H), 1.20-1.26; (m, 12H), 2.61-2.65; (m, 4H), 2.69-2.76; (m, 4H), 3.20-3.31; (m, 2H), 3.46-3.53; (m, 8H), 3.60-3.79; (m, 70H), 3.85-3.90; (m, 4H) ppm.

EDTA-mono-C₁₆ amide

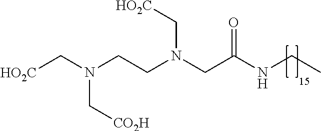

To a toluene (300 mL) dispersion of EDTA (7.5 g, 25.6 mmol) and ethanol (100 mL) was added conc. H₂SO₄ (5 mL) and the reaction mixture was stirred at reflux for 4 h. After cooling to room temperature, the reaction was neutralized by careful addition of saturated aq. NaHCO₃ solution. The resulting mixture was then extracted with DCM (100 mL×3) and water (100 mL). The combined organic layers were dried over Na₂SO₄, filtered, and concentrated in vacuo to afford EDTA tetraethyl ester (8.90 g, 86%) as a clear oil.

To a stirring emulsion of EDTA tetraethylester (5 g, 12.3 mmol) in water (375 mL) was added Na₂HPO₄ (9.8 g, 69 mmol) and KH₂PO₄ (0.29 g, 2.13 mmol) at 27° C. Then pig liver esterase (PLE) (60 mg, 900 units) was added and the mixture was stirred for 8 h. The reaction was extracted with dichloromethane (100 ml×5). The separated organic phase was dried over Na₂SO₄, filtered and concentrated in vacuo to afford EDTA triethylester monoacid (3.44 g, 74%) as an oil.

To a stirred solution of EDTA triethylester monoacid (2 g, 5.32 mmol) in DMF (12 mL) was added 1,1′-carbonyldiimidazole (CDI) (0.97 g, 5.97 mmol) and N-methylmorpholine (0.58 mL, 5.32 mmol). The reaction was stirred at room temperature under N₂ for 1 h. A solution of hexadecylamine (1.28 g, 5.32 mmol) in DMF (12 mL) was added and the reaction was stirred for 12 h. The solvent was concentrated in vacuo and extracted with DCM (50 mL×3) and H₂O (50 mL). The organic layer was collected, dried over Na₂SO₄, filtered, and concentrated in vacuo to afford EDTA triethyl ester hexadecylamide (3.29 g, quant.) as a white powder.

In a round-bottomed flask equipped with a magnetic stirring bar was added EDTA triethyl ester hexadecylamide (1.5 g, 2.43 mmol) in EtOH (20 mL). Then an NaOH aqueous solution (20 mL, 1 M) was added slowly. The mixture was stirred for 12 h and then concentrated under vacuum to remove the ethanol byproduct. The pH of the resulting water phase was adjusted to 2-3 with acetic acid, transferred to a Falcon tube and centrifuged. Water was decanted from the precipitate and the process was repeated 5 times (4000 rpm, 5×10 min). The resulting solid was dried in vacuo to obtain monohexadecylamide EDTA (0.81 g, 63%) as a white solid.

¹H NMR (8, 600 MHz, DMSO-d6): 8.09; (br, 1H), 3.53-3.46; (m, 6H), 3.10-3.06; (m, 2H), 2.83; (s, 4H), 1.43-1.37; (m, 2H), 1.22-1.18; (m, 26H), 0.86; (t, J=7.0 Hz,3H). ¹³C NMR (8, 150 MHz, DMSO-d6): 172.6, 172.2, 169.7, 57.6, 55.4, 54.9, 52.5, 51.7, 38.8, 31.8, 29.6, 29.5, 29.4, 29.2, 29.1, 22.6, 14.4 ppm.

HEDTA-C₁₆-ester

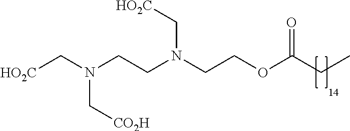

To a stirred solution of 2-(2-aminoethylamino)ethanol (5 g, 48.1 mmol) in DMF (110 mL) was added triethylamine (20.7 mL, 142.5 mmol) dropwise and tent-butyl chloroacetate (41.1 mL, 288 mmol); the reaction was stirred at 60° C. for 2 h, cooled to room temperature and the solvent was concentrated in vacuo. The residual oil was extracted with DCM (100 mL) and 1 M HCl (3×100 mL). The organic layer was collected, dried over Na₂SO₄ and filtered. After evaporation the residue was purified by flash column chromatography (hexanes:EtOAc, 50:50 to 25:75) to afford tri(t-butyl) HEDTA (11.8 g, 55%) as a light orange oil.

To a stirred solution of tri(t-butyl) HEDTA (2.4 g, 5.4 mmol) in dry DCM (55 mL) was added triethylamine (0.95 mL, 6.54 mmol) and 4-dimethylaminopyridine (50 mg, 0.4 mmol, as catalyst) at 0° C. After stirring for 10 min, palmitoyl chloride (1.8 g, 6.54 mmol) was added and the reaction was stirred an additional 12 h at room temperature. The reaction extracted with DCM (100 mL) and sat. NaHCO₃ (2×100 mL). The organic layer was collected, dried over Na₂SO₄ and filtered. The crude product was carried onto the next step.

To a stirred solution of palmitic tri(t-butyl) HEDTA (3.7 g, 5.4 mmol) in DCM (8 mL) was added TFA (8 mL). The reaction was stirred for 12 h at room temperature. The solvents were removed by rotary evaporation under reduced pressure and dried under high vacuum. Water was added to the crude mixture and the pH of the resulting water phase was adjusted to 2-3 with acetic acid and transferred to a Falcon tube and centrifuged. Water was decanted from the precipitate and the process was repeated 5 times (4000 rpm, 5×10 min). Toluene was added to the mixture in the Falcon tube, which was shaken and centrifuged. Toluene was decanted from the precipitate and the process was repeated 5 times (4000 rpm, 5×10 min). The resulting solid was dried in vacuo to obtain palmitic HEDTA ester (2.2 g, 77%) as a white solid.

¹H NMR (8, 600 MHz, DMSO-d6): 4.38-4.36; (s, 2H), 4.17; (s, 2H), 3.61; (s, 4H), 3.56-3.51; (s, 2H), 3.12-3.09; (m, 2H), 2.32-2.28; (m, 2H) 1.54-1.48; (m, 2H) 1.28-1.22; (s, 26H). ¹³C NMR (8, DMSO-d6, 150 MHz): 172.9, 168.8, 59.6, 55.0, 54.0, 53.3, 52.7, 49.7, 45.7, 40.5, 40.4, 40.3, 40.1, 40.0, 39.8, 39.7, 39.6, 31.8, 29.5, 29.4, 29.3, 29.2, 24.4, 8.9 ppm.

Citrate-EO8-C₁₆-ester-mix

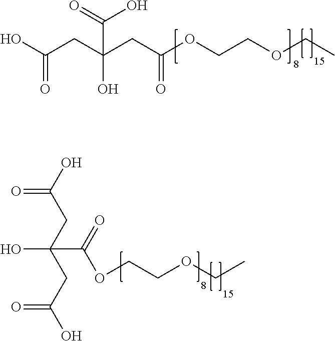

To a stirred solution of citric acid (5.7 g, 30.0 mmol) in acetic anhydride (5.5 g 54.0 mmol) was added acetic acid (1.8 g, 30.0 mmol). The reaction was stirred for 1 h at 90° C. then Brij 10 (20.5 g, 30.0 mmol) was added, and the acetic acid was removed under reduced pressure for 1 h at 90° C. The reaction was further stirred for 12 h at 90° C. To obtain a 50/50 mixture of terminal/pendent Brij10 mono citrate (26 g, quant) as a white wax.

¹H NMR (δ, 600 MHz, CDCl₃): 4.38-4.20; (m, 4H), 4.17; (s, 2H), 3.70-3.56; (m, 64H), 3.44; (t, J=6.8 Hz, 4H), 2.95; (d, J=15.7 Hz, 2H), 2.81; (d, J=15.7 Hz, 2H) 1.60-1.53; (m, 4H) 1.50-1.10; (m, 56H) 0.87; (t, J=7.0 Hz, 6H) ppm. ¹³C NMR (δ, CDCl₃, 150 MHz): 173.1, 171.9, 169.7, 77.3, 77.1, 76.9, 73.3, 72.5, 71.5, 70.6, 70.5, 70.4, 70.3, 70.2, 70.1, 70.0, 69.0, 68.6, 65.0, 61.6, 42.9, 31.9, 29.7, 29.6, 29.5, 29.3, 26.1, 22.7, 14.1 ppm.

Citrate-C₁₆-ester-mix

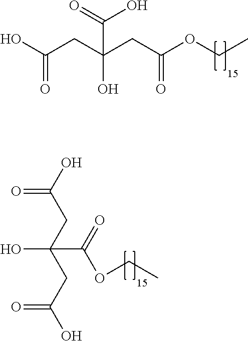

To a stirred solution of citric acid (5.7 g, 30.0 mmol) in acetic anhydride (5.5 g 54.0 mmol) was added acetic acid (1.8 g, 30.0 mmol). The reaction was stirred for 1 h at 90° C. then hexadecanol (7.3 g, 30.0 mmol) was added, and the acetic acid was removed under reduced pressure for 1 h at 90° C. The reaction was further stirred for 12 h at 90° C. To obtain a 50/50 mixture of terminal/pendent hexadecyl citrate (13 g, quant) as a white wax.

¹H NMR (δ, 600 MHz, DMSO-d6): 12.41; (br, 4H), 4.10-3.90; (m, 4H), 2.86-2.62; (m, 8H) 1.60-1.53; (m, 4H) 1.50-1.10; (m, 56H) 0.91-76; (m, 6H). ¹³C NMR (δ, CDCl3, 150 MHz): 174.7, 173.3, 171.6, 170.2, 73.3, 65.1, 64.3, 55.4 43.1, 31.8, 31.4, 29.5, 29.2, 28.5, 28.4, 25.8, 25.2, 22.6, 14.4 ppm.

The other compounds described herein are synthesized using similar methods as above or using known methods from the literature.

### Experimental Protocols

### 96-Well Static Biofilm Assay

Pseudomonas aeruginosa (strain ATCC₁₅₄₄₂) and Staphylococcus aureus (strain ATCC₆₅₃₈) were subcultured for 22 hours on LB and TSA plates respectively at 37° C. Bacteria was resuspended in LB supplemented with 2% sucrose (for P. aeruginosa) or TSB supplemented with 2% sucrose (for S. aureus) resulting in a suspension of 10⁸ CFU ml⁻¹. After vortexing, 200 μl of bacteria suspension were transferred into PVC microtiter plate (96 well plates). Plates were incubated for 48 h at 37° C. Bacterial culture was removed from wells leaving only attached biofilm and 200 ul of formulations applied to each well. Formulations were incubated for 10 min. Treated biofilm was resuspended and serially diluted before plating onto LB or TSB plates. Colonies were counted after 24 h incubation at 37° C.

Planktonic Bacteria with 5% Soil Load

Pseudomonas aeruginosa (strain ATCC₁₅₄₄₂) and Staphylococcus aureus (strain ATCC₆₅₃₈) were subcultured for 22 hours on LB and TSA plates respectively at 37° C. Bacteria was resuspended in TSB (for S. aureus) resulting in a suspension of 10⁸ CFU m⁻¹, 5% Fetal Bovine Serum (soil load) was added to the bacterial suspension and mixed by inverting. 100 ul of bacterial suspension was mixed with 100 ul formulation and incubated for 5 min at room temperature. Samples were serially diluted and plated onto TSB agar plates. Colonies were counted after 24 h incubation at 37° C.

### Biofilm Assay on CDC Coupons: 24-Well

Pseudomonas aeruginosa (strain ATCC₁₅₄₄₂) was subcultured for 22 hours on LB agar plates at 37° C. Bacteria was resuspended in LB supplemented with 2% sucrose resulting in a suspension of 10⁸ CFU mL⁻¹. 2 mL of bacterial suspension was added in a 10 mL test tube and the CDC coupon deposited on the bottom. Cultures were grown at 37° C. for 24 h with shaking and additional 24 h standing. Liquid was decanted from test tubes and 1 mL of formulation was applied to coupon for 10 min. 9 mL of neutralizing solution (2% Sodium Thiosulphate) was added and allowed to stand for 10 min. Biofilm was resuspended by vortex (30sec) and sonication (30sec) repeated twice. Culture was serially diluted and plated onto LB-Agar plates.

### CV Staining Assay on Evaluation of Biofilm Cleaning/Removal

Biofilms were grown in 96-well plates. 200 μL of formulation was applied to the biofilm, kept for 10 mins and carefully removed by pipetting. 200 μL of 1% solution of crystal violet was applied to the wells, kept for 5 mins and removed by pipetting. The following ratings represent the amount of stained biofilm: Biofilm removal ratings: 5=no removal, nearly or all biofilm still present; 3=some removal, significant reduction in amount of biofilm present; 1=nearly all biofilm is removed.

In all the following Examples and unless stated otherwise, the content of the compositions is expressed in wt %, based on a total weight of the composition. Water makes up for the remaining wt %.

### Example 1

Formulations were tested on Pseudomonas aeruginosa (strain ATCC₁₅₃₃₂) and Staphylococcus aureus (strain ATCC₆₅₃₈) using the “96-well static biofilm assay” and Pseudomonas aeruginosa using “Planktonic bacteria with 5% soil load assay” described above. The appearance and pH of the compositions are summarized at Table 1A below. The 96-well P.A. static biofilm assay, S.A. static biofilm assay and P.A. soil load assay are summarized at Table 1B below. For the 96-well assays, the biofilms were generated directly on well walls.

TABLE 1A
Treatment compositions

| Trt # | Composition (wt %) | Appearance | pH |
|---|---|---|---|
| 1 | Untreated Control | — | — |
| 2 | 2% Al-2575 + 0.5% Thymol + 0.5% EDTA-mono-C16-amide + 0.5% | Translucent | 8.8 |
| | NaHCO₃ + water | | |
| 3 | 2% Al-2575 + water | Clear | 6.9 |
| 4 | 0.5% Thymol + 0.67% Tween80 + 0.33% Span80 + water | Milky | 7.2 |
| 5 | 0.5% EDTA-mono-C16-amide + 0.5% NaHCO₃ + water | Clear | 8.8 |
| 6 | 2% Al-2575 + 0.5% Thymol + water | Phase | 7.0 |
| | | separation | |
| 7 | 2% Al-2575 + 0.5% EDTA-mono-C16-amide + 0.5% NaHCO₃ + | Clear | 8.7 |
| | water | | |
| 8 | 0.67% Tween80 + 0.33% Span80 + 0.5% Thymol + 0.5% EDTA- | Milky | 8.7 |
| | mono-C16-amide + 0.5% NaHCO₃ + water | | |
| 9 | 2% Al-2575 + 0.5% Thymol + 0.33% Na2EDTA + water | Phase | 5.0 |
| | | separation | |
| 10 | 2% Al-2575 + 0.5% Thymol + 1.8% Baypure DS 100 + water | Phase | 9.6 |
| | | separation | |
| 11 | 2% Al-2575 + 0.5% Thymol + 0.2% citric acid + water | Phase | 2.6 |
| | | separation | |

TABLE 1B
96-well biofilm and planktonic bacteria with soil load assays

| | | Log cfu/ml | | | | | |
|---|---|---|---|---|---|---|---|
| | | P.A. | % | S.A. | % | P.A. | % |
| Trt # | Composition (wt %) | biofilm | reduction | biofilm | reduction | soil load* | reduction |
| 1 | Untreated Control | 10 | 0 | 10 | 0% | 10 | 0% |
| 2 | 2% Al-2575 + 0.5% | 0 | 100% | 0 | 100% | 0 | 100% |
| | Thymol + 0.5% EDTA- | | | | | | |
| | mono-C16-amide + | | | | | | |
| | 0.5% NaHCO₃ + water | | | | | | |
| 3 | 2% Al-2575 + water | 10 | 0% | 7.8 | 22% | 6.9 | 31% |
| 4 | 0.5% Thymol + 0.67% | 7.2 | 28% | 7.6 | 24% | 6.1 | 39% |
| | Tween80 + 0.33% | | | | | | |
| | Span80 + water | | | | | | |
| 5 | 0.5% EDTA-mono- | 10 | 0% | 7.6 | 24% | 7.4 | 26% |
| | C16-amide + 0.5% | | | | | | |
| | NaHCO₃ + water | | | | | | |
| 6 | 2% Al-2575 + 0.5% | 3.2 | 68% | 0 | 100% | 5.4 | 46% |
| | Thymol + water | | | | | | |
| 7 | 2% Al-2575 + 0.5% | 5.5 | 45% | 5.6 | 44% | 0 | 100% |
| | EDTA-mono-C16- | | | | | | |
| | amide + 0.5% | | | | | | |
| | NaHCO₃ + water | | | | | | |
| 8 | 0.67% Tween80 + | 6 | 40% | 6.7 | 33% | 0 | 100% |
| | 0.33% Span80 + 0.5% | | | | | | |
| | Thymol + 0.5% EDTA- | | | | | | |
| | mono-C16-amide + | | | | | | |
| | 0.5% NaHCO₃ + water | | | | | | |
| 9 | 2% Al-2575 + 0.5% | 10 | 0% | 0 | 100% | 0 | 100% |
| | Thymol + 0.33% | | | | | | |
| | Na2EDTA + water | | | | | | |
| 10 | 2% Al-2575 + 0.5% | 5.2 | 48% | 0 | 100% | 4.6 | 54% |
| | Thymol + 1.8% | | | | | | |
| | Baypure DS 100 + | | | | | | |
| | water | | | | | | |
| 11 | 2% Al-2575 + 0.5% | 5.4 | 46% | 0 | 100% | 5.3 | 47% |
| | Thymol + 0.2% citric | | | | | | |
| | acid + water | | | | | | |

*The compositions were tested at 50% dilution for the P.A. soil load assays.

The biofilm cleaning effect is also tested using the “CV staining assay” described above. The results are summarized at Table 10 below.

TABLE 1C
Treatment compositions

| | | Biofilm cleaning |
|---|---|---|
| Trt # | Composition (wt %) | scale (S.A. biofilm) |
| 1 | Untreated Control | 5 |
| 2 | 2% Al-2575 + 0.5% Thymol + 0.5% EDTA-mono-C16-amide + 0.5% | 1 |
| | NaHCO₃ + water | |
| 3 | 2% Al-2575 + water | 5 |
| 4 | 0.5% Thymol + 0.67% Tween80 + 0.33% Span80 + water | 5 |
| 5 | 0.5% EDTA-mono-C16-amide + 0.5% NaHCO₃ + water | 1 |
| 6 | 2% Al-2575 + 0.5% Thymol + water | 5 |
| 7 | 2% Al-2575 + 0.5% EDTA-mono-C16-amide + 0.5% NaHCO₃ + | 1 |
| | water | |
| 8 | 0.67% Tween80 + 0.33% Span80 + 0.5% Thymol + 0.5% EDTA- | 3 |
| | mono-C16-amide + 0.5% NaHCO₃ + water | |
| 9 | 2% Al-2575 + 0.5% Thymol + 0.33% Na2EDTA + water | 4 |
| 10 | 2% Al-2575 + 0.5% Thymol + 1.8% Baypure DS 100 + water | 3 |
| 11 | 2% Al-2575 + 0.5% Thymol + 0.2% citric acid + water | 4 |

non-alkylated chelators (Na 2 EDTA, Baypure DS 100 and citric acid) had only a minor biofilm reduction/cleaning effect on S.A. biofilm (entries #9, #10 and #11), compared to when an alkylated chelator was used (EDTA-mono-C₁₆-amide, entries #2, #5 and #7).

Formulation #2 was a stable microemulsion. Formulations #9, #10 and #11 were not stable, with a phase separation observed.

Using formulations including an alkylated EDTA provided superior biofilm cleaning/removal properties compared to formulations including Na₂EDTA. In other words, the matrix of the biofilms were eradicated when formulations including an alkylated EDTA were used, which reduced the risk of bacterial colonies growing back and reforming a biofilm habitat.

### Example 2

Formulations were tested on Pseudomonas aeruginosa (strain ATCC₁₅₃₃₂) using the “24-well biofilm assay” described above. The appearance and pH of the compositions are summarized at Table 2A below. The 24-well biofilm assay is summarized at Table 2B. The 24-well assays allowed obtaining thicker biofilms compared to the 96-well assays.

TABLE 2A
Treatment compositions

| Trt # | Composition (wt %) | Appearance | pH |
|---|---|---|---|
| 1 | Untreated Control | — | — |
| 2 | 3% Al-2575 + 3.5% Thymol + 2.5% EDTA-mono-C16-amide + | Milky | 9.1 |
| | 2.5% NaHCO3 + 10% PG (propylene glycol) + water | | |
| 3 | 3% Al-2575 + 10% PG + water | Clear | 5.8 |
| 4 | 2.5% EDTA-mono-C16-amide + 2.5% NaHCO3 + 10% PG + water | Translucent | 9.3 |
| 5 | 3.5% Thymol + 10% PG + water | Oil separation | 3.9 |
| 6 | 10% PG + water | Clear | 4.1 |
| 7 | 3% Al-2575 + 3.5% Thymol + 2.5% EDTA-mono-C16-amide + | Milky with oil | 9.2 |
| | 2.5% NaHCO3 + water | droplets | |
| 8 | 3.5% Thymol + 2% SDS + water | Clear with top | 7.9 |
| | | oil droplets | |
| 9 | 3.5% Thymol + 2% SDS + 10% PG + water | Clear with top | 4.2 |
| | | creaming | |
| 10 | 3.5% Thymol + 1.34% Tween 80 + 0.66% Span 80 + water | Milky with | 7.1 |
| | | powdery | |
| | | sedimentation | |

TABLE 2B
24-well biofilm assays

| Trt | | Log cfu/ml | |
|---|---|---|---|
| # | Composition (wt %) | P.A. biofilm | % reduction |
| 1 | Untreated Control | 8.6 | 0% |
| 2 | 3% Al-2575 + 3.5% Thymol + 2.5% EDTA-mono-C16-amide + | 0 | 100% |
| | 2.5% NaHCO3 + 10% PG (propylene glycol) + water | | |
| 3 | 3% Al-2575 + 10% PG + water | 7.6 | 12% |
| 4 | 2.5% EDTA-mono-C16-amide + 2.5% NaHCO3 + | 7.2 | 16% |
| | 10% PG + water | | |
| 5 | 3.5% Thymol + 10% PG + water | 3.6 | 58% |
| 6 | 10% PG + water | 8.4 | 2% |
| 7 | 3% Al-2575 + 3.5% Thymol + | 0 | 100% |
| | 2.5% EDTA-mono-C16-amide + | | |
| | 2.5% NaHCO3 + water | | |
| 8 | 3.5% Thymol + 2% SDS + water | 3.8 | 56% |
| 9 | 3.5% Thymol + 2% SDS + 10% PG + water | 5.2 | 40% |
| 10 | 3.5% Thymol + 1.34% Tween 80 + 0.66% Span 80 + water | 3.6 | 58% |

### Example 3

Formulations were tested on Pseudomonas aeruginosa (strain ATCC₁₅₃₃₂) using the “24-well biofilm assay” described above. The appearance and pH of the compositions are summarized at Table 3A below. The 24-well biofilm assay is summarized at Table 3B. The 24-well assays allowed obtaining thicker biofilms compared to the 96-well assays.

TABLE 3A
Treatment compositions

| Trt # | Composition (wt %) | Appearance | pH |
|---|---|---|---|
| 1 | Untreated Control | — | — |
| 2 | 3% Al2575 + 3.5% Thymol + 2.5% EDTA-mono-C16-amide + | Milky | 8.8 |
| | 2.5% NaHCO3 + water | | |
| 3 | 3% Al2575 + water | Clear | 6.8 |
| 4 | 2.5% EDTA-mono-C16-amide + 2.5% NaHCO3 + water | Clear | 8.8 |
| 5 | 3.5% Thymol + water | Oil phase | 7.9 |
| 6 | 0.0013% of (4.6% Focus Disperse P-1000-70N + 0.9% APG | — | — |
| | 325N + 0.629% Crodateric CAB + 0.49% Eugenol + 0.01% | | |
| | Tetrasodium EDTA + 85.271% Water) | | |

TABLE 3B
24-well biofilm assays

| | | Log cfu/ml | | Biofilm |
|---|---|---|---|---|
| Trt | | P.A. | % | cleaning |
| # | Composition (wt %) | biofilm | reduction | effect |
| 1 | Untreated Control | 9.3 | 0% | 5 |
| 2 | 3% Al2575 + 3.5% Thymol + 2.5% EDTA-mono-C16- | 0 | 100% | 1 |
| | amide + 2.5% NaHCO3 + water | | | |
| 3 | 3% Al2575 + water | 8.3 | 11% | 3.5 |
| 4 | 2.5% EDTA-mono-C16-amide + 2.5% NaHCO3 + | 8.8 | 5% | 1.5 |
| | water | | | |
| 5 | 3.5% Thymol + water | 5.4 | 42% | 3 |
| 6 | 0.0013% of (4.6% Focus Disperse P-1000-70N + | 9.3 | 0% | 4 |
| | 0.9% APG 325N + 0.629% Crodateric CAB + 0.49% | | | |
| | Eugenol + 0.01% Tetrasodium EDTA + 85.271% | | | |
| | Water) | | | |

Biofilm removal ratings: 5=no removal, nearly or all biofilm still present; 3=some removal, significant reduction in amount of biofilm present; 1=nearly all biofilm is removed.

### Example 4

Formulations were tested on Pseudomonas aeruginosa (strain ATCC₁₅₃₃₂) using the “planktonic bacteria with 5% soil load” assay described above. This assay is not a biofilm removal test, as no biofilm is generated. The appearance and pH of the compositions are summarized at Table 4A below. The results are summarized at Table 4B.

TABLE 4A
Treatment compositions

| Trt # | Composition (wt %) | Appearance | pH |
|---|---|---|---|
| 1 | Untreated Control | — | — |
| 2 | 3% Al2575 + 3.5% Thymol + | Milky | 8.8 |
| | 2.5% EDTA-mono-C16-amide + | | |
| | 2.5% NaHCO3 + water | | |
| 3 | 3% Al2575 + water | Clear | 6.8 |
| 4 | 2.5% EDTA-mono-C16-amide + | Clear | 8.8 |
| | 2.5% NaHCO3 + water | | |
| 5 | 3.5% Thymol + water | Oil phase | 7.9 |
| | | separation | |
| 6 | 3% Al2575 + 3.5% Thymol + water | Milky with oil | 6.9 |
| | | sedimentation | |
| 7 | 3% Al2575 + | Clear | 8.8 |
| | 2.5% EDTA-mono-C16-amide + | | |
| | 2.5% NaHCO3 + water | | |
| 8 | 3.5% Thymol + | Milky with oil | 8.8 |
| | 2.5% EDTA-mono-C16-amide + | | |
| | 2.5% NaHCO3 + water | droplets | |

TABLE 4B
planktonic bacteria with 5% soil load assay

| | | Log cfu/ml | |
|---|---|---|---|
| Trt # | Composition (wt %) | P.A. Soil load | % reduction |
| 1 | Untreated Control | 8.9 | 0% |
| 2 | 3% Al2575 + 3.5% Thymol + | 3.8 | 57% |
| | 2.5% EDTA-mono-C16-amide + | | |
| | 2.5% NaHCO3 + water | | |
| 3 | 3% Al2575 + water | 8.1 | 9% |
| 4 | 2.5% EDTA-mono-C16-amide + | 8.8 | 1% |
| | 2.5% NaHCO3 + water | | |
| 5 | 3.5% Thymol + water | 7.1 | 20% |
| 6 | 3% Al2575 + 3.5% Thymol + | 5.9 | 34% |
| 7 | water 3% Al2575 + | 8.7 | 2% |
| | 2.5% EDTA-mono-C16-amide + | | |
| | 2.5% NaHCO3 + water | | |
| 8 | 3.5% Thymol + | 6.4 | 28% |
| | 2.5% EDTA-mono-C16-amide + | | |
| | 2.5% NaHCO3 + water | | |

### Example 5

Formulations were tested on Pseudomonas aeruginosa (strain ATCC₁₅₃₃₂) using the United States Environmental Protection Agency MB-19-05 antimicrobial testing method (revised 2020-01-21), which is hereby incorporated by reference in its entirety. The appearance and pH of the compositions are summarized at Table 5A below. The results are summarized at Table 5B.

TABLE 5A
Treatment compositions

| Trt # | Composition (wt %) | Appearance | pH |
|---|---|---|---|
| 1 | Untreated Control | — | — |
| 2 | 3% Al2575 + 3.5% Thymol + | Milky | 8.8 |
| | 2.5% EDTA-mono-C16-amide + | | |
| | 2.5% NaHCO3 + water | | |
| 3 | 3% Al2575 + water | Clear | 6.8 |
| 4 | 2.5% EDTA-mono-C16-amide + | Clear | 8.8 |
| | 2.5% NaHCO3 + water | | |
| 5 | 3.5% Thymol + water | Oil phase | 7.9 |
| | | separation | |

TABLE 5B
Biofilm in CDC bioreactor assay

| | | Log cfu/ml | |
|---|---|---|---|
| Trt # | Composition (wt %) | P.A. Biofilm | % reduction |
| 1 | Untreated Control | 8.8 | 0% |
| 2 | 3% Al2575 + 3.5% Thymol + | 0 | 100% |
| | 2.5% EDTA-mono-C16- | | |
| | amide + 2.5% NaHCO3 + water | | |
| 3 | 3% Al2575 + water | 6.7 | 24% |
| 4 | 2.5% EDTA-mono-C16-amide + | 8.6 | 2% |
| | 2.5% NaHCO3 + | | |
| | water | | |
| 5 | 3.5% Thymol + water | 6.4 | 27% |

### Example 6

Formulations were tested on Pseudomonas aeruginosa (strain ATCC₁₅₄₄₂) and Staphylococcus aureus (strain ATCC₆₅₃₈) using the “24-well biofilm assay” described above. The 24-well biofilm assays results are summarized at Table 6.

TABLE 6
24-well biofilm assays

| | | Log cfu/ml | |
|---|---|---|---|
| Trt | | P.A. | S.A. |
| # | Composition (wt %) | Biofilm | Biofilm |
| 1 | Untreated Control | 8.6 | 7.2 |
| 2 | 3.5% Thymol + 3% Al2575 + 2.5% EDTA | 0 | 0 |
| | derivative + 1% Na2CO3 + 25% IPA + water | | |
| | (EDTA derivative is EDTA-mono-C16-amide) | | |
| 3 | Same, EDTA derivative is EDTA-mono-C16- | <3 | <3 |
| | ester | | |
| 4 | Same, EDTA derivative is EDTA-di-C16-amide | <3 | 0 |
| 5 | Same, EDTA derivative is EDTA-di-C8-amide | 0 | 0 |
| 6 | Same, EDTA derivative is EDTA-di-C8-ester | 0 | 0 |
| 7 | Same, EDTA derivative is EDTA-di-C16-ester | 0 | 0 |
| 8 | Same, EDTA derivative is HEDTA-C16-ester | 3 | 3 |
| 9 | Same, EDTA derivative is EDTA-mono-C18- | 3 | 0 |
| | amide | | |
| 10 | Same, EDTA derivative is EDTA-mono-C8- | <3 | 0 |
| | amide | | |
| 11 | Same, EDTA derivative is EDTA-mono-C15- | <3 | 4 |
| | amide | | |
| 12 | Same, EDTA derivative is EDTA-mono- | 4.2 | 0 |
| | cholesterol-ester | | |

* The compositions were tested at 25% dilution for the P.A. and S.A. biofilm assays.

### Example 7

Formulations were tested on Pseudomonas aeruginosa (strain ATCC₁₅₄₄₂) and Staphylococcus aureus (strain ATCC₆₅₃₈) using the United States Environmental Protection Agency MB-19-05 antimicrobial testing method (revised 2020-01-21). The results are summarized at Table 7. Biofilm cleaning and removal effect was evaluated using the “CV staining assay”.

TABLE 7
Biofilm in CDC bioreactor assays

| | | P.A. biofilm | | S.A. biofilm | |
|---|---|---|---|---|---|
| | | | Cleaning | | Cleaning |
| Trt | | Log | Scale | Log | Scale |
| # | Composition (wt %) | cfu/ml | 1-5 | cfu/ml | 1-5 |
| 1 | Untreated Control | 8.2 | 5 | 9.5 | 5 |
| 2 | 4.8% Thymol + 4.8% | 0 | 1 | 0 | 1 |
| | Al2575 + 1.6% EDTA- | | | | |
| | mono-C16-amide + 0.96% | | | | |
| | Na2CO3 + 25% IPA + | | | | |
| | 5% SDS + water | | | | |
| 3 | 4.8% Thymol + 4.8% | 0 | 1 | 0 | 1 |
| | Al2575 + 1.6% EDTA- | | | | |
| | mono-C16-amide + 0.96% | | | | |
| | Na2CO3 + (7.5% IPA + | | | | |
| | 7.5% PG) + 5% SDS + | | | | |
| | water | | | | |
| 4 | 4.5% Thymol + 2.25% | 0 | 1 | 0 | 1 |
| | Al2575 + 0.75% EDTA- | | | | |
| | mono-C16-amide + 0.45% | | | | |
| | Na2CO3 + 25% IPA + | | | | |
| | 5% SDS + water | | | | |

Biofilm removal ratings: 5=no removal, nearly or all biofilm still present; 3=some removal, significant reduction in amount of biofilm present; 1=nearly all biofilm is removed.

### Example 8

Formulations were tested on Pseudomonas aeruginosa (strain ATCC₁₅₄₄₂) using the “24-well biofilm assay” described above. The 24-well biofilm assay is summarized at Table 8. Sterilex™ Ultra disinfectant was used at the label rate as a standard.

TABLE 8
24-well biofilm assay

| | | P.A. biofilm |
|---|---|---|
| Trt # | Composition (wt %) | (LogCFU/ml) |
| 1 | Untreated Control | 8.6 |
| 2 | Sterilex ™ Ultra disinfectant | 4 |
| 3 | 4.5% Thymol + 2.25% Al 2575 + 1.5% EDTA- | 0 |
| | mono-C16-ester + 0.7% Tris + 15% IPA + 4% | |
| | SDS + water | |
| 4 | 4.5% Thymol + 2.25% AL 2559 + 1.5% EDTA- | 0 |
| | mono-C16-ester + 0.7% Tris + 15% IPA + 4% | |
| | SDS + water | |
| 5 | 4.5% Thymol + 2.25% APG325 + 1.5% EDTA- | 0 |
| | mono-C16-ester + 0.7% Tris + 15% IPA + 4% | |
| | SDS + water | |
| 6 | 4.5% Thymol + 2.25% Triton CG-110 + 1.5% | 0 |
| | EDTA-mono-C16-ester + 0.7% Tris + 15% IPA + | |
| | 4% SDS + water | |
| 7 | 4.5% Thymol + 2.25% Glucopon 215UP + 1.5% | 3 |
| | EDTA-mono-C16-ester + 0.7% Tris + 15% IPA + | |
| | 4% SDS + water | |
| 8 | 4.5% Thymol + 2.25% Glucopon 425N + 1.5% | 0 |
| | EDTA-mono-C16-ester + 0.7% Tris + 15% IPA + | |
| | 4% SDS + water | |
| 9 | 4.5% Thymol + 2.25% Glucopon 600UP + 1.5% | 0 |
| | EDTA-mono-C16-ester + 0.7% Tris + 15% IPA + | |
| | 4% SDS + water | |
| 10 | 4.5% Thymol + 2.25% Glucopon 50G + 1.5% | 0 |
| | EDTA-mono-C16-ester + 0.7% Tris + 15% IPA + | |
| | 4% SDS + water | |
| 11 | 4.5% Thymol + 2.25% Agnique PG 8107-U + | 0 |
| | 1.5% EDTA-mono-C16-ester + 0.7% Tris + 15% | |
| | IPA + 4% SDS + water | |
| 12 | 4.5% Thymol + 2.25% Plantaren 1200 N UP + | 0 |
| | 1.5% EDTA-mono-C16-ester + 0.7% Tris + 15% | |
| | IPA + 4% SDS + water | |
| 13 | 4.5% Thymol + 2.25% Multitrope 1620-LQ-MV + | 0 |
| | 1.5% EDTA-mono-C16-ester + 0.7% Tris + 15% | |
| | IPA + 4% SDS + water | |
| 14 | 4.5% Thymol + 2.25% Berol DGR 81 + 1.5% | 0 |
| | EDTA-mono-C16-ester + 0.7% Tris + 15% IPA + | |
| | 4% SDS + water | |
| 15 | 4.5% Thymol + 2.25% Berol LFG 61 + 1.5% | 0 |
| | EDTA-mono-C16-ester + 0.7% Tris + 15% IPA + | |
| | 4% SDS + water | |
| 16 | 4.5% Thymol + 2.25% Sophorolipids + 1.5% | 0 |
| | EDTA-mono-C16-ester + 0.7% Tris + 15% IPA + | |
| | 4% SDS + water | |
| 17 | 4.5% Thymol + 2.25% Rhaminolipids + 1.5% | 0 |
| | EDTA-mono-C16-ester + 0.7% Tris + 15% IPA + | |
| | 4% SDS + water | |
| 18 | 4.5% Thymol + 4.5% Sophorolipids + 1.5% | 0 |
| | EDTA-mono-C16-ester + 0.7% Tris + 15% | |
| | IPA + 4% SDS + water | |

*The compositions were tested at 25% dilution for the P.A. biofilm assays.

### Example 9

Formulations were tested on Pseudomonas aeruginosa (strain ATCC₁₅₄₄₂) and Staphylococcus aureus (strain ATCC₆₅₃₈) using the United States Environmental Protection Agency MB-19-05 antimicrobial testing method (revised 2020-01-21). The results are summarized at Table 9. Sterilex™ Ultra disinfectant was used at the label rate as a standard.

TABLE 9
Biofilm in CDC bioreactor assay

| | | P.A. | S.A. | |
|---|---|---|---|---|
| | | biofilm | biofilm | |
| Trt | | (log | (log | Appearance |
| # | Composition (wt %) | CFU/mL) | CFU/ml) | and pH |
| 1 | Untreated Control | 8.4 | 9.5 | |
| 2 | Sterilex ™ Ultra | 0 | 3.6 | |
| 3 | 4.5% Thymol + 2.25% Al2575 + | 0 | 3 | pH 8.3, |
| | 1.5% EDTA-mono-C16-ester + | | | clear |
| | 1.2% Tris + 15% IPA + 4% | | | |
| | SDS + water | | | |
| 4 | 4.5% Thymol + 2.25% Al2559 + | 0 | 3.4 | pH 8.2, |
| | 1.5% EDTA-mono-C16-ester + | | | clear |
| | 1.2% Tris + 15% IPA + 4% | | | |
| | SDS + water | | | |
| 5 | 4.5% Thymol + 2.25% Glucopon | 4.8 | 7.2 | pH 8.2, |
| | 425 + 1.5% EDTA-mono-C16- | | | clear |
| | ester + 1.2% Tris + 15% IPA + | | | |
| | 4% SDS + water | | | |
| 6 | 4.5% Thymol + 2.25% Agnique | 4.6 | 6.8 | pH 8.2, |
| | PG 8107-U + 1.5% EDTA- | | | clear |
| | mono-C16-ester + 1.2% Tris + | | | |
| | 15% IPA + 4% SDS + water | | | |

### Example 10

Formulations were tested on Pseudomonas aeruginosa (strain ATCC₁₅₄₄₂) using the United States Environmental Protection Agency MB-19-05 antimicrobial testing method (revised 2020-01-21). The results are summarized at Table 10. Sterilex™ Ultra disinfectant was used at the label rate as a standard.

TABLE 10
Biofilm in CDC bioreactor assay

| Trt | | P.A. biofilm | Appearance |
|---|---|---|---|
| # | Compositions (wt %) | (log CFU/mL) | and pH |
| 1 | Untreated Control | 9.8 | |
| 2 | 4.5% Thymol + 2.25% Al2575 + | 3.8 | pH 8.1, |
| | 1.5% EDTA-mono-C16-ester + | | clear |
| | 1.2% Tris + 15% IPA + 4% | | |
| | SDS + water | | |
| 3 | 4.5% Thymol + 2.25% | 5.4 | pH 8.2, |
| | APG325 + 1.5% EDTA-mono- | | clear |
| | C16-ester + 1.2% Tris + 15% | | |
| | IPA + 4% SDS + water | | |
| 4 | 4.5% Thymol + 2.25% | 4.8 | pH 7.9, |
| | Sophorolipids* + 1.5% EDTA- | | clear |
| | mono-C16-ester + 1.2% Tris + | | |
| | 15% IPA + 4% SDS + water | | |
| 5 | 4.5% Thymol + 2.25% | 4.4 | pH 8.0, |
| | Rhamnolipids** + 1.5% EDTA- | | milky |
| | mono-C16-ester + 1.2% Tris + | | |
| | 15% IPA + 4% SDS + water | | |
| 6 | 4.5% Thymol + 2.25% Al2575 + | 4 | pH 8.1, |
| | 1.5% EDTA-mono-C16-ester + | | clear |
| | 1.2% Tris + 35% IPA + 4% | | |
| | SDS + water | | |
| 7 | 4.5% Citronella + 2.25% | | Initial pH |
| | Al2575 + 1.5% EDTA-mono- | | 5.6, |
| | C16-ester + 1.2% Tris + 35% | | precipitated. |
| | IPA + 4% SDS + water | | pH adjusted |
| | | | to 8 before |
| | | | use |

*The Rhamnolipids were obtained from Agaetech ™ Technologies (Rhamnolipid R90);
**The Sophorolipids were obtained from http://www.sophorolipid.com (grade SL50).

### Example 11

“Ready-to-use” and “concentrated” formulations were tested on Pseudomonas aeruginosa (strain ATCC₁₅₄₄₂) and Staphylococcus aureus (strain ATCC₆₅₃₈) using the United States Environmental Protection Agency MB-19-05 antimicrobial testing method (revised 2020-01-21). The concentrated formulations were diluted to 25%. The results are summarized at Table 11. Sterilex™ Ultra disinfectant was used at the label rate as a standard.

TABLE 11
Biofilm in CDC bioreactor assay

| | | P.A. | S.A. | Appear- |
|---|---|---|---|---|
| Trt | | biofilm | biofilm | ance |
| # | Compositions (wt %) | (log CFU/mL) | (log CFU/ml) | and pH |
| 1 | Untreated Control | 8.4 | 9.5 | |
| 2 | Sterilex Ultra | 0 | 3.6 | |
| 3 | 4.5% Thymol + 2.25% | 0 | 3 | pH 8.3, |
| | Al2575 + 1.5% EDTA- | | | clear |
| | mono-C16-ester + 1.2% | | | |
| | Tris + 15% IPA + 4% | | | |
| | SDS + water | | | |
| 4 | Conc sample: 25% (18% | 2 | 3.4 | pH 8.2, |
| | Thymol + 9.0% Al2575 + | | | clear |
| | 6.0% EDTA-mono-C16- | | | |
| | ester + 4.8% Tris + 32% | | | |
| | IPA + 16.0% SDS) (IPA | | | |
| | added to 15% in the | | | |
| | Ready-to-use dilution) | | | |
| 5 | Conc sample: 25% (18% | 2 | 3.6 | pH 8.2, |
| | Thymol + 9.0% Al2575 + | | | clear |
| | 6.0% EDTA-mono-C16- | | | |
| | ester + 4.8% Tris + 32% | | | |
| | IPA + 16.0% SDS) | | | |

### Example 12

Formulations were tested on Pseudomonas aeruginosa (strain ATCC₁₅₄₄₂) using the United States Environmental Protection Agency MB-19-05 antimicrobial testing method (revised 2020-01-21). The results are summarized at Table 12. Sterilex™ Ultra disinfectant was used at the label rate as a standard.

TABLE 12
Biofilm in CDC bioreactor assay

| Trt | | P.A. biofilm | Appearance |
|---|---|---|---|
| # | Compositions (wt %) | (log CFU/ml) | and pH |
| 1 | Untreated Control | 8.8 | |
| 2 | Sterilex Ultra | 2 | |
| 3 | 4.5% Thymol + 2.25% Al2575 + | 2 | pH 8.3, |
| | 1.5% EDTA-mono-C16-ester + | | clear |
| | 1.2% Tris + 15% IPA + 4% | | |
| | SDS + water | | |
| 4 | 4.5% Thymol + 2.25% Al2575 + | 2 | pH 8.1, |
| | 1.6% EDTA-mono-C18-amide + | | clear |
| | 1.2% Tris + 15% IPA + 4% | | |
| | SDS + water | | |
| 5 | 4.5% Thymol + 2.25% Al2575 + | 3.4 | pH 8.3, |
| | 1.2% EDTA-mono-C8-amide + | | clear |
| | 1.2% Tris + 15% IPA + 4% | | |
| | SDS + water | | |
| 6 | 4.5% Thymol + 2.25% Al2575 + | 3 | pH 11.1, |
| | 1% N-C16-DL-aspartic acid + | | clear |
| | 0.23% NaOH + 15% IPA + 4% | | |
| | SDS + water | | |
| 7 | 4.5% Thymol + 2.25% Al2575 + | 3.2 | pH 11.0, |
| | 0.9% N-C12-DL-aspartic acid + | | clear |
| | 0.23% NaOH + 15% IPA + 4% | | |
| | SDS + water | | |

### Example 13

Formulations were tested on Pseudomonas aeruginosa (strain ATCC₁₅₄₄₂) and Staphylococcus aureus (strain ATCC₆₅₃₈) using the United States Environmental Protection Agency MB-19-05 antimicrobial testing method (revised 2020-01-21). The results are summarized at Table 13. Sterilex™ Ultra disinfectant was used at the label rate as a standard.

TABLE 13
Biofilm in CDC bioreactor assay

| Trt | | P.A. biofilm | S.A. biofilm | Appearance |
|---|---|---|---|---|
| # | Compositions (wt %) | (log CFU/ml) | (log CFU/ml) | and pH |
| 1 | Untreated Control | 8.6 | 8.2 | |
| 2 | Sterilex Ultra | 4.4 | 3 | |
| 3 | 4.5% Thymol + 2.25% | 2 | 2 | pH 8.2, |
| | Al2575 + 1.5% EDTA- | | | clear |
| | mono-C16-ester + 1.2% | | | |
| | Tris + 15% IPA + 4% | | | |
| | SDS + water | | | |
| 4 | 4.5% Thymol + 2.25% | 2 | 3.8 | pH 8.1, |
| | Al2575 + 1.6% EDTA- | | | clear |
| | mono-C18-amide + | | | |
| | 1.2% Tris + 15% IPA + | | | |
| | 4% SDS + water | | | |
| 7 | 4.5% Thymol + 2.25% | 3.6 | 2 | pH 8.8, |
| | Al2575 + 1.5% Citrate- | | | clear |
| | EO8-C16-ester-mix + | | | |
| | 1.2% Tris + 25% IPA + | | | |
| | 4% SDS + water | | | |
| 8 | 4.5% Thymol + 2.25% | 3 | 3 | pH 8.1, |
| | Al2575 + 1.5% Citrate- | | | precipitate |
| | C16-ester-mix + 1.2% | | | |
| | Tris + 15% IPA + 4% | | | |
| | SDS + water | | | |

### Example 14

Formulations were tested on Pseudomonas aeruginosa (strain ATCC₁₅₄₄₂) using the “24-well biofilm assay” described above. The results are summarized in Table 14.

TABLE 14
24-well biofilm assay

| Trt | | P.A. biofilm | Appearance |
|---|---|---|---|
| # | Compositions (wt %) | (log CFU/ml) | and pH |
| 1 | Untreated Control | 8.2 | |
| 2 | Sterilex (standard label rate for | 0 | |
| | biofilm) | | |
| 3 | 12.5% Sterilex (12.5% dilution of | 2.1 | |
| | standard rate) | | |
| 4 | (4.5% Thymol + 15% IPA) + | 0 | pH 8.2, |
| | (2.25% Al2575 + 1.5% EDTA- | | clear |
| | mono-C16-ester + 1.2% Tris + | | |
| | 4% SDS) | | |
| 5 | (4.5% Thymol + 2.25% Al2575 + | 0 | pH 9.0, |
| | 1.5% EDTA-mix-EO23-C12 ester + | | turbid, |
| | 1.2% Tris + 15% IPA + 4% SDS) | | phase |
| | | | separation |
| 6 | (4.5% Thymol + 2.25% Al2575 + | 0 | pH 8.8, |
| | 1.5% Citrate-EO8-C16-ester-mix + | | turbid, |
| | 1.2% Tris + 15% IPA + 4% SDS) | | phase |
| | | | separation |
| 7 | (4.5% Thymol + 2.25% Al2575 + | 0 | pH 8.1, |
| | 1.5% Citrate-C16-ester-mix + 1.2% | | turbid, |
| | Tris + 15% IPA + 4% SDS) | | precipitate |
| 8 | (4.5% Thymol + 2.25% Al2575 + | 0 | pH 9.0, |
| | 1.5% Maleic-polyether-diamine + | | clear |
| | 1.2% Tris + 15% IPA + 4% SDS) | | |
| 9 | 12.5% (4.5% Thymol + 15% IPA) + | 0 | pH 8.3, |
| | (2.25% Al2575 + 1.5% EDTA- | | clear |
| | mono-C16-ester + 1.2% Tris + 4% | | |
| | SDS) | | |
| 10 | 12.5% (4.5% Thymol + 2.25% | 0 | pH 9.1, |
| | Al2575 + 1.5% EDTA-mix-EO23- | | turbid, |
| | C12 ester + 1.2% Tris + 15% | | precipitate |
| | IPA + 4% SDS) | | |
| 11 | 12.5% (4.5% Thymol + 2.25% | 0 | pH 8.8, |
| | Al2575 + 1.5% Citrate-EO8-C16- | | milky |
| | ester-mix + 1.2% Tris + 15% IPA + | | |
| | 4% SDS) | | |
| 12 | 12.5% (4.5% Thymol + 2.25% | 0 | pH 8.2, |
| | Al2575 + 1.5% Citrate-C16-ester- | | translucent + |
| | mix + 1.2% Tris + 15% IPA + 4% | | precipitate |
| | SDS) | | |
| 13 | 12.5% (4.5% Thymol + 2.25% | 0 | pH 9.1, |
| | Al2575 + 1.5% Maleic-polyether- | | milky |
| | diamine + 1.2% Tris + 15% IPA + | | |
| | 4% SDS) | | |

### Example 15

Formulations were tested on Pseudomonas aeruginosa (strain ATCC₁₅₄₄₂) and Staphylococcus aureus (strain ATCC₆₅₃₈) using the United States Environmental Protection Agency MB-19-05 antimicrobial testing method (revised 2020-01-21). The results are summarized at Table 15. Sterilex™ Ultra disinfectant was used at the label rate as a standard.

TABLE 15
Biofilm in CDC bioreactor assay

| | | P.A. biofilm | S.A. biofilm |
|---|---|---|---|
| Trt # | Compositions (wt %) | (log CFU/ml) | (log CFU/ml) |
| 1 | Untreated Control | 8.2 | 8.6 |
| 2 | Sterilex Ultra | 0 | 3.6 |
| 3 | 4.5% Thymol + 2.25% Al2575 + | 0 | 0 |
| | 1.5% EDTA-mono-C16-ester + | | |
| | 1.2% Tris + 15% IPA + 4% | | |
| | SDS + water | | |
| 4 | 4.5% Cinnamaldehyde + 2.25% | 0 | 6.2 |
| | Al2575 + 1.5% EDTA-mono- | | |
| | C16-ester + 1.2% Tris + 15% | | |
| | IPA + 4% SDS + water | | |
| 5 | 4.5% geraniol + 2.25% Al2575 + | 0 | 0 |
| | 1.5% EDTA-mono-C16-ester + | | |
| | 1.2% Tris + 15% IPA + 4% | | |
| | SDS + water | | |
| 6 | 4.5% Citronella + 2.25% | 0 | 4 |
| | Al2575 + 1.6% EDTA-mono- | | |
| | C18-amide + 1.2% Tris + 35% | | |
| | IPA + 4% SDS-adjust to pH 8 | | |
| | with NaOH | | |
| 7 | 5% Citronella + 2.25% Al2575 + | 0 | 2 |
| | 1.6% EDTA-mono-C18-amide + | | |
| | 1.2% Tris + 35% IPA + 4% SDS- | | |
| | adjust to pH 8 with NaOH | | |

### Example 16

Formulations were tested on Pseudomonas aeruginosa (strain ATCC₁₅₃₃₂) using the “96-well static biofilm assay”. The results are summarized at Table 16.

TABLE 16
Biofilm in 96-well assay

| Trt | | P.A. biofilm |
|---|---|---|
| # | Compositions (wt %) | (log CFU/ml) |
| 1 | Untreated Control | 8.2 |
| 2 | 4.5% Thymol + 15% IPA + 2.25% Al2575 + 1.5% | 0 |
| | EDTA-mono-C16-ester + 1.2% Tris + 4% SDS + | |
| | water | |
| 3 | 4.5% Thymol + 2.25% Al2575 + 1.5% EDTA-mix- | 0 |
| | EO23-C12 ester + 1.2% Tris + 15% IPA + 4% SDS + | |
| | water | |
| 4 | 4.5% Thymol + 2.25% Al2575 + 1.5% EDTA-di- | 0 |
| | EO23-C12 ester + 1.2% Tris + 15% IPA + 4% SDS + | |
| | water | |
| 5 | 4.5% Thymol + 2.25% Al2575 + 1.5% Maleic- | 0 |
| | polyether-diamine + 1.2% Tris + 15% IPA + 4% | |
| | SDS + water | |

### Example 17

Formulations were tested on Staphylococcus aureus (strain ATCC₆₅₃₈) using the “96-well static biofilm assay”. The results are summarized at Table 17.

TABLE 17
Biofilm in 96-well assay

| | | | S.A. | | |
|---|---|---|---|---|---|
| | | Mean | biofilm | | |
| Trt | | Particle | (log | % | Solution |
| # | Compositions (wt %) | size | CFU/ml) | reduction | Description |
| 1 | Untreated Control | N/A | 10 | | |
| 2 | 0.5% Thymol + 1% | 12 nm | 0 | 100% | Clear, |
| | Al-2575 + 3.5% BIO- | | | | pH 8.7 |
| | SOFT ™ N1-9 + | | | | |
| | 0.5% EDTA-mono- | | | | |
| | C16 ester + 0.5% | | | | |
| | NaHCO3 + water | | | | |
| 3 | 0.5% Thymol + 1% | 50 nm | 6.8 | 32% | Clear, |
| | Al-2575 + 3.5% BIO- | | | | pH 5.0 |
| | SOFT ™ N1-9 + | | | | |
| | 0.5% Na2EDTA + | | | | |
| | water | | | | |

### Example 18

Formulations were tested as follows with different essential oils: commercial glass slides with 10⁶ pathogens and 5% FBS (Stratix™ labs) were provided. Commercial non-woven wipes (2×2 cm) were dipped into the formulations and the glass slides were wiped. The slides were incubated for 10 mins in 20 mL neutralizer and sonicated for 1 min to release bacteria. Serial dilutions were plated on TSB agar plates and colonies were counted 24 h later. The results are summarized in Table 18 below:

TABLE 18
Wipe testing assay

| | | P.A. | S.A. | |
|---|---|---|---|---|
| Trt | | (log | (log | Appearance |
| # | Compositions (wt %) | CFU/ml) | CFU/ml) | and pH |
| 1 | Untreated Control | 4.6 | 8.7 | |
| 2 | 22% of ((4.5% Thymol + 15% | 0 | 0 | Clear, |
| | AIPA) + (2.25% l2575 + 1.5% | | | pH 8.4 |
| | EDTA-mono-C16 ester + 1.2% | | | |
| | Tris + 4% SDS)) | | | |
| 3 | 11% of ((4.5% Thymol + 15% | 0 | 4 | Clear, |
| | IPA) + (2.25% Al2575 + 1.5% | | | pH 8.4 |
| | EDTA-mono-C16 ester + 1.2% | | | |
| | Tris + 4% SDS)) | | | |
| 4 | 11% of ((4.5% citronella + 15% | 0 | 4.2 | Clear, |
| | IPA) + (2.25% Al2575 + 1.5% | | | pH 9.1 |
| | EDTA-mono-C16 ester + 1.2% | | | |
| | Tris + 4% SDS)-add NaOH | | | |
| | adjust pH) | | | |
| 5 | 11% ((4.5% geraniol + 15% | 0 | 4 | Clear, |
| | IPA) + (2.25% Al2575 + 1.5% | | | pH 8.5 |
| | EDTA-mono-C16 ester + 1.2% | | | |
| | Tris + 4% SDS)) | | | |
| 6 | 11% ((2.25% | 0 | 4.2 | Milky, |
| | Thymol + 2.25% geraniol + 15% | | | pH 8.4 |
| | IPA) + (2.25% Al2575 + 1.5% | | | |
| | EDTA-mono-C16 ester + 1.2% | | | |
| | Tris + 4% SDS) | | | |
| 7 | 11% ((4.5% carvacrol + 15% | 0 | 4.6 | Clear, |
| | IPA) + (2.25% Al2575 + 1.5% | | | pH 8.5 |
| | EDTA-mono-C16 ester + 1.2% | | | |
| | Tris + 4% SDS) | | | |
| 8 | 11% ((4.5% orange oil + 15% | 2.6 | 6.5 | Milky, |
| | IPA) + (2.25% Al2575 + 1.5% | | | pH 8.5 |
| | EDTA-mono-C16 ester + 1.2% | | | |
| | Tris + 4% SDS) | | | |
| 9 | 11% ((4.5% lavender oil + 15% | 0 | 4.8 | Milky, |
| | IPA) + (2.25% Al2575 + 1.5% | | | pH 8.6 |
| | EDTA-mono-C16 ester + 1.2% | | | |
| | Tris + 4% SDS)) | | | |

### Example 19

Formulations were tested on Pseudomonas aeruginosa (strain ATCC₁₅₄₄₂) using the United States Environmental Protection Agency MB-19-05 antimicrobial testing method (revised 2020-01-21). The results are summarized at Table 19.

TABLE 19
Biofilm in CDC bioreactor assay

| Trt | | P.A. biofilm |
|---|---|---|
| # | Compositions (wt %) | (log CFU/ml) |
| 1 | Untreated Control | 4.6 |
| 2 | (4.5% Thymol + 0.45% geraniol + 15% IPA) + | 0 |
| | (2.25% Al2575 + 1.5% EDTA-mono-C16 ester + | |
| | 1.2% Tris + 4% SDS) | |
| 3 | (4.5% Thymol + 0.45% carvarcrol + 15% IPA) + | 0 |
| | (2.25% Al2575 + 1.5% EDTA-mono-C16 ester + | |
| | 1.2% Tris + 4% SDS) | |
| 4 | (4.5% Thymol + 0.45% citronella + 15% IPA) + | 0 |
| | (2.25% Al2575 + 1.5% EDTA-mono-C16 ester + | |
| | 1.2% Tris + 4% SDS) | |
| 5 | (4.5% Thymol + 0.45% lavender oil + 15% IPA) + | 0 |
| | (2.25% Al2575 + 1.5% EDTA-mono-C16 ester + | |
| | 1.2% Tris + 4% SDS) | |
| 6 | (4.5% Thymol + 0.45% orange oil + 15% IPA) + | 0 |
| | (2.25% Al2575 + 1.5% EDTA-mono-C16 ester + | |
| | 1.2% Tris + 4% SDS) | |

### Example 20

The level of foaming of various solutions was tested in triplicate and for several water hardness (FH) levels, using the following procedure:
1—30 mL of the formulation is placed into a clean 100 mL graduated cylinder;
2—The graduated cylinder is inverted 20 times; and
3—The total volume is measured immediately, after 30 s and after 5 minutes.

The following solutions were tested. The results are summarized in Table 20 below:
a) 0.05% SDS;
b) 0.0125% rhamnolipid+0.0375% SDS; and
c) 4.5% Thymol+2.25% Al2575+1.5% EDTA-mono-C₁₆ ester+1.2% Tris+15% IPA+4% SDS.

TABLE 20
Foaming tests with different water hardness

| Water hardness | Test | Total volume (mL) | | |
|---|---|---|---|---|
| (FH) | solutions | 0 min | 0.5 min | 5 min |
| 0 | a) | 40.0 ± 8.7 | 33.5 ± 2.6 | 32.8 ± 1.9 |
| | b) | 52.0 ± 8.2 | 49.3 ± 9.7 | 48.3 ± 9.5 |
| | c) | 35.0 ± 1.0 | 30.0 ± 0.0 | 30.0 ± 0.0 |
| 48 | a) | 33.3 ± 0.6 | 30.7 ± 0.6 | 30.2 ± 0.3 |
| | b) | 35.3 ± 0.6 | 35.3 ± 0.6 | 34.8 ± 0.3 |
| | c) | 35.7 ± 0.6 | 30.2 ± 0.3 | 30.0 ± 0.0 |
| 96 | a) | 32.7 ± 0.6 | 30.2 ± 0.3 | 30.0 ± 0.0 |
| | b) | 34.0 ± 0.0 | 34.0 ± 0.0 | 33.5 ± 1.3 |
| | c) | 39.7 ± 1.5 | 30.0 ± 0.0 | 30.0 ± 0.0 |

Test solution c) that includes a biosurfactant (alkyl polyglycoside), an essential oil (thymol) and EDTA-mono-C₁₆ ester had a low foaming capacity, where all the foam formed breaks within 30 seconds. The emulsion remained clear at higher water hardness.

### Abbreviations

Throughout Examples 1-16, the carboxylic acid derivatives used are named as follows:

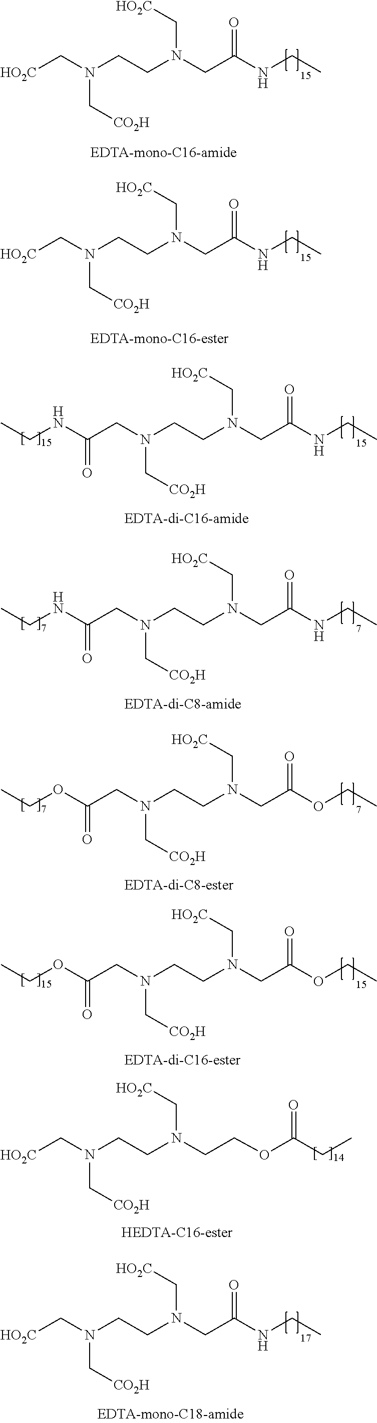

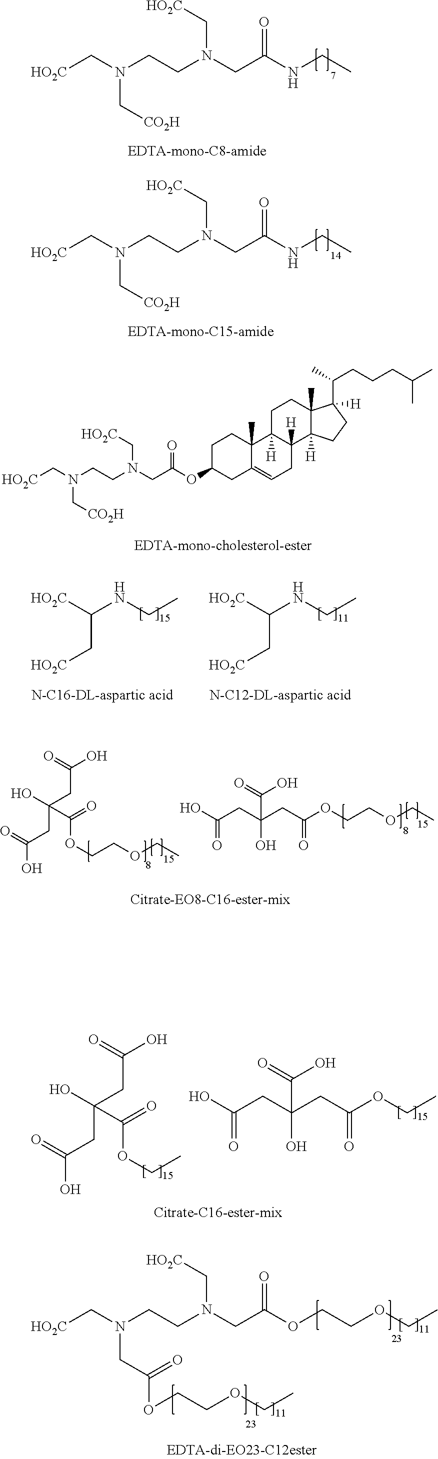

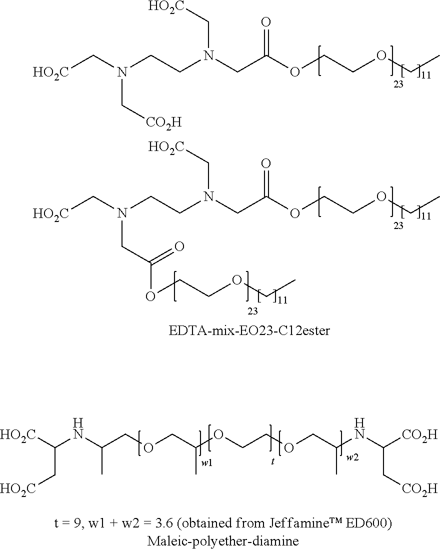

All publications, patents, and patent documents cited herein above are incorporated by reference herein, as though individually incorporated by reference. The compounds, compositions, methods and uses described herein have been described with reference to various implementations and techniques. However, one skilled in the art will understand that many variations and modifications can be made while remaining within the spirit and scope of the appended claims.

1-70. (canceled)

71. An antibiofilm combination, comprising:
a compound of Formula (I): 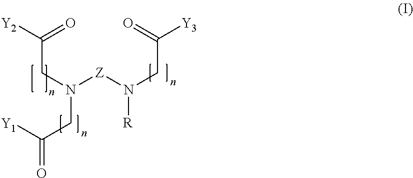
or a salt thereof, wherein:
R is selected from the group consisting of 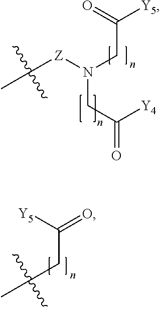
(C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl,
-(PO)_{w1}-(EO)(C₂-C₂₄)alkenyl, -(PO)_{w1}-(EO)(C₂-C₂₄)alkynyl, —(CH₂)ₚ—OR₁, —(CH₂)ₚ—NR₁R₂, —(CH₂)ₚ—OC(═O)R₁, —(CH₂)ₚ—NR₂C(═O)R₁, (C₁-C₂₄)acyl, aryl and a steroidyl group;
each Y₁, Y₂, Y₃ and Y₄ is independently selected from the group consisting of —OR₃ and —NR₃R₄;
Y₅ is selected from the group consisting of —OR₁ and —NR₁R₂;
each R₁ is independently selected from the group consisting of (C₁-C₂₄)alkyl,
-(EO)ₜC₁-C₂₄)alkyl, (C₂-C₂₄)alkenyl, -(EO)ₜ-(PO)_{w1}-(C₁-C₂₄)alkyl, -(EO)ₜ-(PO)_{w1}-(C₂-C₂₄)alkenyl, -(EO)ₜ-(PO)_{w1}-(C₂-C₂₄)alkynyl,
-(PO)_{w1}-(EO)4C₂-C₂₄)alkenyl, -(PO)_{w1}-(EO)(C₂-C₂₄)alkynyl, aryl and a steroidyl group;
each R₂, R₃ and R₄ is independently selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-C₂-C₂₄)alkenyl, -(EO)ₜ-(PO)_{w1}-(C₂-C₂₄)alkynyl, -(PO)_{w1}-(EO)ₜ-C₁-C₂₄)alkyl,
-(PO)_{w1}-(EO)4C₂-C₂₄)alkenyl, -(PO)_{w1}-(EO)ₜ-(C₂-C₂₄)alkynyl, aryl and a steroidyl group;
each Z is independently selected from the group consisting of (C₂-C₆)alkylene, (C₃-C₆)cycloalkylene and —(CH₂)₂—O—(CH₂)₂—O—(CH₂)₂—;
wherein each (C₂-C₆)alkylene and (C₃-C₆)cycloalkylene is independently unsubstituted or substituted by one or more identical or different substituents R₅;
wherein each aryl, (C₁-C₂₄)alkyl, (C₂-C₂₄)alkenyl and (C₂-C₂₄)alkynyl is independently unsubstituted or substituted by one or more identical or different substituents R₆;
wherein each R₅ and each R₆ is independently selected from the group consisting of halogen, —OH, —O—(C₁-C₄)alkyl, CF₃, and —CN;
each n is independently 1, 2, 3 or 4;
each p is independently 2, 3 or 4;
each t is independently a number between 1 and 50; and
each w1 is independently a number between 0 and 10.
an essential oil; and
a biosurfactant selected from the group consisting of an alkyl polyglycoside, a rhamnolipid,
a sophorolipid and a combination thereof.

72. The antibiofilm combination of claim 71, wherein:
each R₁ is independently selected from the group consisting of (C₈-C₁₈)alkyl and -(EO)ₜ-C₈-C₁₈)alkyl;
R₂ and R₄ are each H; and
each R₃ is independently selected from the group consisting of H, (C₈-C₁₈)alkyl and (EO)ₜ-(C₈-C₁₈)alkyl,
wherein each t is independently a number between 1 and 30.

73. The antibiofilm combination of claim 71, wherein Z is selected from the group consisting of —CH₂—CH₂—, 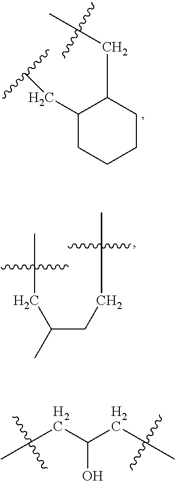
and —(CH₂)₂—O—(CH₂)₂—O—(CH₂)₂—.

74. The antibiofilm combination of claim 71, wherein n is 1 or 2.

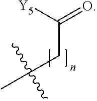

75. The antibiofilm combination of claim 71, wherein R is

76. The antibiofilm combination of claim 75, wherein Y₁=OH, Y₂=OH and Y₃=OH.

77. The antibiofilm combination of claim 75, wherein Y₁=Y₅, Y₂=OH and Y₃=OH.

78. The antibiofilm combination of claim 71, wherein the compound of Formula (I) is: 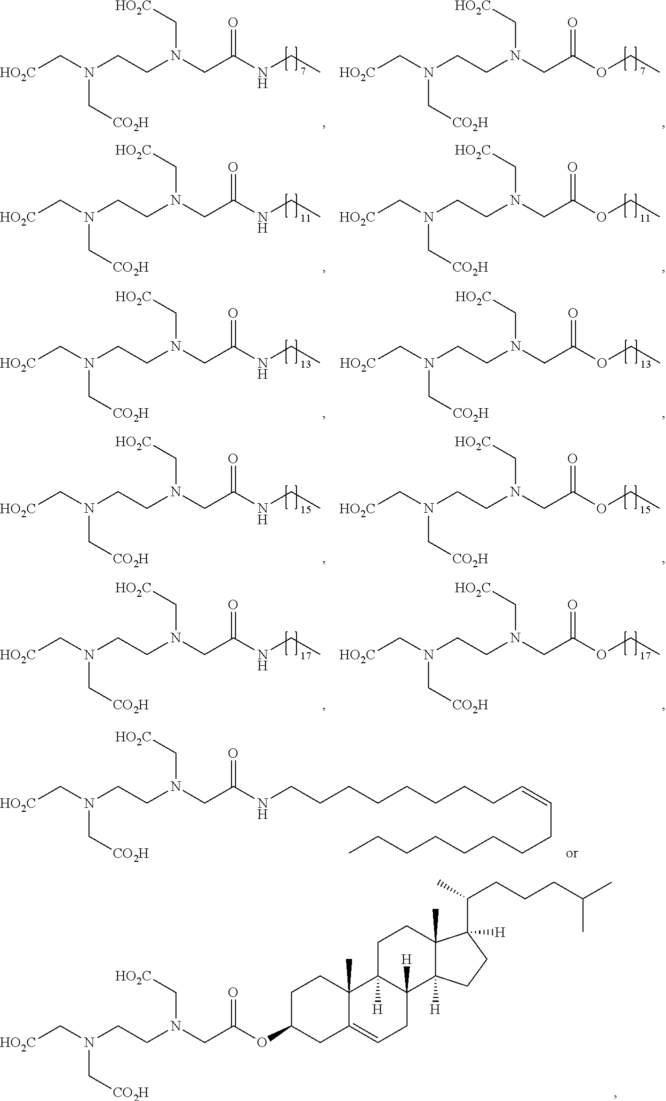
or a salt thereof.

79. The antibiofilm combination of claim 71, wherein the compound of Formula (I) is: 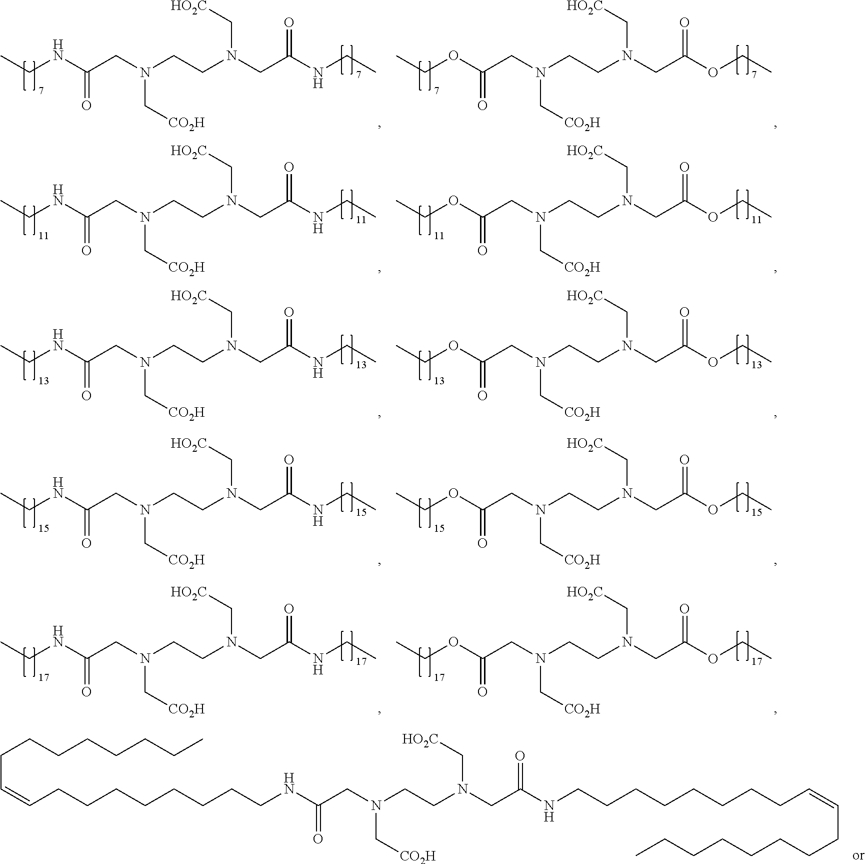 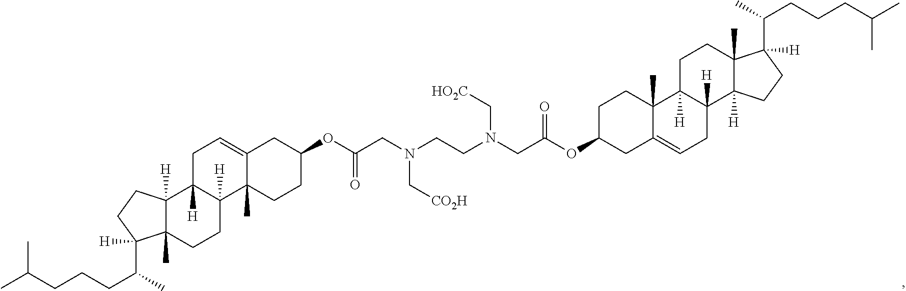
or a salt thereof.

80. The antibiofilm combination of claim 71, wherein R is 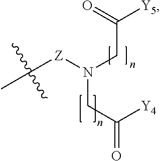
(C₈-C₁₈)alkyl, (C₈-C₁₈)alkenyl, (C₈-C₁₈)alkynyl or —(CH₂)ₚ—OC(═O)R₁, wherein p=2.

81. An antibiofilm combination, comprising:
a compound of Formula (IIIA): 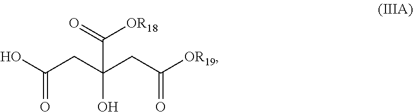
or a salt thereof, wherein:
R₁₉ is selected from the group consisting of H, (C₁-C₂₄)alkyl, (C₂-C₂₄)alkenyl, (C₂-C₂₄)alkynyl, -(EO)ₜ-(PO)_{w1}-(C₁-C₂₄)alkyl, -(EO)ₜ-(PO)_{w1}-(C₂-C₂₄)alkenyl,
-(EO)ₜ-(PO)_{w1}-(C₂-C₂₄)alkynyl,
-(PO)_{w1}-(EO)ₜ-(C₂-C₂₄)alkenyl and -(PO)_{w1}-(EO)ₜ-(C₂-C₂₄)alkynyl,
R₁₈ is selected from the group consisting of H, (C₁-C₂₄)alkyl, (C₂-C₂₄)alkenyl,
(C₂-C₂₄)alkynyl; -(EO)ₜ-(PO)_{w1}-(C₁-C₂₄)alkyl, -(EO)ₜ-(PO)_{w1}-(C₂-C₂₄)alkenyl,
-(EO)ₜ-(PO)_{w1}-(C₂-C₂₄)alkynyl,
-(PO)_{w1}-(EO)ₜ-(C₂-C₂₄)alkenyl and -(PO)_{w1}-(EO)ₜ-(C₂-C₂₄)alkynyl,
wherein at least one of R₁₈ and R₁₉ is not H;
each (C₁-C₂₄)alkyl, (C₂-C₂₄)alkenyl and (C₂-C₂₄)alkynyl is independently unsubstituted or substituted by one or more identical or different substituents R_{6;}
wherein each R₆ is independently selected from the group consisting of halogen, —OH, —O—(C₁-C₄)alkyl, CF₃, and —CN;
each t is independently a number between 1 and 50; and
each w1 is independently a number between 1 and 10;
an essential oil; and
a biosurfactant selected from the group consisting of an alkyl polyglycoside, a rhamnolipid,
a sophorolipid and a combination thereof.

82. An antibiofilm combination, comprising:
a compound of Formula (VII): 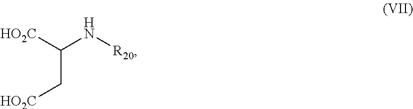
or a salt thereof, wherein:
R₂₀ is selected from the group consisting of: (C₁-C₂₄)alkyl, (C₂-C₂₄)alkenyl,
(C₂-C₂₄)alkynyl, -(EO)ₜ-(PO)_{w1}-(C₁-C₂₄)alkyl, -(EO)ₜ-(PO)_{w1}-(C₂-C₂₄)alkenyl,
-(EO)ₜ(PO)_{w1}-(C₂-C₂₄)alkynyl, -(PO)_{w1}-(EO)ₜ-(C₁-C₂₄)alkyl,
-(PO)_{w1}-(EO)(C₂-C₂₄)alkenyl, -(PO)_{w1}-(EO)ₜ-C₂-C₂₄)alkynyl, 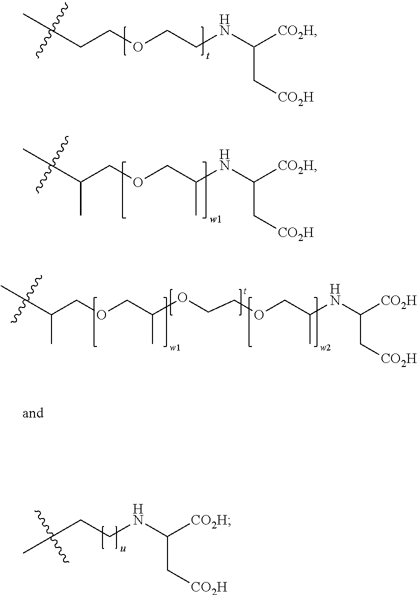
t is a number between 1 and 50;
u is a number between 1 and 23;
w1 is a number between 0 and 10; and
w2 is a number between 0 and 10;
each (C₁-C₂₄)alkyl, (C₂-C₂₄)alkenyl and (C₂-C₂₄)alkynyl is independently unsubstituted or substituted by one or more identical or different substituents R₆;
wherein each R₆ is independently selected from the group consisting of halogen, —OH, —O—(C₁-C₄)alkyl, CF₃, and —CN
an essential oil; and
a biosurfactant selected from the group consisting of an alkyl polyglycoside, a rhamnolipid,
a sophorolipid and a combination thereof.

83. The antibiofilm combination of claim 71, wherein:
the compound of Formula (I) is a polycarboxylic acid compound of Formula (IC) or Formula (TB), 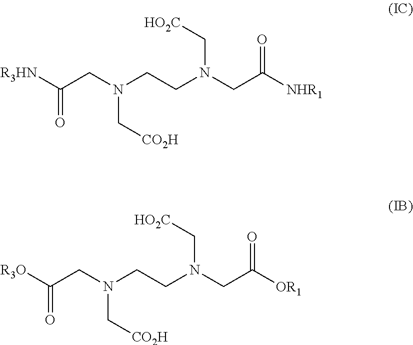
or a salt thereof, wherein:
R₁ is a (C₈-C₁₈)alkyl;
R₃ is H or (C₈-C₁₈)alkyl.

84. The antibiofilm combination of claim 71, wherein the essential oil is selected from the group consisting of thymol, eugenol, geranial, nerol, citral, carvacrol, cinnamaldehyde, terpinol, α-terpinene, citronellal, citronellol, geraniol, geranyl acetate, limonene, lavender oil, methyl isoeugenol and mixtures thereof.

85. The antibiofilm combination of claim 71, further comprising a surfactant selected from the group consisting of an alkyl sulfate surfactant, an alkylbenzene sulfonate surfactant, an ethoxylated alcohol, a polymeric surfactant, a fatty acid ester, a poly(ethylene glycol), an ethoxylated alkyl alcohol, a monoglyceride, an alkyl monoglyceride, a polysorbate, and a mixture thereof.

86. The antibiofilm combination of claim 71, which is free of any additional surfactant.

87. The antibiofilm combination of claim 71, further comprising at least one of water, an additional oil and a non-aqueous solvent, wherein the additional oil is selected from the group of a mineral oil and a vegetable oil.

88. The antibiofilm combination of claim 71, wherein the antibiofilm combination is an antibiofilm composition.

89. The antibiofilm combination of claim 71, wherein the antibiofilm combination is provided as a multiple-pack system comprising at least two packs, each one of the two packs comprising at least one separate component of the combination.

90. A method for disrupting preformed biofilms on a surface or for inhibiting biofilm formation on a surface, comprising applying the antibiofilm combination of claim 71 to the surface.
